(19) United States
(12) Patent Application Publication
(10) Pub. No.: US 2023/0084780 A1
(43) Pub. Date: Mar. 16, 2023

(54) METHOD AND DEVICE IN NODE FOR WIRELESS COMMUNICATION

(71) Applicants: Lu WU, SHANGHAI (CN); Xiaobo ZHANG, SHANGHAI (CN)

(72) Inventors: Lu WU, SHANGHAI (CN); Xiaobo ZHANG, SHANGHAI (CN)

(73) Assignee: SHANGHAI LANGBO COMMUNICATION TECHNOLOGY COMPANY LIMITED, SHANGHAI (CN)

(21) Appl. No.: 17/992,932

(22) Filed: Nov. 23, 2022

Related U.S. Application Data
(63) Continuation of application No. PCT/CN2021/098076, filed on Jun. 3, 2021.

(30) Foreign Application Priority Data
Jun. 4, 2020 (CN) 202010499976.3
Jun. 4, 2020 (CN) 202010501259.X
Jun. 12, 2020 (CN) 202010532526.X

(51) Int. Cl. H04W 74/08

(52) U.S. Cl. CPC H04W 74/0816

(57) ABSTRACT

The disclosure provides a method and a device in a node for wireless communication. A first node performs a first listening in a first subband; when the first listening indicates that a channel is busy, the first node determines to give up a radio transmission on a first channel, starts a first timer and updates a first counter by 1; when any one of Q timers expires, the first node resets the first counter to an initial value; and when the first counter reaches or exceeds a target threshold, the first node transmits a first signal. The first channel belongs to the first subband in frequency domain, the first listening is correlated to a first index, and the first index is any one of Q indexes; the Q indexes are one-to-one corresponding to the Q timers respectively.

### CROSS REFERENCE TO RELATED APPLICATIONS

This application is a continuation of International Application No. PCT/CN2021/098076, filed Jun. 3, 2021, which claims the priority benefit of Chinese Patent Application No. 202010499976.3, filed on Jun. 4, 2020, and claims the priority benefit of Chinese Patent Application No. 202010501259.X, filed on Jun. 4, 2020, and claims the priority benefit of Chinese Patent Application No. 202010532526.X, filed on Jun. 12, 2020, the full disclosure of which is incorporated herein by reference.

### TECHNICAL FIELD

The disclosure relates to transmission methods and devices in wireless communication systems, and in particular to a transmission method and device for a radio signal in a wireless communication system supporting a cellular network.

### BACKGROUND

In cellular systems, both 3rd Generation Partner Project (3GPP) Long-term Evolution (LTE) and 5G New Radio Access Technology (NR) introduce unlicensed spectrum communications. In order to guarantee the compatibility with other access technologies on an unlicensed spectrum, in channel sensing, a Listen Before Talk (LBT) technology is employed under omnidirectional antennas so as to avoid interferences caused when multiple transmitters occupy simultaneously a same frequency resource.

A Study item (SI) of 52.6 GHz-71 GHz involved in NR Release 17 was approved at the 3GPP RAN #86 plenary, and a channel access mechanism is one important point to study. Herein, multiple antennas experience beamforming to form a beam which points to a particular spatial direction to improve the quality of communication, and the channel sensing technology involving beamforming is one research hotspot.

### SUMMARY

The inventor finds through researches that the failure detection and recovery mechanism for channel sensing is one key problem in the case of beamforming.

In view of the above problems, the disclosure provides a solution. In the description of the above problems, an uplink is taken as an example. This disclosure is also applicable to downlink transmission scenarios and sidelink transmission scenarios and can achieve the technical effects similar to those in sidelink. In addition, the adoption of a unified solution by different scenarios (including, but not limited to, uplink, downlink and sidelink) is also beneficial to reducing the complexity and cost of hardware. It should be noted that the embodiments of the UE in the disclosure and the characteristics of the embodiments may be applied to the base station if no conflict is incurred, and vice versa. The embodiments of the disclosure and the characteristics of the embodiments may be arbitrarily combined mutually if no conflict is incurred.

In one embodiment, terminologies in the disclosure are explained with reference to the definitions in specification protocol TS36 series of 3GPP.

In one embodiment, terminologies in the disclosure are explained with reference to the definitions in specification protocol TS38 series of 3GPP.

In one embodiment, terminologies in the disclosure are explained with reference to the definitions in specification protocol TS37 series of 3GPP.

In one embodiment, terminologies in the disclosure are explained with reference to the definitions in specification protocols of Institute of Electrical and Electronics Engineers (IEEE).

The disclosure provides a method in a first node for wireless communication, wherein the method includes:

performing a first sensing in a first subband; when the first sensing indicates that a channel is busy, determining to give up a radio transmission on a first channel, starting a first timer and updating a first counter by 1; and

when any one of Q timers expires, resetting the first counter to an initial value; and when the first counter reaches or exceeds a target threshold, transmitting a first signal.

Herein, the first channel belongs to the first subband in frequency domain, the first sensing is correlated to a first index, and the first index is any one of Q indexes; the Q indexes are one-to-one corresponding to the Q timers respectively, and the first timer is one of the Q timers that is corresponding to the first index; and Q is a positive integer greater than 1.

In one embodiment, a problem to be solved by the disclosure is to consider the failure detection and recovery mechanism of channel sensing in the case of beamforming.

In one embodiment, a problem to be solved by the disclosure is to consider the failure detection and recovery mechanism of channel sensing in the case of multiple Transmit-Receive Points (TRPs).

In one embodiment, a problem to be solved by the disclosure is to consider the failure detection and recovery mechanism of channel sensing in the case of multiple antenna panels.

In one embodiment, a problem to be solved by the disclosure is to consider the LBT failure detection and recovery mechanism in the case of employing directional antennas.

In one embodiment, the essence of the above method is that: Q indexes correspond to Q types of channel sensing in a first subband respectively, a first sensing is one type of channel sensing corresponding to a first index, and Q timers are used for the failure detection of the Q types of channel sensing respectively. The above method has the following benefits: an effective channel failure detection and recovery mechanism is established for multiple types of channel sensing, and the reliability of transmission is improved under the unlicensed spectrum.

In one embodiment, the essence of the above method is that: Q indexes correspond to Q TRPs in a first subband respectively, a first sensing is LBT corresponding to a first index, and Q timers are used for the LBT failure detection of the Q TRPs respectively. The above method has the following benefits: an effective LBT failure detection and recovery mechanism is established for multiple TRPs, and the reliability of transmission is improved under the unlicensed spectrum.

In one embodiment, the essence of the above method is that: Q indexes correspond to Q antenna panels in a first subband respectively, a first sensing is LBT corresponding to a first index, and Q timers are used for the LBT failure detection of the Q antenna panels respectively. The above method has the following benefits: an effective LBT failure detection and recovery mechanism is established for multiple antenna panels, and the reliability of transmission is improved under the unlicensed spectrum.

In one embodiment, the essence of the above method is that: Q indexes correspond to Q LBT beams respectively, a first beam is an LBT beam corresponding to a first index, a first sensing is LBT performed employing a first beam, the LBT of all the Q beams is specific to a first subband, and Q timers are used for the LBT failure detection of the Q beams respectively. The above method has the following benefits: an effective LBT failure detection and recovery mechanism is established for the LBT under directional antennas, and the reliability of transmission is improved under the unlicensed spectrum.

According to one aspect of the disclosure, the above method includes:

monitoring a first type of signaling in the first subband.

Herein, the first type of signaling is used for determining the first index; and the first sensing is performed each time the first type of signaling is detected.

According to one aspect of the disclosure, the above method includes:

when the first counter reaches or exceeds a target threshold, triggering a sensing failure indication of the first subband.

Herein, as a response to the action that the sensing failure indication of the first subband is triggered, the first signal is generated.

According to one aspect of the disclosure, the above method includes:

when the sensing failure indication has been triggered for each subband configured with a PRACH in a first serving cell, transmitting the sensing failure indication to an upper layer; when the sensing failure indication has not been triggered for at least one subband configured with a PRACH in a first serving cell, switching from the first subband to a second subband.

Herein, the second subband is one subband in the first serving cell that is configured with a PRACH and has not been triggered the sensing failure indication.

According to one aspect of the disclosure, the above method includes:

as a response to the action of transmitting the sensing failure indication to an upper layer, transmitting a radio link failure message.

According to one aspect of the disclosure, the above method includes:

receiving a first signaling.

Herein, the first signaling indicates at least one of expiration values of the Q timers or a target threshold of the first counter.

According to one aspect of the disclosure, the above method includes:

transmitting a second signal.

Herein, the second signal indicates a second index, and the second index is one of the Q indexes.

The disclosure provides a method in a second node for wireless communication, wherein the method includes:

receiving a first signal.

Herein, a transmitter of the first signal maintains a first counter, and the first counter reaches or exceeds a target threshold; the transmitter of the first signal performs a first sensing in a first subband; when the first sensing indicates that a channel is busy, the transmitter of the first signal determines to give up a radio transmission on a first channel, starts a first timer and updates the first counter by 1; the first channel belongs to the first subband in frequency domain, the first sensing is correlated to a first index, and the first index is any one of Q indexes; the Q indexes are one-to-one corresponding to Q timers respectively, and the first timer is one of the Q timers that is corresponding to the first index; and Q is a positive integer greater than 1.

According to one aspect of the disclosure, the above method includes:

transmitting a first type of signaling in the first subband.

Herein, the first type of signaling is used for determining the first index; and the first sensing is performed each time the first type of signaling is detected by the transmitter of the first signal.

According to one aspect of the disclosure, the above method includes:

receiving a radio link failure message.

Herein, the transmitter of the first signal transmits the sensing failure indication to an upper layer.

According to one aspect of the disclosure, the above method includes:

transmitting a first signaling.

Herein, the first signaling indicates at least one of expiration values of the Q timers or a target threshold of the first counter.

According to one aspect of the disclosure, the above method includes:

receiving a second signal.

Herein, the second signal indicates a second index, and the second index is one of the Q indexes.

The disclosure provides a first node for wireless communication, wherein the first node includes:

a first receiver, to perform a first sensing in a first subband, and when the first sensing indicates that a channel is busy, to determine to give up a radio transmission on a first channel, to start a first timer and to update a first counter by 1; and

a first transmitter, when any one of Q timers expires, to reset the first counter to an initial value, and when the first counter reaches or exceeds a target threshold, to transmit a first signal.

Herein, the first channel belongs to the first subband in frequency domain, the first sensing is correlated to a first index, and the first index is any one of Q indexes; the Q indexes are one-to-one corresponding to the Q timers respectively, and the first timer is one of the Q timers that is corresponding to the first index; and Q is a positive integer greater than 1.

The disclosure provides a second node for wireless communication, wherein the second node includes:

a second receiver, to receive a first signal.

Herein, a transmitter of the first signal maintains a first counter, and the first counter reaches or exceeds a target threshold; the transmitter of the first signal performs a first sensing in a first subband; when the first sensing indicates that a channel is busy, the transmitter of the first signal determines to give up a radio transmission on a first channel, starts a first timer and updates the first counter by 1; the first channel belongs to the first subband in frequency domain, the first sensing is correlated to a first index, and the first index is any one of Q indexes; the Q indexes are one-to-one corresponding to Q timers respectively, and the first timer is one of the Q timers that is corresponding to the first index; and Q is a positive integer greater than 1.

In one embodiment, the method in the disclosure has the following advantages.

Through the method provided in the disclosure, an effective channel failure detection and recovery mechanism is established for multiple types of channel sensing, and the reliability of transmission is improved under the unlicensed spectrum.

Through the method provided in the disclosure, an effective LBT failure detection and recovery mechanism is established for the LBT under multiple TRPs, and the reliability of transmission is improved under the unlicensed spectrum.

Through the method provided in the disclosure, an effective LBT failure detection and recovery mechanism is established for the LBT under multiple antenna panels, and the reliability of transmission is improved under the unlicensed spectrum.

Through the method provided in the disclosure, an effective LBT failure detection and recovery mechanism is established for the LBT under directional antennas, and the reliability of transmission is improved under the unlicensed spectrum.

The disclosure provides a method in a first node for wireless communication, wherein the method includes:

performing a first sensing in a first subband; when the first sensing indicates that a channel is busy, determining to give up a radio transmission on a first channel, starting a first timer and updating a first counter by 1; and

when the first timer expires, resetting the first counter to an initial value; and when any one of Q counters reaches or exceeds a target threshold, transmitting a first signal.

Herein, the first channel belongs to the first subband in frequency domain, the first sensing is correlated to a first index, and the first index is any one of Q indexes; the Q indexes are one-to-one corresponding to the Q counters respectively, and the first counter is one of the Q counters that is corresponding to the first index; and Q is a positive integer greater than 1.

In one embodiment, a problem to be solved by the disclosure is to consider the failure detection and recovery mechanism of channel sensing in the case of beamforming.

In one embodiment, a problem to be solved by the disclosure is to consider the failure detection and recovery mechanism of channel sensing in the case of multiple Transmit-Receive Points (TRPs).

In one embodiment, a problem to be solved by the disclosure is to consider the failure detection and recovery mechanism of channel sensing in the case of multiple antenna panels.

In one embodiment, a problem to be solved by the disclosure is to consider the LBT failure detection and recovery mechanism in the case of employing directional antennas.

In one embodiment, the essence of the above method is that: Q indexes correspond to Q types of channel sensing in a first subband respectively, a first sensing is one type of channel sensing corresponding to a first index, and Q counters are used for the failure detection of the Q types of channel sensing respectively. The above method has the following benefits: an effective channel failure detection and recovery mechanism is established for multiple types of channel sensing, and the reliability of transmission is improved under the unlicensed spectrum.

In one embodiment, the essence of the above method is that: Q indexes correspond to Q TRPs in a first subband respectively, a first sensing is LBT corresponding to a first index, and Q counters are used for the LBT failure detection of the Q TRPs respectively. The above method has the following benefits: an effective LBT failure detection and recovery mechanism is established for multiple TRPs, and the reliability of transmission is improved under the unlicensed spectrum.

In one embodiment, the essence of the above method is that: Q indexes correspond to Q antenna panels in a first subband respectively, a first sensing is LBT corresponding to a first index, and Q counters are used for the LBT failure detection of the Q antenna panels respectively. The above method has the following benefits: an effective LBT failure detection and recovery mechanism is established for multiple antenna panels, and the reliability of transmission is improved under the unlicensed spectrum.

In one embodiment, the essence of the above method is that: Q indexes correspond to Q LBT beams respectively, a first beam is an LBT beam corresponding to a first index, a first sensing is LBT performed employing a first beam, the LBT of all the Q beams is specific to a first subband, and Q counters are used for the LBT failure detection of the Q beams respectively. The above method has the following benefits: an effective LBT failure detection and recovery mechanism is established for the LBT under directional antennas, and the reliability of transmission is improved under the unlicensed spectrum.

According to one aspect of the disclosure, the Q indexes are one-to-one corresponding to Q timers respectively, and the first timer is one of the Q timers that is corresponding to the first index.

In one embodiment, the essence of the above method is that: Q indexes correspond to Q types of channel sensing in a first subband respectively, and Q timers are used for the failure detection of the Q types of channel respectively.

In one embodiment, the essence of the above method is that: Q indexes correspond to Q TRPs in a first subband respectively, and Q timers are used for the LBT failure detection of the Q TRPs respectively.

In one embodiment, the essence of the above method is that: Q indexes correspond to Q antenna panels in a first subband respectively, and Q timers are used for the LBT failure detection of the Q antenna panels respectively.

In one embodiment, the essence of the above method is that: Q indexes correspond to Q LBT beams respectively, and Q timers are used for the LBT failure detection of the Q beams respectively.

According to one aspect of the disclosure, the Q counters are all corresponding to the first timer.

In one embodiment, the essence of the above method is that: Q indexes correspond to Q types of channel sensing in a first subband respectively, and a first timer is used for the failure detection of the Q types of channel.

In one embodiment, the essence of the above method is that: Q indexes correspond to Q TRPs in a first subband respectively, and a first timer is used for the LBT failure detection of the Q TRPs respectively.

In one embodiment, the essence of the above method is that: Q indexes correspond to Q antenna panels in a first subband respectively, and a first timer is used for the LBT failure detection of the Q antenna panels respectively.

In one embodiment, the essence of the above method is that: Q indexes correspond to Q LBT beams respectively, and a first timer is used for the LBT failure detection of the Q beams respectively.

According to one aspect of the disclosure, when the first timer expires, the Q counters are all reset to an initial value.

According to one aspect of the disclosure, the above method includes:

monitoring a first type of signaling in the first subband.

Herein, the first type of signaling is used for determining the first index; and the first sensing is performed each time the first type of signaling is detected.

According to one aspect of the disclosure, the above method includes:

when any one of the Q counters reaches or exceeds a target threshold, triggering a sensing failure indication of the first subband.

Herein, as a response to the action that the sensing failure indication of the first subband is triggered, the first signal is generated.

According to one aspect of the disclosure, the above method includes:

when the sensing failure indication has been triggered for each subband configured with a PRACH in a first serving cell, transmitting the sensing failure indication to an upper layer; when the sensing failure indication has not been triggered for at least one subband configured with a PRACH in a first serving cell, switching from the first subband to a second subband.

Herein, the second subband is one subband in the first serving cell that is configured with a PRACH and has not been triggered the sensing failure indication.

According to one aspect of the disclosure, the above method includes:

as a response to the action of transmitting the sensing failure indication to an upper layer, transmitting a radio link failure message.

According to one aspect of the disclosure, the above method includes:

receiving a first signaling.

Herein, the first signaling indicates at least one of an expiration value of the first timer or target thresholds of the Q counters.

According to one aspect of the disclosure, the above method includes:

transmitting a second signal.

Herein, the second signal indicates a second index, and the second index is one of the Q indexes.

The disclosure provides a method in a second node for wireless communication, wherein the method includes:

receiving a first signal.

Herein, a transmitter of the first signal maintains Q counters, and any one of the Q counters reaches or exceeds a target threshold; the transmitter of the first signal performs a first sensing in a first subband; when the first sensing indicates that a channel is busy, the transmitter of the first signal determines to give up a radio transmission on a first channel, starts a first timer and updates a first counter by 1; the first channel belongs to the first subband in frequency domain, the first sensing is correlated to a first index, and the first index is any one of Q indexes; the Q indexes are one-to-one corresponding to Q counters respectively, and the first counter is one of the Q counters that is corresponding to the first index; and Q is a positive integer greater than 1.

According to one aspect of the disclosure, the Q indexes are one-to-one corresponding to Q timers respectively, and the first timer is one of the Q timers that is corresponding to the first index.

According to one aspect of the disclosure, the Q counters are all corresponding to the first timer.

According to one aspect of the disclosure, when the first timer expires, the Q counters are all reset to an initial value by the transmitter of the first signal.

According to one aspect of the disclosure, the above method includes:

transmitting a first type of signaling in the first subband.

Herein, the first type of signaling is used for determining the first index; and the first sensing is performed each time the first type of signaling is detected by the transmitter of the first signal.

According to one aspect of the disclosure, the above method includes:

receiving a radio link failure message.

Herein, the transmitter of the first signal transmits the sensing failure indication to an upper layer.

According to one aspect of the disclosure, the above method includes:

transmitting a first signaling.

Herein, the first signaling indicates at least one of an expiration value of the first timer or target thresholds of the Q counters.

According to one aspect of the disclosure, the above method includes:

receiving a second signal.

Herein, the second signal indicates a second index, and the second index is one of the Q indexes.

The disclosure provides a first node for wireless communication, wherein the first node includes:

a first receiver, to perform a first sensing in a first subband, and when the first sensing indicates that a channel is busy, to determine to give up a radio transmission on a first channel, to start a first timer and to update a first counter by 1; and

a first transmitter, when the first timers expires, to reset the first counter to an initial value, and when any one of Q counters reaches or exceeds a target threshold, to transmit a first signal.

Herein, the first channel belongs to the first subband in frequency domain, the first sensing is correlated to a first index, and the first index is any one of Q indexes; the Q indexes are one-to-one corresponding to the Q counters respectively, and the first counter is one of the Q counters that is corresponding to the first index; and Q is a positive integer greater than 1.

The disclosure provides a second node for wireless communication, wherein the second node includes:

a second receiver, to receive a first signal.

Herein, a transmitter of the first signal maintains Q counters, and any one of the Q counters reaches or exceeds a target threshold; the transmitter of the first signal performs a first sensing in a first subband; when the first sensing indicates that a channel is busy, the transmitter of the first signal determines to give up a radio transmission on a first channel, starts a first timer and updates a first counter by 1; the first channel belongs to the first subband in frequency domain, the first sensing is correlated to a first index, and the first index is any one of Q indexes; the Q indexes are one-to-one corresponding to Q counters respectively, and the first counter is one of the Q counters that is corresponding to the first index; and Q is a positive integer greater than 1.

In one embodiment, the method in the disclosure has the following advantages.

Through the method provided in the disclosure, an effective channel failure detection and recovery mechanism is established for multiple types of channel sensing, and the reliability of transmission is improved under the unlicensed spectrum.

Through the method provided in the disclosure, an effective LBT failure detection and recovery mechanism is established for the LBT under multiple TRPs, and the reliability of transmission is improved under the unlicensed spectrum.

Through the method provided in the disclosure, an effective LBT failure detection and recovery mechanism is established for the LBT under multiple antenna panels, and the reliability of transmission is improved under the unlicensed spectrum.

Through the method provided in the disclosure, an effective LBT failure detection and recovery mechanism is established for the LBT under directional antennas, and the reliability of transmission is improved under the unlicensed spectrum.

The disclosure provides a method in a first node for wireless communication, wherein the method includes:

receiving a first signaling, the first signaling reconfiguring a first parameter; and, as a response to the action that the first parameter is reconfigured, resetting a first counter to an initial value; and

performing a first sensing in a first subband; when the first sensing indicates that a channel is busy, determining to give up a radio transmission on a first channel, starting a first timer and updating the first counter by 1.

Herein, the first channel belongs to the first subband in frequency domain, and the first parameter is used for determining a first reference signal resource set; at least one of the radio transmission on the first channel or the first sensing is spatially correlated to a first reference signal resource, the first reference signal resource is one reference signal resource in the first reference signal resource set, and the first reference signal resource set includes at least one reference signal resource.

In one embodiment, a problem to be solved by the disclosure is to consider the failure detection and recovery mechanism of channel in the case of beamforming.

In one embodiment, a problem to be solved by the disclosure is to consider the failure detection and recovery mechanism of channel in the case of multiple Transmit-Receive Points (TRPs).

In one embodiment, a problem to be solved by the disclosure is to consider the failure detection and recovery mechanism of channel in the case of multiple antenna panels.

In one embodiment, a problem to be solved by the disclosure is to consider the LBT failure detection and recovery mechanism in the case of employing directional antennas.

In one embodiment, the essence of the above method is that: when a beam is reset, a first counter is used for the channel failure detection, and the first counter is reset to an initial value when a beam is reset. The above method has the following benefits: an effective channel failure detection and recovery mechanism is established in the case of beamforming, and the reliability of transmission is improved under the unlicensed spectrum.

In one embodiment, the essence of the above method is that: when a beam is reset, a first counter is used for the channel failure detection, a first parameter indicates a TRP, and the first counter is reset to an initial value when the TRP is reset. The above method has the following benefits: an effective channel failure detection and recovery mechanism is established in the case of beamforming, and the reliability of transmission is improved under the unlicensed spectrum.

In one embodiment, the essence of the above method is that: when a beam is reset, a first counter is used for the channel failure detection, a first parameter indicates an antenna panel, and the first counter is reset to an initial value when the antenna panel is reset. The above method has the following benefits: an effective channel failure detection and recovery mechanism is established in the case of beamforming, and the reliability of transmission is improved under the unlicensed spectrum.

According to one aspect of the disclosure, the above method includes:

when the first counter reaches or exceeds a target threshold, transmitting a first signal.

According to one aspect of the disclosure, the above method includes:

when the first timer expires, resetting the first counter to the initial value.

According to one aspect of the disclosure, the above method includes:

monitoring a first type of signaling in the first subband.

Herein, the first sensing is performed each time the first type of signaling is detected.

According to one aspect of the disclosure, the first type of signaling includes a first field, and the first field in the first type of signaling is used for indicating the first reference signal resource.

According to one aspect of the disclosure, Q counters are one-to-one corresponding to Q reference signal resources, the first reference signal resource is any one of the Q reference signal resources, the first counter is one of the Q counters that is corresponding to the first reference signal resource, and the Q is a positive integer greater than 1.

In one embodiment, the essence of the above method is that: Q reference signal resources correspond to Q beams respectively, and Q counters are used for the channel failure detection under the Q beams respectively.

In one embodiment, the essence of the above method is that: Q reference signal resources correspond to Q TRPs in a first subband respectively, and Q counters are used for the channel failure detection under the Q TRPs respectively.

In one embodiment, the essence of the above method is that: Q reference signal resources correspond to Q antenna panels in a first subband respectively, and Q counters are used for the channel failure detection under the Q antenna panels respectively.

According to one aspect of the disclosure, the above method includes:

as a response to the action that the first parameter is reconfigured, resetting (Q−1) counters to the initial value.

Herein, the Q counters are composed of the first counter and the (Q−1) counters.

The disclosure provides a method in a second node for wireless communication, wherein the method includes:

transmitting a first signaling, the first signaling reconfiguring a first parameter.

Herein, as a response to the action that the first parameter is reconfigured, a target receiver of the first signaling resets a first counter to an initial value; the target receiver of the first signaling performs a first sensing in a first subband; when the first sensing indicates that a channel is busy, the target receiver of the first signaling determines to give up a radio transmission on a first channel, starts a first timer and updates the first counter by 1; the first channel belongs to the first subband in frequency domain, and the first parameter is used for determining a first reference signal resource set; at least one of the radio transmission on the first channel or the first sensing is spatially correlated to a first reference signal resource, the first reference signal resource is one reference signal resource in the first reference signal resource set, and the first reference signal resource set includes at least one reference signal resource.

According to one aspect of the disclosure, the above method includes:

receiving a first signal.

Herein, the first counter reaches or exceeds a target threshold.

According to one aspect of the disclosure, the above method includes: when the first timer expires, the target receiver of the first signaling resets the first counter to the initial value.

According to one aspect of the disclosure, the above method includes:

transmitting a first type of signaling in the first subband.

Herein, the first sensing is performed each time the first type of signaling is detected by the target receiver of the first signaling.

According to one aspect of the disclosure, the first type of signaling includes a first field, and the first field in the first type of signaling is used for indicating the first reference signal resource.

According to one aspect of the disclosure, Q counters are one-to-one corresponding to Q reference signal resources, the first reference signal resource is any one of the Q reference signal resources, and the first counter is one of the Q counters that is corresponding to the first reference signal resource.

According to one aspect of the disclosure, as a response to the action that the first parameter is reconfigured, the target receiver of the first signaling resets (Q−1) counters to the initial value, wherein the Q counters are composed of the first counter and the (Q−1) counters.

The disclosure provides a first node for wireless communication, wherein the first node includes:

a first receiver, to receive a first signaling, the first signaling reconfiguring a first parameter; as a response to the action that the first parameter is reconfigured, to reset a first counter to an initial value; to perform a first sensing in a first subband; and when the first sensing indicates that a channel is busy, to determine to give up a radio transmission on a first channel, to start a first timer and to update the first counter by 1.

Herein, the first channel belongs to the first subband in frequency domain, and the first parameter is used for determining a first reference signal resource set; at least one of the radio transmission on the first channel or the first sensing is spatially correlated to a first reference signal resource, the first reference signal resource is one reference signal resource in the first reference signal resource set, and the first reference signal resource set includes at least one reference signal resource.

The disclosure provides a second node for wireless communication, wherein the second node includes:

a second transmitter, to transmit a first signaling, the first signaling reconfiguring a first parameter.

Herein, as a response to the action that the first parameter is reconfigured, a target receiver of the first signaling resets a first counter to an initial value; the target receiver of the first signaling performs a first sensing in a first subband; when the first sensing indicates that a channel is busy, the target receiver of the first signaling determines to give up a radio transmission on a first channel, starts a first timer and updates the first counter by 1; the first channel belongs to the first subband in frequency domain, and the first parameter is used for determining a first reference signal resource set; at least one of the radio transmission on the first channel or the first sensing is spatially correlated to a first reference signal resource, the first reference signal resource is one reference signal resource in the first reference signal resource set, and the first reference signal resource set includes at least one reference signal resource.

In one embodiment, the method in the disclosure has the following advantages.

Through the method provided in the disclosure, an effective channel failure detection and recovery mechanism is established in the case of beamforming, and the reliability of transmission is improved under the unlicensed spectrum.

Through the method provided in the disclosure, an effective LBT failure detection and recovery mechanism is established for the LBT under multiple TRPs, and the reliability of transmission is improved under the unlicensed spectrum.

Through the method provided in the disclosure, an effective LBT failure detection and recovery mechanism is established for the LBT under multiple antenna panels, and the reliability of transmission is improved under the unlicensed spectrum.

Through the method provided in the disclosure, an effective LBT failure detection and recovery mechanism is established for the LBT under directional antennas, and the reliability of transmission is improved under the unlicensed spectrum.

### BRIEF DESCRIPTION OF THE DRAWINGS

Other features, purposes and advantages of the disclosure will become more apparent from the detailed description of non-restrictive embodiments taken in conjunction with the following drawings.

FIG. 1A is a flowchart of a first sensing, a first counter and a first signal according to one embodiment of the disclosure.

FIG. 1B is a flowchart of a first sensing, a first counter and a first signal according to one embodiment of the disclosure.

FIG. 1C is a flowchart of a first signaling, a first sensing, a first counter and a first timer according to one embodiment of the disclosure.

FIG. 2 is a diagram illustrating a network architecture according to one embodiment of the disclosure.

FIG. 3 is a diagram illustrating a radio protocol architecture of a user plane and a control plane according to one embodiment of the disclosure.

FIG. 4 is a diagram illustrating a first communication equipment and a second communication equipment according to one embodiment of the disclosure.

FIG. 5A is a flowchart of transmission of a radio signal according to one embodiment of the disclosure.

FIG. 5B is a flowchart of transmission of a radio signal according to one embodiment of the disclosure.

FIG. 5C is a flowchart of transmission of a radio signal according to one embodiment of the disclosure.

FIG. 6A is a diagram illustrating a first type of signaling and a first sensing according to one embodiment of the disclosure.

FIG. 6B is a diagram illustrating a first type of signaling and a first sensing according to one embodiment of the disclosure.

FIG. 6C is a diagram illustrating a first type of signaling and a first sensing according to one embodiment of the disclosure.

FIG. 7A is a diagram illustrating Q timers and a first counter according to one embodiment of the disclosure.

FIG. 7B is a diagram illustrating a first timer according to one embodiment of the disclosure.

FIG. 7C is a diagram illustrating a relationship between a first type of signaling and a first reference signal resource according to one embodiment of the disclosure.

FIG. 8A is a diagram illustrating a first signaling according to one embodiment of the disclosure.

FIG. 8B is a diagram illustrating a first timer according to one embodiment of the disclosure.

FIG. 8C is a diagram illustrating a relationship between a first parameter and a first counter according to one embodiment of the disclosure.

FIG. 9A is a diagram illustrating a second signal according to one embodiment of the disclosure.

FIG. 9B is a diagram illustrating a first timer according to one embodiment of the disclosure.

FIG. 9C is a diagram illustrating a relationship between a first parameter and a first counter according to another embodiment of the disclosure.

FIG. 10A is a diagram illustrating a scenario in which a first sensing indicates whether a channel is busy according to one embodiment of the disclosure.

FIG. 10B is a diagram illustrating a first signaling according to one embodiment of the disclosure.

FIG. 10C is a diagram illustrating a triggering condition for a first signal according to one embodiment of the disclosure.

FIG. 11A is a diagram illustrating a scenario in which a first sensing indicates whether a channel is busy according to another embodiment of the disclosure.

FIG. 11B is a diagram illustrating a second signal according to one embodiment of the disclosure.

FIG. 11C is a diagram illustrating a triggering condition for a first signal according to another embodiment of the disclosure.

FIG. 12 is a structure block diagram of a processing device in a first node according to one embodiment of the disclosure.

FIG. 13 is a structure block diagram of a processing device in a second node according to one embodiment of the disclosure.

FIG. 14A is a structure block diagram of a processing device in a first node according to one embodiment of the disclosure.

FIG. 14B is a diagram illustrating a response to a sensing failure indication of a first subband according to one embodiment of the disclosure.

FIG. 15B is a structure block diagram of a processing device in a second node according to one embodiment of the disclosure.

FIG. 15C is a diagram illustrating Q counters according to one embodiment of the disclosure.

FIG. 16 is a structure block diagram of a processing device in a first node according to one embodiment of the disclosure.

FIG. 17 is a structure block diagram of a processing device in a second node according to one embodiment of the disclosure.

### DESCRIPTION OF THE EMBODIMENTS

The technical scheme of the disclosure is described below in further detail in conjunction with the drawings. It should be noted that the embodiments in the disclosure and the characteristics of the embodiments may be mutually combined arbitrarily if no conflict is incurred.

### Embodiment 1A

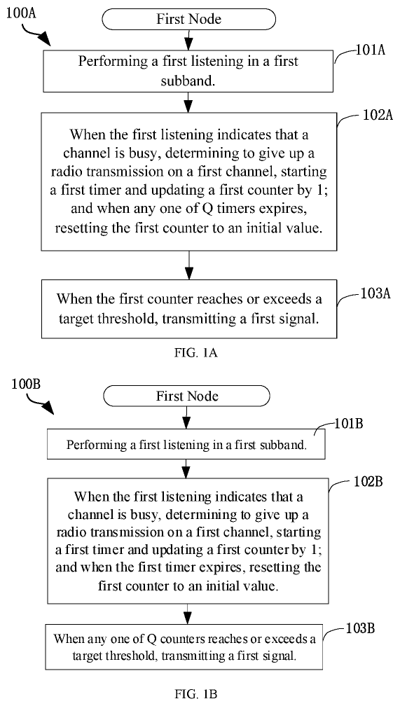

Embodiment 1A illustrates a flowchart of a first sensing, a first counter and a first signal according to one embodiment of the disclosure, as shown in FIG. 1A. In FIG. 1A, each box represents one step, in particular, the order of each box in the figure does not represent the precedence relationship in time between the represented steps.

In Embodiment 1A, the first node in the disclosure, in S101A, performs a first sensing in a first subband; in S102A, when the first sensing indicates that a channel is busy, determines to give up a radio transmission on a first channel, starts a first timer and updates a first counter by 1, and, when any one of Q timers expires, resets the first counter to an initial value; and in S103A, when the first counter reaches or exceeds a target threshold, transmits a first signal. Herein, the first channel belongs to the first subband in frequency domain, the first sensing is correlated to a first index, and the first index is any one of Q indexes; the Q indexes are one-to-one corresponding to the Q timers respectively, and the first timer is one of the Q timers that is corresponding to the first index; and Q is a positive integer greater than 1.

In one embodiment, the first subband is predefined.

In one embodiment, the first subband is preconfigured.

In one embodiment, the first subband is configurable.

In one embodiment, the first subband includes a positive integer number of subcarriers.

In one embodiment, the first subband includes one carrier.

In one embodiment, the first subband includes one Bandwidth Part (BWP).

In one embodiment, the first subband includes one UpLink (UL) BWP.

In one embodiment, the first subband includes one subband.

In one embodiment, the first subband belongs to an unlicensed spectrum.

In one embodiment, the first sensing indicates that a channel is busy or a channel is idle.

In one embodiment, the first sensing is used for determining whether to perform the radio transmission in the first subband.

In one embodiment, the first sensing is used for determining whether to perform the radio transmission on the first channel.

In one embodiment, the first sensing is used for determining whether the first subband is idle or busy.

In one embodiment, when the first sensing indicates that a channel is busy, the first subband is busy; when the first sensing indicates that a channel is idle, the first subband is idle.

In one embodiment, the first sensing includes an energy detection.

In one embodiment, the first sensing includes sensing energies of radio signals in a first subband and averaging the energies over time to obtain a received energy; when the received energy is less than a first energy threshold, the first sensing indicates that a channel is idle; otherwise, the first sensing indicates that a channel is busy.

In one embodiment, the first sensing includes a power detection.

In one embodiment, the first sensing includes sensing a power of a radio signal in a first subband to obtain a received power; when the received power is less than a first power threshold, the first sensing indicates that a channel is idle; otherwise, the first sensing indicates that a channel is busy.

In one embodiment, the first sensing is Listen Before Talk (LBT).

In one embodiment, the first sensing is Uplink LBT.

In one embodiment, the first sensing includes at least one of Type 1 LBT or Type 2 LBT.

In one embodiment, the first sensing includes at least one of Type 1 LBT, Type 2A LBT or Type 2B LBT.

In one embodiment, the first sensing includes Type 1 LBT and Type 2 LBT.

In one embodiment, the first sensing is Clear Channel Assessment (CCA).

In one embodiment, the first sensing includes a coherent detection of signature sequences.

In one embodiment, the first sensing includes performing a coherent reception in the first subband using a signature sequence, and measuring an energy of a signal obtained after the coherent reception; when the energy of the signal obtained after the coherent reception is less than a second energy threshold, the first sensing indicates that a channel is idle; otherwise, the first sensing indicates that a channel is busy.

In one embodiment, the first sensing includes performing a coherent reception in the first subband using a signature sequence, and measuring an energy of a signal obtained after the coherent reception; when the energy of the signal obtained after the coherent reception is less than a second energy threshold, the first sensing indicates that a channel is busy; otherwise, the first sensing indicates that a channel is idle.

In one embodiment, the first sensing includes a Cyclic Redundancy Check (CRC) detection.

In one embodiment, the first sensing includes receiving a radio signal and performing a decoding operation in the first subband; when the decoding is determined to be correct according to CRC bits, the first sensing indicates that a channel is busy; otherwise, the first sensing indicates that a channel is idle.

In one embodiment, the first sensing includes receiving a radio signal and performing a decoding operation in the first subband; when the decoding is determined to be correct according to CRC bits, the first sensing indicates that a channel is idle; otherwise, the first sensing indicates that a channel is busy.

In one embodiment, the first index is a non-negative integer.

In one embodiment, the first index is a positive integer.

In one embodiment, any one of the Q indexes is a non-negative integer.

In one embodiment, any one of the Q indexes is a positive integer.

In one embodiment, any two of the Q indexes are different.

In one embodiment, an expiration value of the first timer is a positive integer.

In one embodiment, an expiration value of the first timer is configurable.

In one embodiment, an expiration value of the first timer is predefined.

In one embodiment, when the first timer reaches an expiration value of the first timer, the first timer expires.

In one embodiment, the phrase of starting a first timer includes setting the first timer to an expiration value; when the first timer reaches 0, the first timer expires.

In one embodiment, when a given timer reaches an expiration value of the given timer, the given timer expires; and the given timer is any one of the Q timers.

In one embodiment, the phrase of starting a first timer includes setting the first timer to an expiration value; when a given timer reaches 0, the given timer expires; and the given timer is any one of the Q timers.

In one embodiment, an initial value of the first counter is 0.

In one embodiment, an initial value of the first counter is a positive integer.

In one embodiment, a target threshold of the first counter is configured.

In one embodiment, a target threshold of the first counter is predefined.

In one embodiment, the first sensing employs a first multiantenna related parameter.

In one embodiment, the first multiantenna related parameter includes an analog beamforming matrix.

In one embodiment, the first multiantenna related parameter includes a digital beamforming matrix.

In one embodiment, the first multiantenna related parameter includes a coefficient of a spatial filter.

In one embodiment, the first multiantenna related parameter includes a Quasi co-location (QCL) parameter.

In one embodiment, the first multiantenna related parameter is correlated to the first index.

In one embodiment, the phrase that the first sensing is correlated to a first index includes: a Transmission Configuration Indicator (TCI) state indicated by the first index is used for the first sensing.

In one embodiment, the phrase that the first sensing is correlated to a first index includes: a Transmission Configuration Indicator (TCI) state indicated by the first index is used for determining the first multiantenna related parameter.

In one embodiment, the phrase that the first sensing is correlated to a first index includes: the first index is used for determining a first reference signal resource, and the first sensing is correlated to the first reference signal resource.

In one embodiment, the phrase that the first sensing is correlated to a first index includes: the first index is used for determining a first reference signal resource, and a QCL parameter for receiving the first reference signal resource is used for the first sensing.

In one subembodiment, the first reference signal resource is a downlink reference signal resource.

In one subembodiment, the first reference signal resource is a sidelink reference signal resource.

In one embodiment, the phrase that the first sensing is correlated to a first index includes: the first index is used for determining the first multiantenna related parameter.

In one embodiment, the phrase that the first sensing is correlated to a first index includes: the first index is used for determining a first reference signal resource, and the first multiantenna related parameter is correlated to the first reference signal resource.

In one embodiment, the phrase that the first sensing is correlated to a first index includes: the first index is used for determining a first reference signal resource, and a QCL parameter for receiving the first reference signal resource is used for determining the multiantenna related parameter.

In one subembodiment, the first reference signal resource is a downlink reference signal resource.

In one subembodiment, the first reference signal resource is a sidelink reference signal resource.

In one embodiment, the phrase that the first sensing is correlated to a first index includes: the first index is used for determining a first reference signal resource, and a QCL parameter for receiving the first reference signal resource is the same as the multiantenna related parameter.

In one subembodiment, the first reference signal resource is a downlink reference signal resource.

In one subembodiment, the first reference signal resource is a sidelink reference signal resource.

In one embodiment, the phrase that the first sensing is correlated to a first index includes: the first index is used for determining a first reference signal resource, and a QCL parameter for transmitting the first reference signal resource is used for the first sensing.

In one subembodiment, the first reference signal resource is an uplink reference signal resource.

In one subembodiment, the first reference signal resource is a sidelink reference signal resource.

In one embodiment, the phrase that the first sensing is correlated to a first index includes: the first index is used for determining a first reference signal resource, and a QCL parameter for transmitting the first reference signal resource is used for determining the first multiantenna related parameter.

In one subembodiment, the first reference signal resource is an uplink reference signal resource.

In one subembodiment, the first reference signal resource is a sidelink reference signal resource.

In one embodiment, the phrase that the first sensing is correlated to a first index includes: the first index is used for determining a first reference signal resource, and a QCL parameter for transmitting the first reference signal resource is the same as the first multiantenna related parameter.

In one subembodiment, the first reference signal resource is an uplink reference signal resource.

In one subembodiment, the first reference signal resource is a sidelink reference signal resource.

In one embodiment, the downlink reference signal resource includes a Synchronization/Physical Broadcast Channel (SS/PBCH) block.

In one embodiment, the downlink reference signal resource includes a Channel State Information-Reference Signal (CSI-RS) resource.

In one embodiment, the downlink reference signal resource includes at least one of a CSI-RS resource or an SS/PBCH block.

In one embodiment, the uplink reference signal resource includes a Sounding Reference Signal (SRS) resource.

In one embodiment, the uplink reference signal resource includes an uplink DeModulation Reference Signals (DMRS) resource.

In one embodiment, the uplink reference signal resource includes at least one of an SRS resource or an uplink DMRS resource.

In one embodiment, the sidelink reference signal resource includes a Sidelink CSI-RS resource.

In one embodiment, the sidelink reference signal resource includes a Sidelink DMRS resource.

In one embodiment, the sidelink reference signal resource includes at least one of a Sidelink CSI-RS resource or a Sidelink DMRS resource.

In one embodiment, the QCL parameter includes a spatial parameter.

In one embodiment, the QCL parameter includes a spatial RX parameter.

In one embodiment, the QCL parameter includes a spatial TX parameter.

In one embodiment, the QCL parameter includes a spatial domain filter.

In one embodiment, the QCL parameter includes a spatial domain transmission filter.

In one embodiment, the QCL parameter includes a beam.

In one embodiment, the QCL parameter includes a beamforming matrix.

In one embodiment, the QCL parameter includes a beamforming vector.

In one embodiment, the QCL parameter includes an analog beamforming matrix.

In one embodiment, the QCL parameter includes an analog beamforming vector.

In one embodiment, the QCL parameter includes an angle of arrival.

In one embodiment, the QCL parameter includes an angle of departure.

In one embodiment, the QCL parameter includes a spatial correlation.

In one embodiment, a type of the QCL parameter includes QCL-TypeD.

In one embodiment, a type of the QCL parameter includes at least one of QCL-TypeA, QCL-TypeB or QCL-TypeC.

In one embodiment, a type of the QCL parameter includes at least one of Doppler shift, Doppler spread, average delay or delay spread.

In one embodiment, the first node is a UE, and the first channel includes an uplink channel.

In one embodiment, the first node is a base station, and the first channel includes a downlink channel.

In one embodiment, the first node is a UE, and the first channel includes a sidelink channel.

In one embodiment, the first channel includes a Physical Uplink Shared Channel (PUSCH).

In one embodiment, the first channel includes a Physical Uplink Control Channel (PUCCH).

In one embodiment, the first channel includes a Physical Sidelink Shared Channel (PSSCH).

In one embodiment, the first channel includes a Physical Sidelink Control Channel (PSCCH).

In one embodiment, the first channel includes a Physical Sidelink Feedback Channel (PSFCH).

In one embodiment, the first channel includes a Physical Downlink Shared Channel (PDSCH).

In one embodiment, the first channel includes a Physical Downlink Control Channel (PDCCH).

In one embodiment, the first channel is reserved for a downlink reference signal resource.

In one embodiment, the first channel is reserved for an uplink reference signal resource.

In one embodiment, the first channel is reserved for a sidelink reference signal resource.

In one embodiment, the phrase of giving up a radio transmission on a first channel includes: keeping a zero transmit power on the first channel.

In one embodiment, the phrase of giving up a radio transmission on a first channel includes: in time domain resources occupied by the first channel, performing a channel sensing in the first subband.

In one embodiment, the phrase of giving up a radio transmission on a first channel includes: in time domain resources occupied by the first channel, performing LBT in the first subband.

In one embodiment, the phrase of giving up a radio transmission on a first channel includes: modulation symbols generated for the radio transmission on the first channel are dropped.

In one embodiment, the phrase of giving up a radio transmission on a first channel includes: modulation symbols generated for the radio transmission on the first channel are delayed to transmit.

In one embodiment, the phrase of giving up a radio transmission on a first channel includes: modulation symbols generated for the radio transmission on the first channel are transmitted in time-frequency resources that are orthogonal to time-frequency resources occupied by the first channel.

In one embodiment, the phrase of starting a first timer includes setting the first timer to 0, and increasing the first timer by 1 every one first-type time interval.

In one subembodiment, the above operation is performed in regardless of whether the first timer is running or not.

In one subembodiment, when the first timer reaches an expiration value of the first timer, the first timer expires.

In one embodiment, the phrase of starting a first timer includes setting the first timer to an expiration value, and decreasing the first timer by 1 every one first-type time interval.

In one subembodiment, the above operation is performed in regardless of whether the first timer is running or not.

In one subembodiment, when the first timer reaches 0, the first timer expires.

In one embodiment, the one first-type time interval is one subframe.

In one embodiment, the one first-type time interval is one slot.

In one embodiment, the one first-type time interval is one Transport Time Interval (TTI).

In one embodiment, in the first subband, when there is no time-frequency resource reserved for uplink transmission in one subframe, the one subframe does not belong to the first-type time interval.

In one embodiment, in the first subband, when the first node is configured to Discontinuous Transmission (DTX) in one subframe, the one subframe does not belong to the first-type time interval.

In one embodiment, the phrase of updating a first counter by 1 includes: the first counter increases by 1; the initial value of the first counter is 0, and the target threshold of the first counter is a positive integer greater than the initial value of the first counter.

In one subembodiment, the target threshold of the first counter is equal to 1.

In one subembodiment, the target threshold of the first counter is a positive integer greater than 1.

In one embodiment, the phrase of updating a first counter by 1 includes: the first counter decreases by 1; the initial value of the first counter is a positive integer, and the target threshold of the first counter is an integer less than the initial value of the first counter.

In one subembodiment, the target threshold of the first counter is a non-negative integer less than the initial value of the first counter.

In one subembodiment, the target threshold of the first counter is equal to 0.

In one subembodiment, the target threshold of the first counter is equal to 1.

In one embodiment, the phrase that any one of Q timers expires refers that: one of the Q timers expires.

In one embodiment, the phrase that any one of Q timers expires refers that: at least one of the Q timers expires.

In one embodiment, the phrase that any one of Q timers expires refers that: all of the Q timers expire.

In one embodiment, when one of the Q timers expires, the condition that when any one of Q timers expires is met.

In one embodiment, when none of the Q timers expires, the condition that when any one of Q timers expires is not met.

In one embodiment, when more than one of the Q timers expires, the condition that when any one of Q timers expires is met.

In one embodiment, when all of the Q timers expire, the condition that when any one of Q timers expires is met.

In one embodiment, the higher layer includes Layer 2 (L2 layer).

In one embodiment, the higher layer includes Layer 3 (L3 layer).

In one embodiment, the higher layer includes a Radio Resource Control (RRC) layer.

In one embodiment, the higher layer includes Layer 2 (L2 layer) and Layer 3 (L3 layer).

In one embodiment, the higher layer includes Layer 2 (L2 layer) and layers above Layer 2.

In one embodiment, the first signal includes one physical layer signal.

In one embodiment, the first signal includes one higher layer signal.

In one embodiment, the first signal is transmitted on a PUSCH.

In one embodiment, the first signal is transmitted on a PUCCH.

In one embodiment, the first signal includes a scheduling request.

In one embodiment, the first signal includes a Media Access Control Control Element (MAC CE).

In one embodiment, the first signal includes an LBT failure MAC CE.

In one embodiment, the first signal includes a scheduling request for an LBT failure MAC CE.

In one embodiment, the first signal includes a second index, and the second index is one of the Q indexes.

In one embodiment, the first signal includes a second index, and the second index is one of the Q indexes that is different from the first index.

In one embodiment, the Q indexes are used for determining Q multiantenna related parameters respectively.

In one embodiment, Q multiantenna related parameters are correlated to the Q indexes respectively.

In one embodiment, the first multiantenna related parameter is one of the Q multiantenna related parameters that is determined by the first index.

In one embodiment, any one of the Q multiantenna related parameters includes an analog beamforming matrix.

In one embodiment, any one of the Q multiantenna related parameters includes a digital beamforming matrix.

In one embodiment, any one of the Q multiantenna related parameters includes a coefficient of a spatial filter.

In one embodiment, any one of the Q multiantenna related parameters includes a QCL parameter.

In one embodiment, the Q multiantenna related parameters are TCI states indicated by the Q indexes respectively.

In one embodiment, TCI states indicated by the Q indexes are used for determining the Q multiantenna related parameters respectively.

In one embodiment, the Q indexes are used for determining Q reference signal resources respectively, and the Q multiantenna related parameters are correlated to the Q reference signal resources respectively.

In one embodiment, the Q indexes are used for determining Q reference signal resources respectively, and the Q reference signal resources are used for determining the Q multiantenna related parameters respectively.

In one embodiment, a given index is one of the Q indexes, a given reference signal resource is one of the Q reference signal resources that is determined by the given index, a given multiantenna related parameter is one of the Q multiantenna related parameters that is determined by the given reference signal resource; and a QCL parameter for receiving the given reference signal resource is used for determining the given multiantenna related parameter.

In one subembodiment, the given reference signal resource is a downlink reference signal resource.

In one subembodiment, the given reference signal resource is a sidelink reference signal resource.

In one embodiment, a given index is one of the Q indexes, a given reference signal resource is one of the Q reference signal resources that is determined by the given index, a given multiantenna related parameter is one of the Q multiantenna related parameters that is determined by the given reference signal resource; and the given multiantenna related parameter is a QCL parameter for receiving the given reference signal resource.

In one subembodiment, the given reference signal resource is a downlink reference signal resource.

In one subembodiment, the given reference signal resource is a sidelink reference signal resource.

In one embodiment, a given index is one of the Q indexes, a given reference signal resource is one of the Q reference signal resources that is determined by the given index, a given multiantenna related parameter is one of the Q multiantenna related parameters that is determined by the given reference signal resource; and a QCL parameter for transmitting the given reference signal resource is used for determining the given multiantenna related parameter.

In one subembodiment, the given reference signal resource is an uplink reference signal resource.

In one subembodiment, the given reference signal resource is a sidelink reference signal resource.

In one embodiment, a given index is one of the Q indexes, a given reference signal resource is one of the Q reference signal resources that is determined by the given index, a given multiantenna related parameter is one of the Q multiantenna related parameters that is determined by the given reference signal resource; and the given multiantenna related parameter is a QCL parameter for transmitting the given reference signal resource.

In one subembodiment, the given reference signal resource is an uplink reference signal resource.

In one subembodiment, the given reference signal resource is a sidelink reference signal resource.

### Embodiment 1B

Embodiment 1B illustrates a flowchart of a first sensing, a first counter and a first signal according to one embodiment of the disclosure, as shown in FIG. 1B. In FIG. 1B, each box represents one step, in particular, the order of each box in the figure does not represent the precedence relationship in time between the represented steps.

In Embodiment 1B, the first node in the disclosure, in S101B, performs a first sensing in a first subband; in S102B, when the first sensing indicates that a channel is busy, determines to give up a radio transmission on a first channel, starts a first timer and updates a first counter by 1, and, when the first timer expires, resets the first counter to an initial value; and in S103B, when any one of Q counters reaches or exceeds a target threshold, transmits a first signal. Herein, the first channel belongs to the first subband in frequency domain, the first sensing is correlated to a first index, and the first index is any one of Q indexes; the Q indexes are one-to-one corresponding to the Q counters respectively, and the first counter is one of the Q counters that is corresponding to the first index; and Q is a positive integer greater than 1.

In one embodiment, the first subband is predefined.

In one embodiment, the first subband is preconfigured.

In one embodiment, the first subband is configurable.

In one embodiment, the first subband includes a positive integer number of subcarriers.

In one embodiment, the first subband includes one carrier.

In one embodiment, the first subband includes one Bandwidth Part (BWP).

In one embodiment, the first subband includes one UpLink (UL) BWP.

In one embodiment, the first subband includes one subband.

In one embodiment, the first subband belongs to an unlicensed spectrum.

In one embodiment, the first sensing indicates that a channel is busy or a channel is idle.

In one embodiment, the first sensing is used for determining whether to perform the radio transmission in the first subband.

In one embodiment, the first sensing is used for determining whether to perform the radio transmission on the first channel.

In one embodiment, the first sensing is used for determining whether the first subband is idle or busy.

In one embodiment, when the first sensing indicates that a channel is busy, the first subband is busy; when the first sensing indicates that a channel is idle, the first subband is idle.

In one embodiment, the first sensing includes an energy detection.

In one embodiment, the first sensing includes sensing energies of radio signals in a first subband and averaging the energies over time to obtain a received energy; when the received energy is less than a first energy threshold, the first sensing indicates that a channel is idle; otherwise, the first sensing indicates that a channel is busy.

In one embodiment, the first sensing includes a power detection.

In one embodiment, the first sensing includes sensing a power of a radio signal in a first subband to obtain a received power; when the received power is less than a first power threshold, the first sensing indicates that a channel is idle; otherwise, the first sensing indicates that a channel is busy.

In one embodiment, the first sensing is Listen Before Talk (LBT).

In one embodiment, the first sensing is Uplink LBT.

In one embodiment, the first sensing includes at least one of Type 1 LBT or Type 2 LBT.

In one embodiment, the first sensing includes at least one of Type 1 LBT, Type 2A LBT or Type 2B LBT.

In one embodiment, the first sensing includes Type 1 LBT and Type 2 LBT.

In one embodiment, the first sensing is Clear Channel Assessment (CCA).

In one embodiment, the first sensing includes a coherent detection of signature sequences.

In one embodiment, the first sensing includes performing a coherent reception in the first subband using a signature sequence, and measuring an energy of a signal obtained after the coherent reception; when the energy of the signal obtained after the coherent reception is less than a second energy threshold, the first sensing indicates that a channel is idle; otherwise, the first sensing indicates that a channel is busy.

In one embodiment, the first sensing includes performing a coherent reception in the first subband using a signature sequence, and measuring an energy of a signal obtained after the coherent reception; when the energy of the signal obtained after the coherent reception is less than a second energy threshold, the first sensing indicates that a channel is busy; otherwise, the first sensing indicates that a channel is idle.

In one embodiment, the first sensing includes a Cyclic Redundancy Check (CRC) detection.

In one embodiment, the first sensing includes receiving a radio signal and performing a decoding operation in the first subband; when the decoding is determined to be correct according to CRC bits, the first sensing indicates that a channel is busy; otherwise, the first sensing indicates that a channel is idle.

In one embodiment, the first sensing includes receiving a radio signal and performing a decoding operation in the first subband; when the decoding is determined to be correct according to CRC bits, the first sensing indicates that a channel is idle; otherwise, the first sensing indicates that a channel is busy.

In one embodiment, the first index is a non-negative integer.

In one embodiment, the first index is a positive integer.

In one embodiment, any one of the Q indexes is a non-negative integer.

In one embodiment, any one of the Q indexes is a positive integer.

In one embodiment, any two of the Q indexes are different.

In one embodiment, target thresholds of all the Q counters are the same.

In one embodiment, target thresholds of at least two of the Q counters are different.

In one embodiment, target thresholds of the Q counters are configured respectively.

In one embodiment, target thresholds of the Q counters are predefined respectively.

In one embodiment, an expiration value of the first timer is a positive integer.

In one embodiment, an expiration value of the first timer is configurable.

In one embodiment, an expiration value of the first timer is predefined.

In one embodiment, initial values of all the Q counters are 0, and target thresholds of all the Q counters are positive integers.

In one embodiment, initial values of all the Q counters are positive integers, and target thresholds of all the Q counters are 0.

In one embodiment, initial values of all the Q counters are positive integers, and target thresholds of all the Q counters are 1.

In one embodiment, when the first timer reaches an expiration value of the first timer, the first timer expires.

In one embodiment, an initial value of the first counter is 0.

In one embodiment, an initial value of the first counter is a positive integer.

In one embodiment, initial values of all the Q counters are 0.

In one embodiment, initial values of all the Q counters are positive integers.

In one embodiment, the first sensing employs a first multiantenna related parameter.

In one embodiment, the first multiantenna related parameter includes an analog beamforming matrix.

In one embodiment, the first multiantenna related parameter includes a digital beamforming matrix.

In one embodiment, the first multiantenna related parameter includes a coefficient of a spatial filter.

In one embodiment, the first multiantenna related parameter includes a Quasi co-location (QCL) parameter.

In one embodiment, the first multiantenna related parameter is correlated to the first index.

In one embodiment, the phrase that the first sensing is correlated to a first index includes: a Transmission Configuration Indicator (TCI) state indicated by the first index is used for the first sensing.

In one embodiment, the phrase that the first sensing is correlated to a first index includes: a Transmission Configuration Indicator (TCI) state indicated by the first index is used for determining the first multiantenna related parameter.

In one embodiment, the phrase that the first sensing is correlated to a first index includes: the first index is used for determining a first reference signal resource, and the first sensing is correlated to the first reference signal resource.

In one embodiment, the phrase that the first sensing is correlated to a first index includes: the first index is used for determining a first reference signal resource, and a QCL parameter for receiving the first reference signal resource is used for the first sensing.

In one subembodiment, the first reference signal resource is a downlink reference signal resource.

In one subembodiment, the first reference signal resource is a sidelink reference signal resource.

In one embodiment, the phrase that the first sensing is correlated to a first index includes: the first index is used for determining the first multiantenna related parameter.

In one embodiment, the phrase that the first sensing is correlated to a first index includes: the first index is used for determining a first reference signal resource, and the first multiantenna related parameter is correlated to the first reference signal resource.

In one embodiment, the phrase that the first sensing is correlated to a first index includes: the first index is used for determining a first reference signal resource, and a QCL parameter for receiving the first reference signal resource is used for determining the multiantenna related parameter.

In one subembodiment, the first reference signal resource is a downlink reference signal resource.

In one subembodiment, the first reference signal resource is a sidelink reference signal resource.

In one embodiment, the phrase that the first sensing is correlated to a first index includes: the first index is used for determining a first reference signal resource, and a QCL parameter for receiving the first reference signal resource is the same as the multiantenna related parameter.

In one subembodiment, the first reference signal resource is a downlink reference signal resource.

In one subembodiment, the first reference signal resource is a sidelink reference signal resource.

In one embodiment, the phrase that the first sensing is correlated to a first index includes: the first index is used for determining a first reference signal resource, and a QCL parameter for transmitting the first reference signal resource is used for the first sensing.

In one subembodiment, the first reference signal resource is an uplink reference signal resource.

In one subembodiment, the first reference signal resource is a sidelink reference signal resource.

In one embodiment, the phrase that the first sensing is correlated to a first index includes: the first index is used for determining a first reference signal resource, and a QCL parameter for transmitting the first reference signal resource is used for determining the first multiantenna related parameter.

In one subembodiment, the first reference signal resource is an uplink reference signal resource.

In one subembodiment, the first reference signal resource is a sidelink reference signal resource.

In one embodiment, the phrase that the first sensing is correlated to a first index includes: the first index is used for determining a first reference signal resource, and a QCL parameter for transmitting the first reference signal resource is the same as the first multiantenna related parameter.

In one subembodiment, the first reference signal resource is an uplink reference signal resource.

In one subembodiment, the first reference signal resource is a sidelink reference signal resource.

In one embodiment, the downlink reference signal resource includes a Synchronization/Physical Broadcast Channel (SS/PBCH) block.

In one embodiment, the downlink reference signal resource includes a Channel State Information-Reference Signal (CSI-RS) resource.

In one embodiment, the downlink reference signal resource includes at least one of a CSI-RS resource or an SS/PBCH block.

In one embodiment, the uplink reference signal resource includes a Sounding Reference Signal (SRS) resource.

In one embodiment, the uplink reference signal resource includes an uplink DeModulation Reference Signals (DMRS) resource.

In one embodiment, the uplink reference signal resource includes at least one of an SRS resource or an uplink DMRS resource.

In one embodiment, the sidelink reference signal resource includes a Sidelink CSI-RS resource.

In one embodiment, the sidelink reference signal resource includes a Sidelink DMRS resource.

In one embodiment, the sidelink reference signal resource includes at least one of a Sidelink CSI-RS resource or a Sidelink DMRS resource.

In one embodiment, the QCL parameter includes a spatial parameter.

In one embodiment, the QCL parameter includes a spatial RX parameter.

In one embodiment, the QCL parameter includes a spatial TX parameter.

In one embodiment, the QCL parameter includes a spatial domain filter.

In one embodiment, the QCL parameter includes a spatial domain transmission filter.

In one embodiment, the QCL parameter includes a beam.

In one embodiment, the QCL parameter includes a beamforming matrix.

In one embodiment, the QCL parameter includes a beamforming vector.

In one embodiment, the QCL parameter includes an analog beamforming matrix.

In one embodiment, the QCL parameter includes an analog beamforming vector.

In one embodiment, the QCL parameter includes an angle of arrival.

In one embodiment, the QCL parameter includes an angle of departure.

In one embodiment, the QCL parameter includes a spatial correlation.

In one embodiment, a type of the QCL parameter includes QCL-TypeD.

In one embodiment, a type of the QCL parameter includes at least one of QCL-TypeA, QCL-TypeB or QCL-TypeC.

In one embodiment, a type of the QCL parameter includes at least one of Doppler shift, Doppler spread, average delay or delay spread.

In one embodiment, the first node is a UE, and the first channel includes an uplink channel.

In one embodiment, the first node is a base station, and the first channel includes a downlink channel.

In one embodiment, the first node is a UE, and the first channel includes a sidelink channel.

In one embodiment, the first channel includes a Physical Uplink Shared Channel (PUSCH).

In one embodiment, the first channel includes a Physical Uplink Control Channel (PUCCH).

In one embodiment, the first channel includes a Physical Sidelink Shared Channel (PSSCH).

In one embodiment, the first channel includes a Physical Sidelink Control Channel (PSCCH).

In one embodiment, the first channel includes a Physical Sidelink Feedback Channel (PSFCH).

In one embodiment, the first channel includes a Physical Downlink Shared Channel (PDSCH).

In one embodiment, the first channel includes a Physical Downlink Control Channel (PDCCH).

In one embodiment, the first channel is reserved for a downlink reference signal resource.

In one embodiment, the first channel is reserved for an uplink reference signal resource.

In one embodiment, the first channel is reserved for a sidelink reference signal resource.

In one embodiment, the phrase of giving up a radio transmission on a first channel includes: keeping a zero transmit power on the first channel.

In one embodiment, the phrase of giving up a radio transmission on a first channel includes: in time domain resources occupied by the first channel, performing a channel sensing in the first subband.

In one embodiment, the phrase of giving up a radio transmission on a first channel includes: in time domain resources occupied by the first channel, performing LBT in the first subband.

In one embodiment, the phrase of giving up a radio transmission on a first channel includes: modulation symbols generated for the radio transmission on the first channel are dropped.

In one embodiment, the phrase of giving up a radio transmission on a first channel includes: modulation symbols generated for the radio transmission on the first channel are delayed to transmit.

In one embodiment, the phrase of giving up a radio transmission on a first channel includes: modulation symbols generated for the radio transmission on the first channel are transmitted in time-frequency resources that are orthogonal to time-frequency resources occupied by the first channel.

In one embodiment, the phrase of starting a first timer includes setting the first timer to 0, and increasing the first timer by 1 every one first-type time interval.

In one subembodiment, the above operation is performed in regardless of whether the first timer is running or not.

In one subembodiment, when the first timer reaches an expiration value of the first timer, the first timer expires.

In one embodiment, the phrase of starting a first timer includes setting the first timer to an expiration value, and decreasing the first timer by 1 every one first-type time interval.

In one subembodiment, the above operation is performed in regardless of whether the first timer is running or not.

In one subembodiment, when the first timer reaches 0, the first timer expires.

In one embodiment, the one first-type time interval is one subframe.

In one embodiment, the one first-type time interval is one slot.

In one embodiment, the one first-type time interval is one Transport Time Interval (TTI).

In one embodiment, in the first subband, when there is no time-frequency resource reserved for uplink transmission in one subframe, the one subframe does not belong to the first-type time interval.

In one embodiment, in the first subband, when the first node is configured to Discontinuous Transmission (DTX) in one subframe, the one subframe does not belong to the first-type time interval.

In one embodiment, the phrase of updating a first counter by 1 includes: the first counter increases by 1; the initial value of the first counter is 0, and the target threshold of the first counter is a positive integer greater than the initial value of the first counter.

In one subembodiment, the target threshold of the first counter is equal to 1.

In one subembodiment, the target threshold of the first counter is a positive integer greater than 1.

In one embodiment, the phrase of updating a first counter by 1 includes: the first counter decreases by 1; the initial value of the first counter is a positive integer, and the target threshold of the first counter is an integer less than the initial value of the first counter.

In one subembodiment, the target threshold of the first counter is a non-negative integer less than the initial value of the first counter.

In one subembodiment, the target threshold of the first counter is equal to 0.

In one subembodiment, the target threshold of the first counter is equal to 1.

In one embodiment, the phrase that any one of Q counters reaches or exceeds a target threshold refers that: one of the Q counters reaches or exceeds the target threshold.

In one embodiment, the phrase that any one of Q counters reaches or exceeds a target threshold refers that: at least one of the Q counters reaches or exceeds the target threshold.

In one embodiment, the phrase that any one of Q counters reaches or exceeds a target threshold refers that: the Q counters all reach or exceed the target threshold.

In one embodiment, when one of the Q counters reaches or exceeds the target threshold, the condition that when any one of Q counters reaches or exceeds a target threshold is met.

In one embodiment, when none of the Q counters reaches the target threshold, the condition that when any one of Q counters reaches or exceeds a target threshold is not met.

In one embodiment, when more than one of the Q counters reaches or exceeds the target threshold, the condition that when any one of Q counters reaches or exceeds a target threshold is met.

In one embodiment, when all of the Q counters reach or exceed the target threshold, the condition that when any one of Q counters reaches or exceeds a target threshold is met.

In one embodiment, the higher layer includes Layer 2 (L2 layer).

In one embodiment, the higher layer includes Layer 3 (L3 layer).

In one embodiment, the higher layer includes a Radio Resource Control (RRC) layer.

In one embodiment, the higher layer includes Layer 2 (L2 layer) and Layer 3 (L3 layer).

In one embodiment, the higher layer includes Layer 2 (L2 layer) and layers above Layer 2.

In one embodiment, the first signal includes one physical layer signal.

In one embodiment, the first signal includes one higher layer signal.

In one embodiment, the first signal is transmitted on a PUSCH.

In one embodiment, the first signal is transmitted on a PUCCH.

In one embodiment, the first signal includes a scheduling request.

In one embodiment, the first signal includes a Media Access Control Control Element (MAC CE).

In one embodiment, the first signal includes an LBT failure MAC CE.

In one embodiment, the first signal includes a scheduling request for an LBT failure MAC CE.

In one embodiment, the first signal includes a second index, and the second index is one of the Q indexes.

In one embodiment, the first signal includes a second index, and the second index is one of the Q indexes that is different from the first index.

In one embodiment, the Q indexes are used for determining Q multiantenna related parameters respectively.

In one embodiment, Q multiantenna related parameters are correlated to the Q indexes respectively.

In one embodiment, the first multiantenna related parameter is one of the Q multiantenna related parameters that is determined by the first index.

In one embodiment, any one of the Q multiantenna related parameters includes an analog beamforming matrix.

In one embodiment, any one of the Q multiantenna related parameters includes a digital beamforming matrix.

In one embodiment, any one of the Q multiantenna related parameters includes a coefficient of a spatial filter.

In one embodiment, any one of the Q multiantenna related parameters includes a QCL parameter.

In one embodiment, the Q multiantenna related parameters are TCI states indicated by the Q indexes respectively.

In one embodiment, TCI states indicated by the Q indexes are used for determining the Q multiantenna related parameters respectively.

In one embodiment, the Q indexes are used for determining Q reference signal resources respectively, and the Q multiantenna related parameters are correlated to the Q reference signal resources respectively.

In one embodiment, the Q indexes are used for determining Q reference signal resources respectively, and the Q reference signal resources are used for determining the Q multiantenna related parameters respectively.

In one embodiment, a given index is one of the Q indexes, a given reference signal resource is one of the Q reference signal resources that is determined by the given index, a given multiantenna related parameter is one of the Q multiantenna related parameters that is determined by the given reference signal resource; and a QCL parameter for receiving the given reference signal resource is used for determining the given multiantenna related parameter.

In one subembodiment, the given reference signal resource is a downlink reference signal resource.

In one subembodiment, the given reference signal resource is a sidelink reference signal resource.

In one embodiment, a given index is one of the Q indexes, a given reference signal resource is one of the Q reference signal resources that is determined by the given index, a given multiantenna related parameter is one of the Q multiantenna related parameters that is determined by the given reference signal resource; and the given multiantenna related parameter is a QCL parameter for receiving the given reference signal resource.

In one subembodiment, the given reference signal resource is a downlink reference signal resource.

In one subembodiment, the given reference signal resource is a sidelink reference signal resource.

In one embodiment, a given index is one of the Q indexes, a given reference signal resource is one of the Q reference signal resources that is determined by the given index, a given multiantenna related parameter is one of the Q multiantenna related parameters that is determined by the given reference signal resource; and a QCL parameter for transmitting the given reference signal resource is used for determining the given multiantenna related parameter.

In one subembodiment, the given reference signal resource is an uplink reference signal resource.

In one subembodiment, the given reference signal resource is a sidelink reference signal resource.

In one embodiment, a given index is one of the Q indexes, a given reference signal resource is one of the Q reference signal resources that is determined by the given index, a given multiantenna related parameter is one of the Q multiantenna related parameters that is determined by the given reference signal resource; and the given multiantenna related parameter is a QCL parameter for transmitting the given reference signal resource.

In one subembodiment, the given reference signal resource is an uplink reference signal resource.

In one subembodiment, the given reference signal resource is a sidelink reference signal resource.

### Embodiment 1C

Embodiment 1C illustrates a flowchart of a first signaling, a first sensing, a first counter and a first timer according to one embodiment of the disclosure, as shown in FIG. 1C. In FIG. 1C, each box represents one step, in particular, the order of each box in the figure does not represent the precedence relationship in time between the represented steps.

In Embodiment 1C, the first node in the disclosure, in S101C, receives a first signaling, the first signaling reconfiguring a first parameter; in S102C, as a response to the action that the first parameter is reconfigured, resets a first counter to an initial value; in S103C, performs a first sensing in a first subband; in S104C, when the first sensing indicates that a channel is busy, determines to give up a radio transmission on a first channel, starts a first timer and updates the first counter by 1. Herein, the first channel belongs to the first subband in frequency domain, and the first parameter is used for determining a first reference signal resource set; at least one of the radio transmission on the first channel and the first sensing is spatially correlated to a first reference signal resource, the first reference signal resource is one reference signal resource in the first reference signal resource set, and the first reference signal resource set includes at least one reference signal resource.

In one embodiment, the first signaling is a higher layer signaling.

In one embodiment, the first signaling is an RRC signaling.

In one embodiment, the first signaling is an MAC CE signaling.

In one embodiment, the first signaling includes one RRC Information Element (IE).

In one embodiment, the first signaling includes at least partial fields in one RRC IE.

In one embodiment, the first signaling includes multiple RRC IEs.

In one embodiment, the first signaling includes an LBT-FailureRecoveryConfig IE.

In one embodiment, the first signaling includes at least partial fields in an LBT-FailureRecoveryConfig IE.

In one embodiment, the first signaling includes an LBT-FailureRecoveryConfig-r16 IE.

In one embodiment, the first signaling includes at least partial fields in an LBT-FailureRecoveryConfig-r16 IE.

In one embodiment, the first signaling includes a TCI-State IE.

In one embodiment, the first signaling includes at least partial fields in a TCI-State IE.

In one embodiment, the first signaling includes an SRS-Config IE.

In one embodiment, the first signaling includes at least partial fields in an SRS-Config IE.

In one embodiment, the first signaling includes a PUSCH-Config IE.

In one embodiment, the first signaling includes at least partial fields in a PUSCH-Config IE.

In one embodiment, the first signaling includes a PDSCH-Config IE.

In one embodiment, the first signaling includes at least partial fields in a PDSCH-Config.

In one embodiment, the first signaling includes a ControlResourceSet IE.

In one embodiment, the first signaling includes at least partial fields in a ControlResourceSet IE.

In one embodiment, a name of one RRC IE included in the first signaling includes lbt.

In one embodiment, a name of one RRC IE included in the first signaling includes LBT.

In one embodiment, the first signaling also reconfigures a maximum value of the first counter.

In one embodiment, the first signaling also reconfigures a target threshold of the first counter.

In one embodiment, the first signaling also reconfigures an expiration value of the first timer.

In one embodiment, the first reference signal resource set includes the first reference signal resource only.

In one embodiment, the first reference signal resource set includes more than one reference signal resource.

In one embodiment, the first reference signal resource set also includes a reference signal resource other than the first reference signal resource.

In one embodiment, the first reference signal resource set includes at least one of a downlink reference signal resource and an uplink reference signal resource.

In one embodiment, the first reference signal resource set includes at least one of a downlink reference signal resource, an uplink reference signal resource or a sidelink reference signal resource.

In one embodiment, the first reference signal resource set includes an uplink reference signal resource.

In one embodiment, the first reference signal resource set includes a downlink reference signal resource.

In one embodiment, the first reference signal resource set includes a sidelink reference signal resource.

In one embodiment, the downlink reference signal resource includes a Synchronization/Physical Broadcast Channel (SS/PBCH) block.

In one embodiment, the downlink reference signal resource includes a Channel State Information-Reference Signal (CSI-RS) resource.

In one embodiment, the downlink reference signal resource includes at least one of a CSI-RS resource or an SS/PBCH block.

In one embodiment, the uplink reference signal resource includes a Sounding Reference Signal (SRS) resource.

In one embodiment, the uplink reference signal resource includes an uplink DeModulation Reference Signals (DMRS) resource.

In one embodiment, the uplink reference signal resource includes at least one of an SRS resource or an uplink DMRS resource.

In one embodiment, the sidelink reference signal resource includes a Sidelink CSI-RS resource.

In one embodiment, the sidelink reference signal resource includes a Sidelink DMRS resource.

In one embodiment, the sidelink reference signal resource includes at least one of a Sidelink CSI-RS resource or a Sidelink DMRS resource.

In one embodiment, the first type of signaling is used for determining the first reference signal resource.

In one embodiment, the first type of signaling is used for indicating the first reference signal resource.

In one embodiment, the first type of signaling indicates explicitly the first reference signal resource.

In one embodiment, the first type of signaling indicates implicitly the first reference signal resource.

In one embodiment, time-frequency resources occupied by the first type of signaling are used for determining the first reference signal resource.

In one embodiment, the first subband is predefined.

In one embodiment, the first subband is preconfigured.

In one embodiment, the first subband is configurable.

In one embodiment, the first subband includes a positive integer number of subcarriers.

In one embodiment, the first subband includes one carrier.

In one embodiment, the first subband includes one Bandwidth Part (BWP).

In one embodiment, the first subband includes one UpLink (UL) BWP.

In one embodiment, the first subband includes one subband.

In one embodiment, the first subband belongs to an unlicensed spectrum.

In one embodiment, the first sensing indicates that a channel is busy or a channel is idle.

In one embodiment, the first sensing is used for determining whether to perform the radio transmission in the first subband.

In one embodiment, the first sensing is used for determining whether to perform the radio transmission on the first channel.

In one embodiment, the first sensing is used for determining whether the first subband is idle or busy.

In one embodiment, when the first sensing indicates that a channel is busy, the first subband is busy; when the first sensing indicates that a channel is idle, the first subband is idle.

In one embodiment, the first sensing includes an energy detection.

In one embodiment, the first sensing includes sensing energies of radio signals in a first subband and averaging the energies over time to obtain a received energy; when the received energy is less than a first energy threshold, the first sensing indicates that a channel is idle; otherwise, the first sensing indicates that a channel is busy.

In one embodiment, the first sensing includes a power detection.

In one embodiment, the first sensing includes sensing a power of a radio signal in a first subband to obtain a received power; when the received power is less than a first power threshold, the first sensing indicates that a channel is idle; otherwise, the first sensing indicates that a channel is busy.

In one embodiment, the first sensing is Listen Before Talk (LBT).

In one embodiment, the first sensing is Uplink LBT.

In one embodiment, the first sensing includes at least one of Type 1 LBT or Type 2 LBT.

In one embodiment, the first sensing includes at least one of Type 1 LBT, Type 2A LBT or Type 2B LBT.

In one embodiment, the first sensing includes Type 1 LBT and Type 2 LBT.

In one embodiment, the first sensing is Clear Channel Assessment (CCA).

In one embodiment, the first sensing includes a coherent detection of signature sequences.

In one embodiment, the first sensing includes performing a coherent reception in the first subband using a signature sequence, and measuring an energy of a signal obtained after the coherent reception; when the energy of the signal obtained after the coherent reception is less than a second energy threshold, the first sensing indicates that a channel is idle; otherwise, the first sensing indicates that a channel is busy.

In one embodiment, the first sensing includes performing a coherent reception in the first subband using a signature sequence, and measuring an energy of a signal obtained after the coherent reception; when the energy of the signal obtained after the coherent reception is less than a second energy threshold, the first sensing indicates that a channel is busy; otherwise, the first sensing indicates that a channel is idle.

In one embodiment, the first sensing includes a Cyclic Redundancy Check (CRC) detection.

In one embodiment, the first sensing includes receiving a radio signal and performing a decoding operation in the first subband; when the decoding is determined to be correct according to CRC bits, the first sensing indicates that a channel is busy; otherwise, the first sensing indicates that a channel is idle.

In one embodiment, the first sensing includes receiving a radio signal and performing a decoding operation in the first subband; when the decoding is determined to be correct according to CRC bits, the first sensing indicates that a channel is idle; otherwise, the first sensing indicates that a channel is busy.

In one embodiment, the first node is a UE, and the first channel includes an uplink channel.

In one embodiment, the first node is a base station, and the first channel includes a downlink channel.

In one embodiment, the first node is a UE, and the first channel includes a sidelink channel.

In one embodiment, the first channel includes a Physical Uplink Shared Channel (PUSCH).

In one embodiment, the first channel includes a Physical Uplink Control Channel (PUCCH).

In one embodiment, the first channel includes a Physical Sidelink Shared Channel (PSSCH).

In one embodiment, the first channel includes a Physical Sidelink Control Channel (PSCCH).

In one embodiment, the first channel includes a Physical Sidelink Feedback Channel (PSFCH).

In one embodiment, the first channel includes a Physical Downlink Shared Channel (PDSCH).

In one embodiment, the first channel includes a Physical Downlink Control Channel (PDCCH).

In one embodiment, the first channel is reserved for a downlink reference signal resource.

In one embodiment, the first channel is reserved for an uplink reference signal resource.

In one embodiment, the first channel is reserved for a sidelink reference signal resource.

In one embodiment, the phrase of giving up a radio transmission on a first channel includes: keeping a zero transmit power on the first channel.

In one embodiment, the phrase of giving up a radio transmission on a first channel includes: in time domain resources occupied by the first channel, performing a channel sensing in the first subband.

In one embodiment, the phrase of giving up a radio transmission on a first channel includes: in time domain resources occupied by the first channel, performing LBT in the first subband.

In one embodiment, the phrase of giving up a radio transmission on a first channel includes: modulation symbols generated for the radio transmission on the first channel are dropped.

In one embodiment, the phrase of giving up a radio transmission on a first channel includes: modulation symbols generated for the radio transmission on the first channel are delayed to transmit.

In one embodiment, the phrase of giving up a radio transmission on a first channel includes: modulation symbols generated for the radio transmission on the first channel are transmitted in time-frequency resources that are orthogonal to time-frequency resources occupied by the first channel.

In one embodiment, the phrase of starting a first timer includes setting the first timer to 0, and increasing the first timer by 1 every one first-type time interval.

In one subembodiment, the above operation is performed in regardless of whether the first timer is running or not.

In one subembodiment, when the first timer reaches an expiration value of the first timer, the first timer expires.

In one embodiment, the phrase of starting a first timer includes setting the first timer to an expiration value, and decreasing the first timer by 1 every one first-type time interval.

In one subembodiment, the above operation is performed in regardless of whether the first timer is running or not.

In one subembodiment, when the first timer reaches 0, the first timer expires.

In one embodiment, the one first-type time interval is one subframe.

In one embodiment, the one first-type time interval is one slot.

In one embodiment, the one first-type time interval is one Transport Time Interval (TTI).

In one embodiment, in the first subband, when there is no time-frequency resource reserved for uplink transmission in one subframe, the one subframe does not belong to the first-type time interval.

In one embodiment, in the first subband, when the first node is configured to Discontinuous Transmission (DTX) in one subframe, the one subframe does not belong to the first-type time interval.

In one embodiment, the phrase of updating a first counter by 1 includes: the first counter increases by 1; the initial value of the first counter is 0, and the target threshold of the first counter is a positive integer greater than the initial value of the first counter.

In one subembodiment, the target threshold of the first counter is equal to 1.

In one subembodiment, the target threshold of the first counter is a positive integer greater than 1.

In one embodiment, the phrase of updating a first counter by 1 includes: the first counter decreases by 1; the initial value of the first counter is a positive integer, and the target threshold of the first counter is an integer less than the initial value of the first counter.

In one subembodiment, the target threshold of the first counter is a non-negative integer less than the initial value of the first counter.

In one subembodiment, the target threshold of the first counter is equal to 0.

In one subembodiment, the target threshold of the first counter is equal to 1.

In one embodiment, the radio transmission on the first channel is spatially correlated to the first reference signal resource.

In one embodiment, the first sensing is spatially correlated to the first reference signal resource.

In one embodiment, the radio transmission on the first channel is spatially correlated to the first reference signal resource, and the first sensing is spatially correlated to the first reference signal resource.

In one embodiment, at least one of the radio transmission on the first channel and the first sensing is spatially correlated to M1 reference signal resource(s) in the first reference signal resource set, wherein M1 is a positive integer greater than 1.

In one subembodiment, the first reference signal resource is one of the M1 reference signal resources.

In one subembodiment, the first reference signal resource is any one of the M1 reference signal resources.

In one embodiment, the first reference signal resource is any one reference signal resource in the first reference signal resource set.

In one embodiment, when a first counter reaches or exceeds a target threshold, the first receiver autonomously updates a multiantenna related parameter of the first sensing.

In one subembodiment, the multiantenna related parameter of the first sensing before updated is spatially correlated to the first reference signal resource, and the multiantenna related parameter of the first sensing after updated is spatially correlated to one reference signal resource in the first reference signal resource set other than the first reference signal resource.

In one embodiment, an antenna port of the radio transmission on the first channel is QCLed to an antenna port of the first reference signal resource.

In one embodiment, any one antenna port of the radio transmission on the first channel is QCLed to at least one antenna port of the first reference signal resource.

In one embodiment, at least one antenna port of the radio transmission on the first channel is QCLed to at least one antenna port of the first reference signal resource.

In one embodiment, any one antenna port of the first reference signal resource is QCLed to at least one antenna port of the radio transmission on the first channel.

In one embodiment, the radio transmission on the first channel employs a second multiantenna related parameter.

In one embodiment, a second multiantenna related parameter is used for the radio transmission on the first channel.

In one embodiment, a second multiantenna related parameter includes a multiantenna related parameter of the radio transmission on the first channel.

In one embodiment, the second multiantenna related parameter includes an analog beamforming matrix.

In one embodiment, the second multiantenna related parameter includes a digital beamforming matrix.

In one embodiment, the second multiantenna related parameter includes a coefficient of a spatial filter.

In one embodiment, the second multiantenna related parameter includes a Quasi co-location (QCL) parameter.

In one embodiment, the second multiantenna related parameter includes a TCI state.

In one embodiment, the QCL parameter includes a spatial parameter.

In one embodiment, the QCL parameter includes a spatial RX parameter.

In one embodiment, the QCL parameter includes a spatial TX parameter.

In one embodiment, the QCL parameter includes a spatial domain filter.

In one embodiment, the QCL parameter includes a spatial domain transmission filter.

In one embodiment, the QCL parameter includes a beam.

In one embodiment, the QCL parameter includes a beamforming matrix.

In one embodiment, the QCL parameter includes a beamforming vector.

In one embodiment, the QCL parameter includes an analog beamforming matrix.

In one embodiment, the QCL parameter includes an analog beamforming vector.

In one embodiment, the QCL parameter includes an angle of arrival.

In one embodiment, the QCL parameter includes an angle of departure.

In one embodiment, the QCL parameter includes a spatial correlation.

In one embodiment, a type of the QCL parameter includes QCL-TypeD.

In one embodiment, a type of the QCL parameter includes at least one of QCL-TypeA, QCL-TypeB or QCL-TypeC.

In one embodiment, a type of the QCL parameter includes at least one of Doppler shift, Doppler spread, average delay or delay spread.

In one embodiment, the phrase that the radio transmission on the first channel is spatially correlated to a first reference signal resource includes: the first reference signal resource is used for determining the second multiantenna related parameter.

In one embodiment, the phrase that the radio transmission on the first channel is spatially correlated to a first reference signal resource includes: a QCL parameter for receiving the first reference signal resource is used for the radio transmission on the first channel.

In one subembodiment, the first reference signal resource is a downlink reference signal resource.

In one subembodiment, the first reference signal resource is a sidelink reference signal resource.

In one embodiment, the phrase that the radio transmission on the first channel is spatially correlated to a first reference signal resource includes: a QCL parameter for receiving the first reference signal resource is used for determining the second multiantenna related parameter.

In one subembodiment, the first reference signal resource is a downlink reference signal resource.

In one subembodiment, the first reference signal resource is a sidelink reference signal resource.

In one embodiment, the phrase that the radio transmission on the first channel is spatially correlated to a first reference signal resource includes: the second multiantenna related parameter includes a QCL parameter for receiving the first reference signal resource.

In one subembodiment, the first reference signal resource is a downlink reference signal resource.

In one subembodiment, the first reference signal resource is a sidelink reference signal resource.

In one embodiment, the phrase that the radio transmission on the first channel is spatially correlated to a first reference signal resource includes: a QCL parameter for transmitting the first reference signal resource is used for the radio transmission on the first channel.

In one subembodiment, the first reference signal resource is an uplink reference signal resource.

In one subembodiment, the first reference signal resource is a sidelink reference signal resource.

In one embodiment, the phrase that the radio transmission on the first channel is spatially correlated to a first reference signal resource includes: a QCL parameter for transmitting the first reference signal resource is used for determining the second multiantenna related parameter.

In one subembodiment, the first reference signal resource is an uplink reference signal resource.

In one subembodiment, the first reference signal resource is a sidelink reference signal resource.

In one embodiment, the phrase that the radio transmission on the first channel is spatially correlated to a first reference signal resource includes: the second multiantenna related parameter includes a QCL parameter for transmitting the first reference signal resource.

In one subembodiment, the first reference signal resource is an uplink reference signal resource.

In one subembodiment, the first reference signal resource is a sidelink reference signal resource.

In one embodiment, the first sensing employs a first multiantenna related parameter.

In one embodiment, the first sensing employs a first multiantenna related parameter to receive a radio signal.

In one embodiment, a first multiantenna related parameter includes a multiantenna related parameter employed by the first sensing.

In one embodiment, the first multiantenna related parameter includes an analog beamforming matrix.

In one embodiment, the first multiantenna related parameter includes a digital beamforming matrix.

In one embodiment, the first multiantenna related parameter includes a coefficient of a spatial filter.

In one embodiment, the first multiantenna related parameter includes a Quasi co-location (QCL) parameter.

In one embodiment, the first multiantenna related parameter includes a TCI state.

In one embodiment, the phrase that the first sensing is spatially correlated to a first reference signal resource includes: the first reference signal resource is used for determining the first multiantenna related parameter.

In one embodiment, the phrase that the first sensing is spatially correlated to a first reference signal resource includes: a QCL parameter for receiving the first reference signal resource is used for the first sensing.

In one subembodiment, the first reference signal resource is a downlink reference signal resource.

In one subembodiment, the first reference signal resource is a sidelink reference signal resource.

In one embodiment, the phrase that the first sensing is spatially correlated to a first reference signal resource includes: a QCL parameter for receiving the first reference signal resource is used for determining the first multiantenna related parameter.

In one subembodiment, the first reference signal resource is a downlink reference signal resource.

In one subembodiment, the first reference signal resource is a sidelink reference signal resource.

In one embodiment, the phrase that the first sensing is spatially correlated to a first reference signal resource includes: the first multiantenna related parameter includes a QCL parameter for receiving the first reference signal resource.

In one subembodiment, the first reference signal resource is a downlink reference signal resource.

In one subembodiment, the first reference signal resource is a sidelink reference signal resource.

In one embodiment, the phrase that the first sensing is spatially correlated to a first reference signal resource includes: a QCL parameter for transmitting the first reference signal resource is used for the first sensing.

In one subembodiment, the first reference signal resource is an uplink reference signal resource.

In one subembodiment, the first reference signal resource is a sidelink reference signal resource.

In one embodiment, the phrase that the first sensing is spatially correlated to a first reference signal resource includes: a QCL parameter for transmitting the first reference signal resource is used for determining the first multiantenna related parameter.

In one subembodiment, the first reference signal resource is an uplink reference signal resource.

In one subembodiment, the first reference signal resource is a sidelink reference signal resource.

In one embodiment, the phrase that the first sensing is spatially correlated to a first reference signal resource includes: the first multiantenna related parameter includes a QCL parameter for transmitting the first reference signal resource.

In one subembodiment, the first reference signal resource is an uplink reference signal resource.

In one subembodiment, the first reference signal resource is a sidelink reference signal resource.

### Embodiment 2

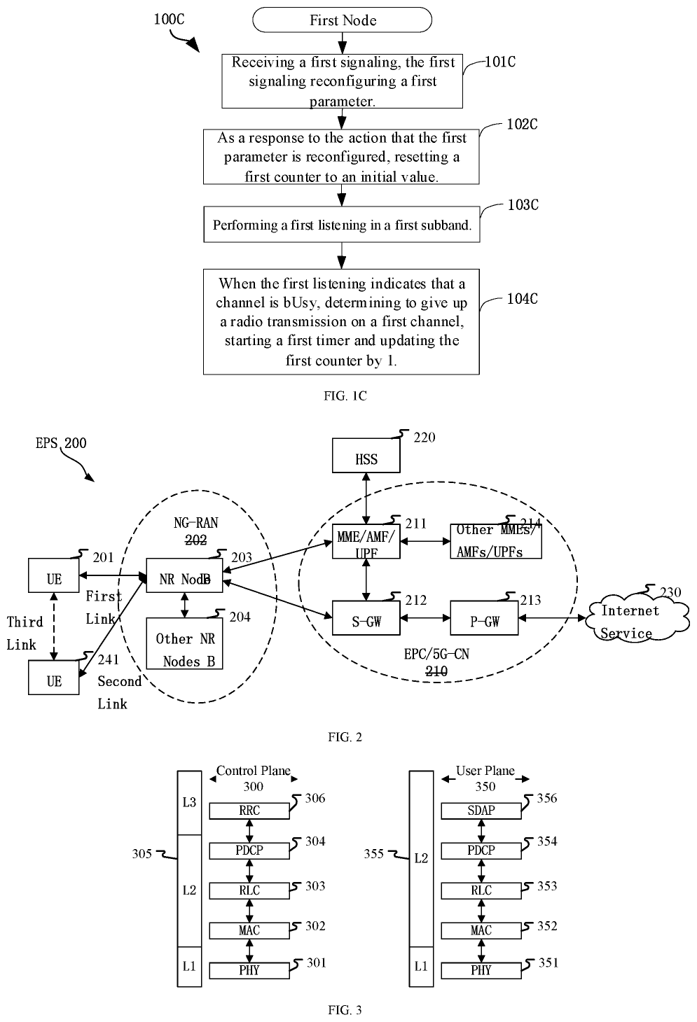

Embodiment 2 illustrates a diagram of a network architecture according to the disclosure, as shown in FIG. 2.

FIG. 2 is a diagram illustrating a network architecture 200 of 5G NR, Long-Term Evolution (LTE) and Long-Term Evolution Advanced (LTE-A) systems. The 5G NR or LTE network architecture 200 may be called an Evolved Packet System (EPS) 200 or some other appropriate terms. The EPS 200 may include one or more UEs 201, a Next Generation-Radio Access Network (NG-RAN) 202, an Evolved Packet Core/5G-Core Network (EPC/5G-CN) 210, a Home Subscriber Server (HSS) 220 and an Internet service 230. The EPS may be interconnected with other access networks. For simple description, the entities/interfaces are not shown. As shown in FIG. 2, the EPS provides packet switching services. Those skilled in the art are easy to understand that various concepts presented throughout the disclosure can be extended to networks providing circuit switching services or other cellular networks. The NG-RAN includes an NR node B (gNB) 203 and other gNBs 204. The gNB 203 provides UE 201 oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Basic Service Set (BSS), an Extended Service Set (ESS), a TRP or some other appropriate terms. The gNB 203 provides an access point of the EPC/5G-CN 210 for the UE 201. Examples of UE 201 include cellular phones, smart phones, Session Initiation Protocol (SIP) phones, laptop computers, Personal Digital Assistants (PDAs), satellite radios, non-terrestrial base statin communications, satellite mobile communications, Global Positioning Systems (GPSs), multimedia devices, video devices, digital audio player (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art may also call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 includes a Mobility Management Entity/Authentication Management Field/User Plane Function (MME/AMF/UPF) 211, other MMEs/AMFs/UPFs 214, a Service Gateway (S-GW) 212 and a Packet Data Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212. The S-GW 212 is connected to the P-GW 213. The P-GW 213 provides UE IP address allocation and other functions. The P-GW 213 is connected to the Internet service 230. The Internet service 230 includes IP services corresponding to operators, specifically including internet, intranet, IP Multimedia Subsystems (IP IMSs) and PS Streaming Services (PSSs).

In one embodiment, the UE 201 corresponds to the first node in the disclosure.

In one embodiment, the gNB 203 corresponds to the first node in the disclosure.

In one embodiment, the UE 241 corresponds to the second node in the disclosure.

In one embodiment, the gNB 203 corresponds to the second node in the disclosure.

### Embodiment 3

Embodiment 3 illustrates a diagram of an embodiment of a radio protocol architecture of a user plane and a control plane according to the disclosure, as shown in FIG. 3. FIG. 3 is a diagram illustrating an embodiment of a radio protocol architecture of a user plane 350 and a control plane 300. In FIG. 3, the radio protocol architecture of a control plane 300 between a first communication node equipment (UE, gNB or RSU in V2X) and a second communication node equipment (gNB, UE or RSU in V2X) or between two UEs is illustrated by three layers, which are a Layer 1, a Layer 2 and a Layer 3 respectively. The Layer 1 (L1 layer) is the lowest layer and implements various PHY (physical layer) signal processing functions. The L1 layer will be referred to herein as the PHY 301. The Layer 2 (L2 layer) 305 is above the PHY 301, and is responsible for the links between the first communication node equipment and the second communication node equipment and between two UEs. The L2 Layer 305 includes a Medium Access Control (MAC) sublayer 302, a Radio Link Control (RLC) sublayer 303, and a Packet Data Convergence Protocol (PDCP) sublayer 304, which are terminated at the second communication node equipment. The PDCP sublayer 304 provides multiplexing between different radio bearers and logical channels. The PDCP sublayer 304 also provides security by encrypting packets and provides support for handover of the first communication node equipment between second communication node equipments. The RLC sublayer 303 provides segmentation and reassembling of higher-layer packets, retransmission of lost packets, and reordering of lost packets to as to compensate for out-of-order reception due to HARQ. The MAC sublayer 302 provides multiplexing between logical channels and transport channels. The MAC sublayer 302 is also responsible for allocating various radio resources (i.e., resource blocks) in one cell among the first communication node equipment. The MAC sublayer 302 is also in charge of HARQ operations. The RRC sublayer 306 in the Layer 3 (L3 layer) in the control plane 300 is responsible for acquiring radio resources (i.e. radio bearers) and configuring lower layers using an RRC signaling between the second communication node equipment and the first communication node equipment. The radio protocol architecture of the user plane 350 includes a Layer 1 (L1 layer) and a Layer 2 (L2 layer); the radio protocol architecture for the first communication node equipment and the second communication node equipment in the user plane 350 on the PHY 351, the PDCP sublayer 354 in the L2 Layer 355, the RLC sublayer 353 in the L2 Layer 355 and the MAC sublayer 352 in the L2 Layer 355 is substantially the same as the radio protocol architecture on corresponding layers and sublayers in the control plane 300, with the exception that the PDCP sublayer 354 also provides header compression for higher-layer packets so as to reduce radio transmission overheads. The L2 Layer 355 in the user plane 350 further includes a Service Data Adaptation Protocol (SDAP) sublayer 356; the SDAP sublayer 356 is in charge of mappings between QoS flows and Data Radio Bearers (DRBs), so as to support diversification of services. Although not shown, the first communication node equipment may include several higher layers above the L2 Layer 355, including a network layer (i.e. IP layer) terminated at the P-GW on the network side and an application layer terminated at the other end (i.e. a peer UE, a server, etc.) of the connection.

In one embodiment, the radio protocol architecture shown in FIG. 3 is applicable to the first node in the disclosure.

In one embodiment, the radio protocol architecture shown in FIG. 3 is applicable to the second node in the disclosure.

In one embodiment, the first signaling in the disclosure is generated on the RRC sublayer 306.

In one embodiment, the first signaling in the disclosure is generated on the MAC sublayer 302.

In one embodiment, the first signaling in the disclosure is generated on the MAC sublayer 352.

In one embodiment, the first type of signaling in the disclosure is generated on the RRC sublayer 306.

In one embodiment, the first type of signaling in the disclosure is generated on the MAC sublayer 302.

In one embodiment, the first type of signaling in the disclosure is generated on the MAC sublayer 352.

In one embodiment, the first type of signaling in the disclosure is generated on the PHY 301.

In one embodiment, the first type of signaling in the disclosure is generated on the PHY 351.

In one embodiment, the first sensing in the disclosure is generated on the PHY 301.

In one embodiment, the first sensing in the disclosure is generated on the PHY 351.

In one embodiment, the first timer in the disclosure is generated on the MAC sublayer 302.

In one embodiment, the first timer in the disclosure is generated on the MAC sublayer 352.

In one embodiment, the first counter in the disclosure is generated on the MAC sublayer 302.

In one embodiment, the first counter in the disclosure is generated on the MAC sublayer 352.

In one embodiment, the sensing failure indication in the disclosure is generated on the MAC sublayer 302.

In one embodiment, the sensing failure indication in the disclosure is generated on the MAC sublayer 352.

In one embodiment, the radio link failure message in the disclosure is generated on the MAC sublayer 302.

In one embodiment, the radio link failure message in the disclosure is generated on the MAC sublayer 352.

In one embodiment, the radio link failure message in the disclosure is generated on the RRC sublayer 306.

In one embodiment, the first signaling in the disclosure is generated on the RRC sublayer 306.

In one embodiment, the first signal in the disclosure is generated on the MAC sublayer 302.

In one embodiment, the first signal in the disclosure is generated on the MAC sublayer 352.

In one embodiment, the first signal in the disclosure is generated on the PHY 301.

In one embodiment, the first signal in the disclosure is generated on the PHY 351.

In one embodiment, the second signaling in the disclosure is generated on the RRC sublayer 306.

In one embodiment, the second signal in the disclosure is generated on the MAC sublayer 302.

In one embodiment, the second signal in the disclosure is generated on the MAC sublayer 352.

In one embodiment, the second signal in the disclosure is generated on the PHY 301.

In one embodiment, the second signal in the disclosure is generated on the PHY 351.

In one embodiment, the first signaling in the disclosure is generated on the RRC sublayer 306.

In one embodiment, the first signaling in the disclosure is generated on the MAC sublayer 302.

In one embodiment, the first signaling in the disclosure is generated on the MAC sublayer 352.

In one embodiment, the first type of signaling in the disclosure is generated on the RRC sublayer 306.

In one embodiment, the first type of signaling in the disclosure is generated on the MAC sublayer 302.

In one embodiment, the first type of signaling in the disclosure is generated on the MAC sublayer 352.

In one embodiment, the first type of signaling in the disclosure is generated on the PHY 301.

In one embodiment, the first type of signaling in the disclosure is generated on the PHY 351.

In one embodiment, the first sensing in the disclosure is generated on the PHY 301.

In one embodiment, the first sensing in the disclosure is generated on the PHY 351.

In one embodiment, the first timer in the disclosure is generated on the MAC sublayer 302.

In one embodiment, the first timer in the disclosure is generated on the MAC sublayer 352.

In one embodiment, the first counter in the disclosure is generated on the MAC sublayer 302.

In one embodiment, the first counter in the disclosure is generated on the MAC sublayer 352.

In one embodiment, the sensing failure indication in the disclosure is generated on the MAC sublayer 302.

In one embodiment, the sensing failure indication in the disclosure is generated on the MAC sublayer 352.

In one embodiment, the radio link failure message in the disclosure is generated on the MAC sublayer 302.

In one embodiment, the radio link failure message in the disclosure is generated on the MAC sublayer 352.

In one embodiment, the radio link failure message in the disclosure is generated on the RRC sublayer 306.

In one embodiment, the first signaling in the disclosure is generated on the RRC sublayer 306.

In one embodiment, the first signal in the disclosure is generated on the MAC sublayer 302.

In one embodiment, the first signal in the disclosure is generated on the MAC sublayer 352.

In one embodiment, the first signal in the disclosure is generated on the PHY 301.

In one embodiment, the first signal in the disclosure is generated on the PHY 351.

In one embodiment, the second signaling in the disclosure is generated on the RRC sublayer 306.

In one embodiment, the second signal in the disclosure is generated on the MAC sublayer 302.

In one embodiment, the second signal in the disclosure is generated on the MAC sublayer 352.

In one embodiment, the second signal in the disclosure is generated on the PHY 301.

In one embodiment, the second signal in the disclosure is generated on the PHY 351.

In one embodiment, the first signaling in the disclosure is generated on the RRC sublayer 306.

In one embodiment, the first signaling in the disclosure is generated on the MAC sublayer 302.

In one embodiment, the first signaling in the disclosure is generated on the MAC sublayer 352.

In one embodiment, the first type of signaling in the disclosure is generated on the RRC sublayer 306.

In one embodiment, the first type of signaling in the disclosure is generated on the MAC sublayer 302.

In one embodiment, the first type of signaling in the disclosure is generated on the MAC sublayer 352.

In one embodiment, the first type of signaling in the disclosure is generated on the PHY 301.

In one embodiment, the first type of signaling in the disclosure is generated on the PHY 351.

In one embodiment, the first sensing in the disclosure is generated on the PHY 301.

In one embodiment, the first sensing in the disclosure is generated on the PHY 351.

In one embodiment, the first timer in the disclosure is generated on the MAC sublayer 302.

In one embodiment, the first timer in the disclosure is generated on the MAC sublayer 352.

In one embodiment, the first counter in the disclosure is generated on the MAC sublayer 302.

In one embodiment, the first counter in the disclosure is generated on the MAC sublayer 352.

In one embodiment, the first signal in the disclosure is generated on the RRC sublayer 306.

In one embodiment, the first signal in the disclosure is generated on the MAC sublayer 306.

In one embodiment, the first signal in the disclosure is generated on the MAC sublayer 352.

In one embodiment, the first signal in the disclosure is generated on the PHY 301.

In one embodiment, the first signal in the disclosure is generated on the PHY 351.

### Embodiment 4

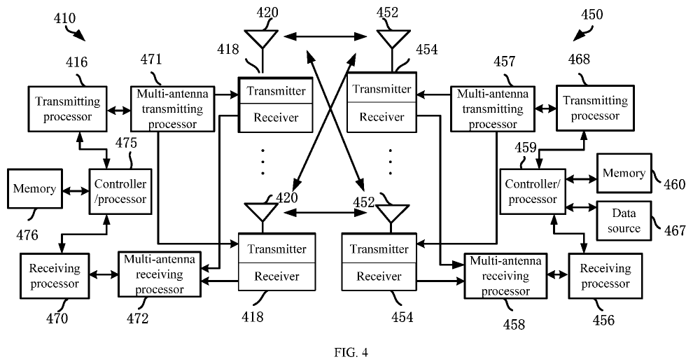

Embodiment 4 illustrates a diagram of a first communication equipment and a second communication equipment according to the disclosure, as shown in FIG. 4. FIG. 4 is a block diagram of a first communication equipment 450 and a second communication equipment 410 that are in communication with each other in an access network.

The first communication equipment 410 includes a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication equipment 450 includes a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication equipment 410 to the second communication equipment 450, at the first communication equipment 410, a higher-layer packet from a core network is provided to the controller/processor 475. The controller/processor 475 provides functions of Layer 2. In the transmission from the first communication equipment 410 to the second communication equipment 450, the controller/processor 475 provides header compression, encryption, packet segmentation and reordering, multiplexing between a logical channel and a transport channel, and a radio resource allocation for the second communication equipment 450 based on various priority metrics. The controller/processor 475 is also in charge of retransmission of lost packets, and signalings to the second communication equipment 450. The transmitting processor 416 and the multi-antenna transmitting processor 471 perform various signal processing functions used for Layer 1 (that is, PHY). The transmitting processor 416 performs encoding and interleaving so as to ensure FEC (Forward Error Correction) at the second communication equipment 450 and mappings to signal clusters corresponding to different modulation schemes (i.e., BPSK, QPSK, M-PSK M-QAM, etc.). The multi-antenna transmitting processor 471 processes the encoded and modulated symbols with digital spatial precoding (including precoding based on codebook and precoding based on non-codebook) and beamforming to generate one or more spatial streams. The transmitting processor 416 subsequently maps each spatial stream into a subcarrier to be multiplexed with a reference signal (i.e., pilot) in time domain and/or frequency domain, and then processes it with Inverse Fast Fourier Transform (IFFT) to generate a physical channel carrying time-domain multicarrier symbol streams. Then, the multi-antenna transmitting processor 471 processes the time-domain multicarrier symbol streams with transmitting analog precoding/beamforming. Each transmitter 418 converts a baseband multicarrier symbol stream provided by the multi-antenna transmitting processor 471 into a radio frequency stream and then provides it to different antennas 420.

In a transmission from the first communication equipment 410 to the second communication equipment 450, at the second communication equipment 450, each receiver 454 receives a signal via the corresponding antenna 452. Each receiver 454 recovers the information modulated to the RF carrier and converts the radio frequency stream into a baseband multicarrier symbol stream to provide to the receiving processor 456. The receiving processor 456 and the multi-antenna receiving processor 458 perform various signal processing functions of Layer 1. The multi-antenna receiving processor 458 processes the baseband multicarrier symbol stream coming from the receiver 454 with receiving analog precoding/beamforming. The receiving processor 456 converts the baseband multicarrier symbol stream subjected to the receiving analog precoding/beamforming operation from time domain into frequency domain using FFT (Fast Fourier Transform). In frequency domain, a physical layer data signal and a reference signal are demultiplexed by the receiving processor 456, wherein the reference signal is used for channel estimation, and the data signal is subjected to multi-antenna detection in the multi-antenna receiving processor 458 to recover any spatial stream targeting the second communication equipment 450. Symbols on each spatial stream are demodulated and recovered in the receiving processor 456 to generate a soft decision. Then, the receiving processor 456 decodes and de-interleaves the soft decision to recover the higher-layer data and control signal on the physical channel transmitted by the first communication equipment 410. Next, the higher-layer data and control signal are provided to the controller/processor 459. The controller/processor 459 performs functions of Layer 2. The controller/processor 459 may be connected to the memory 460 that stores program codes and data. The memory 460 may be called a computer readable media. In the transmission from the first communication equipment 410 to the second communication equipment 450, the controller/processor 459 provides multiplexing between the transport channel and the logical channel, packet reassembling, decryption, header decompression, and control signal processing so as to recover the higher-layer packet coming from the core network. The higher-layer packet is then provided to all protocol layers above Layer 2, or various control signals can be provided to Layer 3 for processing.

In a transmission from the second communication equipment 450 to the first communication equipment 410, at the second communication equipment 450, the data source 467 provides a higher-layer packet to the controller/processor 459. The data source 467 illustrates all protocol layers above the L2 layer. Similar as the transmitting function of the first communication equipment 410 described in the transmission from the first communication equipment 410 to the second communication equipment 450, the controller/processor 459 provides header compression, encryption, packet segmentation and reordering, and multiplexing between a logical channel and a transport channel based on radio resource allocation so as to provide the functions of L2 layer used for the control plane and user plane. The controller/processor 459 is also in charge of retransmission of lost packets, and signalings to the first communication equipment 410. The transmitting processor 468 conducts modulation mapping and channel encoding processing; the multi-antenna transmitting processor 457 performs digital multi-antenna spatial precoding (including precoding based on codebook and precoding based on non-codebook) and beaming processing; and subsequently, the transmitting processor 468 modulates the generated spatial streams into a multicarrier/single-carrier symbol stream, which is subjected to an analog precoding/beamforming operation in the multi-antenna transmitting processor 457 and then is provided to different antennas 452 via the transmitter 454. Each transmitter 452 first converts the baseband symbol stream provided by the multi-antenna transmitting processor 457 into a radio frequency symbol stream and then provides the radio frequency symbol stream to the antenna 452.

In a transmission from the second communication equipment 450 to the first communication equipment 410, the function of the first communication equipment 410 is similar as the receiving function of the second communication equipment 450 described in the transmission from second communication equipment 410 to the second communication equipment 450. Each receiver 418 receives a radio frequency signal via the corresponding antenna 420, converts the received radio frequency signal into a baseband signal, and provides the baseband signal to the multi-antenna receiving processor 472 and the receiving processor 470. The receiving processor 470 and the multi-antenna receiving processor 472 together provide functions of Layer 1. The controller/processor 475 provides functions of Layer 2. The controller/processor 475 may be connected to the memory 476 that stores program codes and data. The memory 476 may be called a computer readable media. In the transmission from the second communication equipment 450 to the first communication equipment 410, the controller/processor 475 provides de-multiplexing between the transport channel and the logical channel, packet reassembling, decryption, header decompression, and control signal processing so as to recover higher-layer packets coming from the UE 450. The higher-layer packet, coming from the controller/processor 475, may be provided to the core network.

In one embodiment, the first node in the disclosure includes the second communication equipment 450.

In one embodiment, the first node in the disclosure includes the first communication equipment 410.

In one embodiment, the second node in the disclosure includes the first communication equipment 410.

In one embodiment, the second node in the disclosure includes the second communication equipment 450.

In one embodiment, the first node in the disclosure is a UE, and the second node is a base station.

In one embodiment, the first node in the disclosure is a UE, and the second node in the disclosure is a UE.

In one embodiment, the first node in the disclosure is a UE, and the second node is a relay node.

In one embodiment, the first node in the disclosure is a relay node, and the second node is a UE.

In one embodiment, the first node in the disclosure is a relay node, and the second node is a base station.

In one embodiment, the first node in the disclosure is a base station, and the second node is a base station.

In one embodiment, the first node in the disclosure is a base station, and the second node is a UE.

In one embodiment, the first node in the disclosure is a base station, and the second node is a relay equipment.

In one embodiment, the second communication equipment 450 includes at least one controller/processor; and the at least one controller/processor is in charge of HARQ operations.

In one embodiment, the first communication equipment 410 includes at least one controller/processor; and the at least one controller/processor is in charge of HARQ operations.

In one embodiment, the first communication equipment 410 includes at least one controller/processor; and the at least one controller/processor is in charge of performing an error detection using ACK and/or NACK protocols to support HARQ operations.

In one embodiment, the second communication equipment 450 includes at least one processor and at least one memory. The at least one memory includes computer program codes. The at least one memory and the computer program codes are configured to be used in collaboration with the at least one processor. The second communication equipment 450 at least performs a first sensing in a first subband; when the first sensing indicates that a channel is busy, determines to give up a radio transmission on a first channel, starts a first timer and updates a first counter by 1; when any one of Q timers expires, resets the first counter to an initial value; and when the first counter reaches or exceeds a target threshold, transmits a first signal. Herein, the first channel belongs to the first subband in frequency domain, the first sensing is correlated to a first index, and the first index is any one of Q indexes; the Q indexes are one-to-one corresponding to the Q timers respectively, and the first timer is one of the Q timers that is corresponding to the first index; and Q is a positive integer greater than 1.

In one subembodiment, the second communication equipment 450 corresponds to the first node in the disclosure.

In one embodiment, the second communication equipment 450 includes a memory that stores a computer readable instruction program. The computer readable instruction program generates an action when executed by at least one processor. The action includes performing a first sensing in a first subband; when the first sensing indicates that a channel is busy, determining to give up a radio transmission on a first channel, starting a first timer and updating a first counter by 1; when any one of Q timers expires, resetting the first counter to an initial value; and when the first counter reaches or exceeds a target threshold, transmitting a first signal. Herein, the first channel belongs to the first subband in frequency domain, the first sensing is correlated to a first index, and the first index is any one of Q indexes; the Q indexes are one-to-one corresponding to the Q timers respectively, and the first timer is one of the Q timers that is corresponding to the first index; and Q is a positive integer greater than 1.

In one subembodiment, the second communication equipment 450 corresponds to the first node in the disclosure.

In one embodiment, the first communication equipment 410 includes at least one processor and at least one memory. The at least one memory includes computer program codes. The at least one memory and the computer program codes are configured to be used in collaboration with the at least one processor. The first communication equipment 410 at least receives a first signal. Herein, a transmitter of the first signal maintains a first counter, and the first counter reaches or exceeds a target threshold; the transmitter of the first signal performs a first sensing in a first subband; when the first sensing indicates that a channel is busy, the transmitter of the first signal determines to give up a radio transmission on a first channel, starts a first timer and updates the first counter by 1; the first channel belongs to the first subband in frequency domain, the first sensing is correlated to a first index, and the first index is any one of Q indexes; the Q indexes are one-to-one corresponding to Q timers respectively, and the first timer is one of the Q timers that is corresponding to the first index; and Q is a positive integer greater than 1.

In one subembodiment, the first communication equipment 410 corresponds to the second node in the disclosure.

In one embodiment, the first communication equipment 410 includes a memory that stores a computer readable instruction program. The computer readable instruction program generates an action when executed by at least one processor. The action includes receiving a first signal. Herein, a transmitter of the first signal maintains a first counter, and the first counter reaches or exceeds a target threshold; the transmitter of the first signal performs a first sensing in a first subband; when the first sensing indicates that a channel is busy, the transmitter of the first signal determines to give up a radio transmission on a first channel, starts a first timer and updates the first counter by 1; the first channel belongs to the first subband in frequency domain, the first sensing is correlated to a first index, and the first index is any one of Q indexes; the Q indexes are one-to-one corresponding to Q timers respectively, and the first timer is one of the Q timers that is corresponding to the first index; and Q is a positive integer greater than 1.

In one subembodiment, the first communication equipment 410 corresponds to the second node in the disclosure.

In one embodiment, at least one of the antenna 452, the receiver 454, the multiantenna receiving processor 458, the receiving processor 456, the controller/processor 459, the memory 460 or the data source 467 is used for receiving the first signaling in the disclosure.

In one embodiment, at least one of the antenna 420, the transmitter 418, the multiantenna transmitting processor 471, the transmitting processor 416, the controller/processor 475 or the memory 476 is used for transmitting the first signaling in the disclosure.

In one embodiment, at least one of the antenna 452, the transmitter 454, the multiantenna transmitting processor 458, the transmitting processor 468, the controller/processor 459, the memory 460 or the data source 467 is used for transmitting the first signaling in the disclosure.

In one embodiment, at least one of the antenna 420, the receiver 418, the multiantenna receiving processor 472, the receiving processor 470, the controller/processor 475, or the memory 476 is used for receiving the first signaling in the disclosure.

In one embodiment, at least one of the antenna 452, the receiver 454, the multiantenna receiving processor 458, the receiving processor 456, the controller/processor 459, the memory 460 or the data source 467 is used for monitoring the first type of signaling in the disclosure in the first subband in the disclosure.

In one embodiment, at least one of the antenna 420, the transmitter 418, the multiantenna transmitting processor 471, the transmitting processor 416, the controller/processor 475 or the memory 476 is used for transmitting the first type of signaling in the disclosure in the first subband in the disclosure.

In one embodiment, at least one of the antenna 420, the receiver 418, the multiantenna receiving processor 472, the receiving processor 470, the controller/processor 475, or the memory 476 is used for monitoring the first type of signaling in the disclosure in the first subband in the disclosure.

In one embodiment, at least one of the antenna 452, the transmitter 454, the multiantenna transmitting processor 458, the transmitting processor 468, the controller/processor 459, the memory 460 or the data source 467 is used for transmitting the first type of signaling in the disclosure in the first subband in the disclosure.

In one embodiment, at least one of the antenna 452, the receiver 454, the multiantenna receiving processor 458, the receiving processor 456, the controller/processor 459, the memory 460 or the data source 467 is used for performing the first sensing in the disclosure in the first subband in the disclosure.

In one embodiment, at least one of the antenna 420, the receiver 418, the multiantenna receiving processor 472, the receiving processor 470, the controller/processor 475, or the memory 476 is used for performing the first sensing in the disclosure in the first subband in the disclosure.

In one embodiment, at least one of the antenna 452, the transmitter 454, the multiantenna transmitting processor 458, the transmitting processor 468, the controller/processor 459, the memory 460 or the data source 467 is used for triggering the sensing failure indication of the first subband in the disclosure.

In one embodiment, at least one of the antenna 420, the transmitter 418, the multiantenna transmitting processor 471, the transmitting processor 416, the controller/processor 475 or the memory 476 is used for triggering the sensing failure indication of the first subband in the disclosure.

In one embodiment, at least one of the antenna 452, the transmitter 454, the multiantenna transmitting processor 458, the transmitting processor 468, the controller/processor 459, the memory 460 or the data source 467 is used for transmitting the radio link failure message in the disclosure.

In one embodiment, at least one of the antenna 420, the receiver 418, the multiantenna receiving processor 472, the receiving processor 470, the controller/processor 475, or the memory 476 is used for receiving the radio link failure message in the disclosure.

In one embodiment, at least one of the antenna 452, the receiver 454, the multiantenna receiving processor 458, the receiving processor 456, the controller/processor 459, the memory 460 or the data source 467 is used for receiving the radio link failure message in the disclosure.

In one embodiment, at least one of the antenna 420, the transmitter 418, the multiantenna transmitting processor 471, the transmitting processor 416, the controller/processor 475 or the memory 476 is used for transmitting the radio link failure message in the disclosure.

In one embodiment, at least one of the antenna 452, the transmitter 454, the multiantenna transmitting processor 458, the transmitting processor 468, the controller/processor 459, the memory 460 or the data source 467 is used for transmitting the first signal in the disclosure.

In one embodiment, at least one of the antenna 420, the receiver 418, the multiantenna receiving processor 472, the receiving processor 470, the controller/processor 475, or the memory 476 is used for receiving the first signal in the disclosure.

In one embodiment, at least one of the antenna 452, the receiver 454, the multiantenna receiving processor 458, the receiving processor 456, the controller/processor 459, the memory 460 or the data source 467 is used for receiving the first signal in the disclosure.

In one embodiment, at least one of the antenna 420, the transmitter 418, the multiantenna transmitting processor 471, the transmitting processor 416, the controller/processor 475 or the memory 476 is used for transmitting the first signal in the disclosure.

In one embodiment, at least one of the antenna 452, the transmitter 454, the multiantenna transmitting processor 458, the transmitting processor 468, the controller/processor 459, the memory 460 or the data source 467 is used for transmitting the second signal in the disclosure.

In one embodiment, at least one of the antenna 420, the receiver 418, the multiantenna receiving processor 472, the receiving processor 470, the controller/processor 475, or the memory 476 is used for receiving the second signal in the disclosure.

In one embodiment, at least one of the antenna 452, the receiver 454, the multiantenna receiving processor 458, the receiving processor 456, the controller/processor 459, the memory 460 or the data source 467 is used for receiving the second signal in the disclosure.

In one embodiment, at least one of the antenna 420, the transmitter 418, the multiantenna transmitting processor 471, the transmitting processor 416, the controller/processor 475 or the memory 476 is used for transmitting the second signal in the disclosure.

In one embodiment, the second communication equipment 450 includes at least one processor and at least one memory. The at least one memory includes computer program codes. The at least one memory and the computer program codes are configured to be used in collaboration with the at least one processor. The second communication equipment 450 at least performs a first sensing in a first subband; when the first sensing indicates that a channel is busy, determines to give up a radio transmission on a first channel, starts a first timer and updates a first counter by 1; when the first timer expires, resets the first counter to an initial value; and when any one of Q counters reaches or exceeds a target threshold, transmits a first signal. Herein, the first channel belongs to the first subband in frequency domain, the first sensing is correlated to a first index, and the first index is any one of Q indexes; the Q indexes are one-to-one corresponding to the Q counters respectively, and the first counter is one of the Q counters that is corresponding to the first index; and Q is a positive integer greater than 1.

In one subembodiment, the second communication equipment 450 corresponds to the first node in the disclosure.

In one embodiment, the second communication equipment 450 includes a memory that stores a computer readable instruction program. The computer readable instruction program generates an action when executed by at least one processor. The action includes performing a first sensing in a first subband; when the first sensing indicates that a channel is busy, determining to give up a radio transmission on a first channel, starting a first timer and updating a first counter by 1; when the first timer expires, resetting the first counter to an initial value; and when any one of Q counters reaches or exceeds a target threshold, transmitting a first signal. Herein, the first channel belongs to the first subband in frequency domain, the first sensing is correlated to a first index, and the first index is any one of Q indexes; the Q indexes are one-to-one corresponding to the Q counters respectively, and the first counter is one of the Q counters that is corresponding to the first index; and Q is a positive integer greater than 1.

In one subembodiment, the second communication equipment 450 corresponds to the first node in the disclosure.

In one embodiment, the first communication equipment 410 includes at least one processor and at least one memory. The at least one memory includes computer program codes. The at least one memory and the computer program codes are configured to be used in collaboration with the at least one processor. The first communication equipment 410 at least receives a first signal. Herein, a transmitter of the first signal maintains Q counters, and any one of the Q counters reaches or exceeds a target threshold; the transmitter of the first signal performs a first sensing in a first subband; when the first sensing indicates that a channel is busy, the transmitter of the first signal determines to give up a radio transmission on a first channel, starts a first timer and updates a first counter by 1; the first channel belongs to the first subband in frequency domain, the first sensing is correlated to a first index, and the first index is any one of Q indexes; the Q indexes are one-to-one corresponding to Q counters respectively, and the first counter is one of the Q counters that is corresponding to the first index; and Q is a positive integer greater than 1.

In one subembodiment, the first communication equipment 410 corresponds to the second node in the disclosure.

In one embodiment, the first communication equipment 410 includes a memory that stores a computer readable instruction program. The computer readable instruction program generates an action when executed by at least one processor. The action includes receiving a first signal. Herein, a transmitter of the first signal maintains Q counters, and any one of the Q counters reaches or exceeds a target threshold; the transmitter of the first signal performs a first sensing in a first subband; when the first sensing indicates that a channel is busy, the transmitter of the first signal determines to give up a radio transmission on a first channel, starts a first timer and updates a first counter by 1; the first channel belongs to the first subband in frequency domain, the first sensing is correlated to a first index, and the first index is any one of Q indexes; the Q indexes are one-to-one corresponding to Q counters respectively, and the first counter is one of the Q counters that is corresponding to the first index; and Q is a positive integer greater than 1.

In one subembodiment, the first communication equipment 410 corresponds to the second node in the disclosure.

In one embodiment, at least one of the antenna 452, the receiver 454, the multiantenna receiving processor 458, the receiving processor 456, the controller/processor 459, the memory 460 or the data source 467 is used for receiving the first signaling in the disclosure.

In one embodiment, at least one of the antenna 420, the transmitter 418, the multiantenna transmitting processor 471, the transmitting processor 416, the controller/processor 475 or the memory 476 is used for transmitting the first signaling in the disclosure.

In one embodiment, at least one of the antenna 452, the transmitter 454, the multiantenna transmitting processor 458, the transmitting processor 468, the controller/processor 459, the memory 460 or the data source 467 is used for transmitting the first signaling in the disclosure.

In one embodiment, at least one of the antenna 420, the receiver 418, the multiantenna receiving processor 472, the receiving processor 470, the controller/processor 475, or the memory 476 is used for receiving the first signaling in the disclosure.

In one embodiment, at least one of the antenna 452, the receiver 454, the multiantenna receiving processor 458, the receiving processor 456, the controller/processor 459, the memory 460 or the data source 467 is used for monitoring the first type of signaling in the disclosure in the first subband in the disclosure.

In one embodiment, at least one of the antenna 420, the transmitter 418, the multiantenna transmitting processor 471, the transmitting processor 416, the controller/processor 475 or the memory 476 is used for transmitting the first type of signaling in the disclosure in the first subband in the disclosure.

In one embodiment, at least one of the antenna 420, the receiver 418, the multiantenna receiving processor 472, the receiving processor 470, the controller/processor 475, or the memory 476 is used for monitoring the first type of signaling in the disclosure in the first subband in the disclosure.

In one embodiment, at least one of the antenna 452, the transmitter 454, the multiantenna transmitting processor 458, the transmitting processor 468, the controller/processor 459, the memory 460 or the data source 467 is used for transmitting the first type of signaling in the disclosure in the first subband in the disclosure.

In one embodiment, at least one of the antenna 452, the receiver 454, the multiantenna receiving processor 458, the receiving processor 456, the controller/processor 459, the memory 460 or the data source 467 is used for performing the first sensing in the disclosure in the first subband in the disclosure.

In one embodiment, at least one of the antenna 420, the receiver 418, the multiantenna receiving processor 472, the receiving processor 470, the controller/processor 475, or the memory 476 is used for performing the first sensing in the disclosure in the first subband in the disclosure.

In one embodiment, at least one of the antenna 452, the transmitter 454, the multiantenna transmitting processor 458, the transmitting processor 468, the controller/processor 459, the memory 460 or the data source 467 is used for triggering the sensing failure indication of the first subband in the disclosure.

In one embodiment, at least one of the antenna 420, the transmitter 418, the multiantenna transmitting processor 471, the transmitting processor 416, the controller/processor 475 or the memory 476 is used for triggering the sensing failure indication of the first subband in the disclosure.

In one embodiment, at least one of the antenna 452, the transmitter 454, the multiantenna transmitting processor 458, the transmitting processor 468, the controller/processor 459, the memory 460 or the data source 467 is used for transmitting the radio link failure message in the disclosure.

In one embodiment, at least one of the antenna 420, the receiver 418, the multiantenna receiving processor 472, the receiving processor 470, the controller/processor 475, or the memory 476 is used for receiving the radio link failure message in the disclosure.

In one embodiment, at least one of the antenna 452, the receiver 454, the multiantenna receiving processor 458, the receiving processor 456, the controller/processor 459, the memory 460 or the data source 467 is used for receiving the radio link failure message in the disclosure.

In one embodiment, at least one of the antenna 420, the transmitter 418, the multiantenna transmitting processor 471, the transmitting processor 416, the controller/processor 475 or the memory 476 is used for transmitting the radio link failure message in the disclosure.

In one embodiment, at least one of the antenna 452, the transmitter 454, the multiantenna transmitting processor 458, the transmitting processor 468, the controller/processor 459, the memory 460 or the data source 467 is used for transmitting the first signal in the disclosure.

In one embodiment, at least one of the antenna 420, the receiver 418, the multiantenna receiving processor 472, the receiving processor 470, the controller/processor 475, or the memory 476 is used for receiving the first signal in the disclosure.

In one embodiment, at least one of the antenna 452, the receiver 454, the multiantenna receiving processor 458, the receiving processor 456, the controller/processor 459, the memory 460 or the data source 467 is used for receiving the first signal in the disclosure.

In one embodiment, at least one of the antenna 420, the transmitter 418, the multiantenna transmitting processor 471, the transmitting processor 416, the controller/processor 475 or the memory 476 is used for transmitting the first signal in the disclosure.

In one embodiment, at least one of the antenna 452, the transmitter 454, the multiantenna transmitting processor 458, the transmitting processor 468, the controller/processor 459, the memory 460 or the data source 467 is used for transmitting the second signal in the disclosure.

In one embodiment, at least one of the antenna 420, the receiver 418, the multiantenna receiving processor 472, the receiving processor 470, the controller/processor 475, or the memory 476 is used for receiving the second signal in the disclosure.

In one embodiment, at least one of the antenna 452, the receiver 454, the multiantenna receiving processor 458, the receiving processor 456, the controller/processor 459, the memory 460 or the data source 467 is used for receiving the second signal in the disclosure.

In one embodiment, at least one of the antenna 420, the transmitter 418, the multiantenna transmitting processor 471, the transmitting processor 416, the controller/processor 475 or the memory 476 is used for transmitting the second signal in the disclosure.

In one embodiment, the second communication equipment 450 includes at least one processor and at least one memory. The at least one memory includes computer program codes. The at least one memory and the computer program codes are configured to be used in collaboration with the at least one processor. The second communication equipment 450 at least receives a first signaling, the first signaling reconfiguring a first parameter; as a response to the action that the first parameter is reconfigured, resets a first counter to an initial value; performs a first sensing in a first subband; and, when the first sensing indicates that a channel is busy, determines to give up a radio transmission on a first channel, starts a first timer and updates the first counter by 1. Herein, the first channel belongs to the first subband in frequency domain, and the first parameter is used for determining a first reference signal resource set; at least one of the radio transmission on the first channel and the first sensing is spatially correlated to a first reference signal resource, the first reference signal resource is one reference signal resource in the first reference signal resource set, and the first reference signal resource set includes at least one reference signal resource.

In one subembodiment, the second communication equipment 450 corresponds to the first node in the disclosure.

In one embodiment, the second communication equipment 450 includes a memory that stores a computer readable instruction program. The computer readable instruction program generates an action when executed by at least one processor. The action includes receiving a first signaling, the first signaling reconfiguring a first parameter; as a response to the action that the first parameter is reconfigured, resetting a first counter to an initial value; performing a first sensing in a first subband; and, when the first sensing indicates that a channel is busy, determining to give up a radio transmission on a first channel, starting a first timer and updating the first counter by 1. Herein, the first channel belongs to the first subband in frequency domain, and the first parameter is used for determining a first reference signal resource set; at least one of the radio transmission on the first channel and the first sensing is spatially correlated to a first reference signal resource, the first reference signal resource is one reference signal resource in the first reference signal resource set, and the first reference signal resource set includes at least one reference signal resource.

In one subembodiment, the second communication equipment 450 corresponds to the first node in the disclosure.

In one embodiment, the first communication equipment 410 includes at least one processor and at least one memory. The at least one memory includes computer program codes. The at least one memory and the computer program codes are configured to be used in collaboration with the at least one processor. The first communication equipment 410 at least transmits a first signaling, the first signaling reconfiguring a first parameter. Herein, as a response to the action that the first parameter is reconfigured, a target receiver of the first signaling resets a first counter to an initial value; the target receiver of the first signaling performs a first sensing in a first subband; when the first sensing indicates that a channel is busy, the target receiver of the first signaling determines to give up a radio transmission on a first channel, starts a first timer and updates the first counter by 1; the first channel belongs to the first subband in frequency domain, and the first parameter is used for determining a first reference signal resource set; at least one of the radio transmission on the first channel and the first sensing is spatially correlated to a first reference signal resource, the first reference signal resource is one reference signal resource in the first reference signal resource set, and the first reference signal resource set includes at least one reference signal resource.

In one subembodiment, the first communication equipment 410 corresponds to the second node in the disclosure.

In one embodiment, the first communication equipment 410 includes a memory that stores a computer readable instruction program. The computer readable instruction program generates an action when executed by at least one processor. The action includes transmitting a first signaling, the first signaling reconfiguring a first parameter. Herein, as a response to the action that the first parameter is reconfigured, a target receiver of the first signaling resets a first counter to an initial value; the target receiver of the first signaling performs a first sensing in a first subband; when the first sensing indicates that a channel is busy, the target receiver of the first signaling determines to give up a radio transmission on a first channel, starts a first timer and updates the first counter by 1; the first channel belongs to the first subband in frequency domain, and the first parameter is used for determining a first reference signal resource set; at least one of the radio transmission on the first channel and the first sensing is spatially correlated to a first reference signal resource, the first reference signal resource is one reference signal resource in the first reference signal resource set, and the first reference signal resource set includes at least one reference signal resource.

In one subembodiment, the first communication equipment 410 corresponds to the second node in the disclosure.

In one embodiment, at least one of the antenna 452, the receiver 454, the multiantenna receiving processor 458, the receiving processor 456, the controller/processor 459, the memory 460 or the data source 467 is used for receiving the first signaling in the disclosure.

In one embodiment, at least one of the antenna 420, the transmitter 418, the multiantenna transmitting processor 471, the transmitting processor 416, the controller/processor 475 or the memory 476 is used for transmitting the first signaling in the disclosure.

In one embodiment, at least one of the antenna 452, the transmitter 454, the multiantenna transmitting processor 458, the transmitting processor 468, the controller/processor 459, the memory 460 or the data source 467 is used for transmitting the first signaling in the disclosure.

In one embodiment, at least one of the antenna 420, the receiver 418, the multiantenna receiving processor 472, the receiving processor 470, the controller/processor 475, or the memory 476 is used for receiving the first signaling in the disclosure.

In one embodiment, at least one of the antenna 452, the receiver 454, the multiantenna receiving processor 458, the receiving processor 456, the controller/processor 459, the memory 460 or the data source 467 is used for monitoring the first type of signaling in the disclosure in the first subband in the disclosure.

In one embodiment, at least one of the antenna 420, the transmitter 418, the multiantenna transmitting processor 471, the transmitting processor 416, the controller/processor 475 or the memory 476 is used for transmitting the first type of signaling in the disclosure in the first subband in the disclosure.

In one embodiment, at least one of the antenna 420, the receiver 418, the multiantenna receiving processor 472, the receiving processor 470, the controller/processor 475, or the memory 476 is used for monitoring the first type of signaling in the disclosure in the first subband in the disclosure.

In one embodiment, at least one of the antenna 452, the transmitter 454, the multiantenna transmitting processor 458, the transmitting processor 468, the controller/processor 459, the memory 460 or the data source 467 is used for transmitting the first type of signaling in the disclosure in the first subband in the disclosure.

In one embodiment, at least one of the antenna 452, the receiver 454, the multiantenna receiving processor 458, the receiving processor 456, the controller/processor 459, the memory 460 or the data source 467 is used for performing the first sensing in the disclosure in the first subband in the disclosure.

In one embodiment, at least one of the antenna 420, the receiver 418, the multiantenna receiving processor 472, the receiving processor 470, the controller/processor 475, or the memory 476 is used for performing the first sensing in the disclosure in the first subband in the disclosure.

In one embodiment, at least one of the antenna 452, the transmitter 454, the multiantenna transmitting processor 458, the transmitting processor 468, the controller/processor 459, the memory 460 or the data source 467 is used for transmitting the first signal in the disclosure.

In one embodiment, at least one of the antenna 420, the receiver 418, the multiantenna receiving processor 472, the receiving processor 470, the controller/processor 475, or the memory 476 is used for receiving the first signal in the disclosure.

In one embodiment, at least one of the antenna 452, the receiver 454, the multiantenna receiving processor 458, the receiving processor 456, the controller/processor 459, the memory 460 or the data source 467 is used for receiving the first signal in the disclosure.

In one embodiment, at least one of the antenna 420, the transmitter 418, the multiantenna transmitting processor 471, the transmitting processor 416, the controller/processor 475 or the memory 476 is used for transmitting the first signal in the disclosure.

### Embodiment 5A

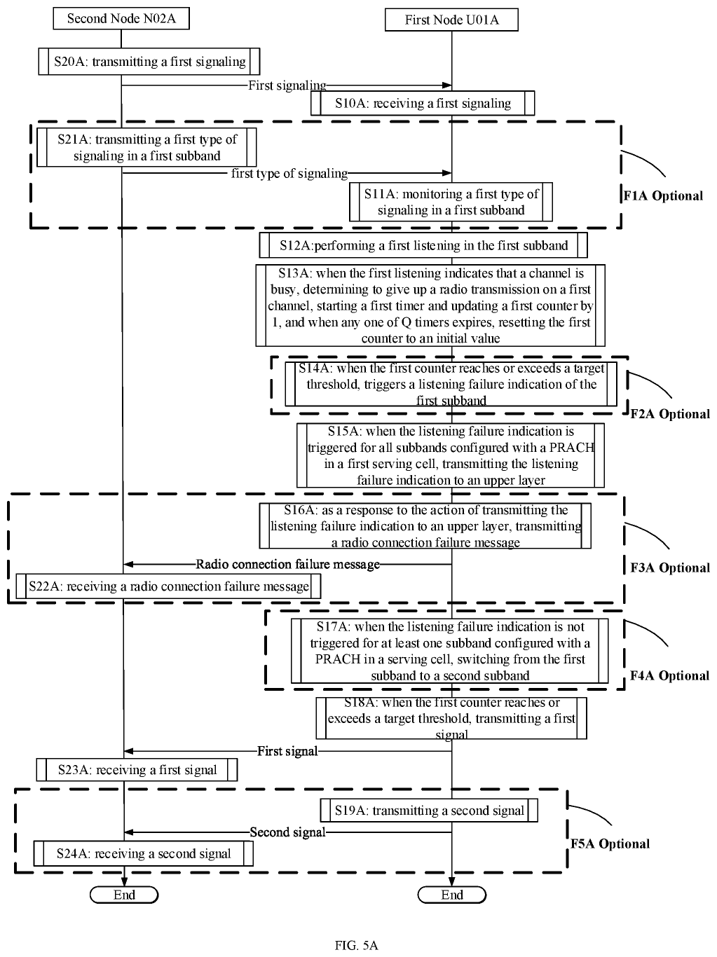

Embodiment 5A illustrates a flowchart of transmission of a radio signal according to one embodiment of the disclosure, as shown in FIG. 5A. In FIG. 5A, a first node U01A and a second node N02A perform communication through an air interface. In FIG. 5A, dash line boxes F1A, F2A, F3A, F4A and F5A are optional. In FIG. 5A, each box represents one step, in particular, the order of each box in the figure does not represent the precedence relationship in time between the represented steps.

The first node U01A, in S10A, receives a first signaling; in S11A, monitors a first type of signaling in a first subband; in S12A, performs a first sensing in the first subband; in S13A, when the first sensing indicates that a channel is busy, determines to give up a radio transmission on a first channel, starts a first timer and updates a first counter by 1, and when any one of Q timers expires, resets the first counter to an initial value; in S14A, when the first counter reaches or exceeds a target threshold, triggers a sensing failure indication of the first subband; in S15A, when the sensing failure indication has been triggered for each subband configured with a PRACH in a first serving cell, transmits the sensing failure indication to an upper layer; in S16A, as a response to the action of transmitting the sensing failure indication to an upper layer, transmits a radio link failure message; in S17A, when the sensing failure indication has not been triggered for at least one subband configured with a PRACH in a first serving cell, switches from the first subband to a second subband; in S18A, when the first counter reaches or exceeds a target threshold, transmits a first signal; and in S19A, transmits a second signal.

The second node N02A, in S20A, transmits a first signaling; in S21A, transmits a first type of signaling in a first subband; in S22A, receives a radio link failure message; in S23A, receives a first signal; and in S24A, receives a second signal.

In Embodiment 5A, the first channel belongs to the first subband in frequency domain, the first sensing is correlated to a first index, and the first index is any one of Q indexes; the Q indexes are one-to-one corresponding to the Q timers respectively, and the first timer is one of the Q timers that is corresponding to the first index; and Q is a positive integer greater than 1. The first type of signaling is used by the first node U01 to determine the first index; the first sensing is performed each time the first type of signaling is detected. As a response to the action that the sensing failure indication of the first subband is triggered, the first signal is generated. The second subband is one subband in the first serving cell that is configured with a PRACH and has not been triggered the sensing failure indication. The first signaling indicates at least one of expiration values of the Q timers or a target threshold of the first counter. The second signal indicates a second index, and the second index is one of the Q indexes.

In one embodiment, the first type of signaling is used by the second node N02A to determine the first index.

In one embodiment, when the dash line box F2A does not exist, both the dash line boxes F3A and F4A do not exist.

In one embodiment, the first subband belongs to one serving cell.

In one embodiment, the Q counters are all specific to the first subband.

In one embodiment, the Q indexes correspond to Q Control resource sets (CORESET) sets respectively.

In one embodiment, the Q indexes correspond to Q search space sets respectively.

In one embodiment, the Q indexes correspond to Q CORESET pools respectively.

In one embodiment, the Q indexes correspond to Q CORESETPoolIndexes respectively.

In one embodiment, any one of the Q indexes is a CORESETPoolIndex.

In one embodiment, the Q indexes correspond to Q antenna panels respectively.

In one embodiment, the Q indexes correspond to Q TRPs respectively.

In one embodiment, when the first sensing indicates that a channel is busy, only the first timer among the Q timers is set to an expiration value.

In one embodiment, when the first sensing indicates that a channel is busy, only the first timer among the Q timers is set to 0.

In one embodiment, the Q timers and the first counter are maintained by a transmitter of the first signal.

In one embodiment, the method in the first node includes:

when the first sensing indicates that a channel is idle, performing the radio transmission on the first channel.

In one embodiment, the method in the first node includes:

when the first sensing indicates that a channel is idle, transmitting a signaling to indicate that the radio transmission on the first channel is performed.

In one embodiment, the method in the first node includes:

when the first sensing indicates that a channel is idle, transmitting a signaling to indicate that a communication node other than the first node performs the radio transmission on the first channel.

In one embodiment, when the first sensing indicates that a channel is idle, the first transmitter performs the radio transmission on the first channel.

In one embodiment, when the first sensing indicates that a channel is idle, the first transmitter transmits a signaling to indicate that the radio transmission on the first channel is performed.

In one embodiment, when the first sensing indicates that a channel is idle, the first transmitter transmits a signaling to indicate that a communication node other than the first node performs the radio transmission on the first channel.

In one embodiment, when the first sensing indicates that a channel is idle, a communication node other than the first node performs the radio transmission on the first channel.

In one embodiment, the monitoring refers to a blind detection, that is, receiving a signal and performing a decoding operation; when the decoding is determined to be correct according to CRC bits, it is determined that a given signal is detected; otherwise, it is determined that a given signal is not detected.

In one embodiment, the monitoring refers to a coherent detection, that is, performing a coherent reception using an RS sequence of DMRS and measuring an energy of a signal obtained after the coherent reception; when the energy of the signal obtained after the coherent reception is less than a first given threshold, it is determined that a given signal is not detected; otherwise, it is determined that a given signal is detected.

In one embodiment, the monitoring refers to a coherent detection, that is, performing a coherent reception using a signature sequence and measuring an energy of a signal obtained after the coherent reception; when the energy of the signal obtained after the coherent reception is less than a second given threshold, it is determined that a given signal is not detected; otherwise, it is determined that a given signal is detected.

In one embodiment, the monitoring refers to an energy detection, that is, sensing energies of radio signals and averaging the energies over time to obtain a received energy; when the received energy is less than third given threshold, it is determined that a given signal is not detected; otherwise, it is determined that a given signal is detected.

In one embodiment, the monitoring refers to a power detection, that is, sensing a power of a radio signal to obtain a received power; when the received power is less than a fourth given threshold, it is determined that a given signal is not detected; otherwise, it is determined that a given signal is detected.

In one embodiment, the sensing failure indication is a consistent LBT failure.

In one embodiment, the first serving cell is a Special Cell (SpCell).

In one embodiment, the first serving cell is a Primary Cell (PCell).

In one embodiment, the first serving cell is a Primary Secondary Cell Group Cell (PSCell).

In one embodiment, the first subband is one subband in the first serving cell.

In one embodiment, the first subband is any one subband in the first serving cell.

In one embodiment, the first subband is any one subband in any one serving cell of the first node.

In one embodiment, the subband configured with a Physical random-access channel (PRACH) is preconfigured.

In one embodiment, the subband configured with a PRACH is configurable.

In one embodiment, the subband configured with a PRACH includes a positive integer number of subcarriers.

In one embodiment, the subband configured with a PRACH includes one carrier.

In one embodiment, the subband configured with a PRACH includes one BWP.

In one embodiment, the subband configured with a PRACH includes one UL BWP.

In one embodiment, the subband configured with a PRACH includes one subband.

In one embodiment, the subband configured with a PRACH belongs to an unlicensed spectrum.

In one embodiment, the second subband is different from the first subband.

In one embodiment, the second subband is predefined.

In one embodiment, the second subband is preconfigured.

In one embodiment, the second subband is configurable.

In one embodiment, the second subband includes a positive integer number of subcarriers.

In one embodiment, the second subband includes one carrier.

In one embodiment, the second subband includes one Bandwidth Part (BWP).

In one embodiment, the second subband includes one UpLink (UL) BWP.

In one embodiment, the second subband includes one subband.

In one embodiment, the second subband belongs to an unlicensed spectrum.

In one embodiment, the upper layer is above an MAC layer.

In one embodiment, the upper layer includes an RLC layer.

In one embodiment, the upper layer includes a PDCP layer.

In one embodiment, the upper layer includes an RLC layer and a PDCP layer.

In one embodiment, the upper layer includes an RLC layer and layers above the RLC layer.

In one embodiment, the upper layer includes an RRC layer.

In one embodiment, the upper layer includes Layer 3 (L3 layer).

In one embodiment, the upper layer includes Layer 3 (L3 layer) and layers above Layer 3.

In one embodiment, the upper layer includes a Non-Access-Stratum (NAS) layer.

In one embodiment, the action of transmitting the sensing failure indication to an upper layer includes: transmitting the sensing failure indication to an RLC layer.

In one embodiment, the action of transmitting the sensing failure indication to an upper layer includes: transmitting the sensing failure indication to an RRC layer.

In one embodiment, the action of transmitting the sensing failure indication to an upper layer includes: transmitting the sensing failure indication to an NAS layer.

In one embodiment, the action of transmitting the sensing failure indication to an upper layer triggers an RLC failure.

In one embodiment, the action of transmitting the sensing failure indication to an upper layer triggers a Radio Link Failure (RLF).

In one embodiment, the action of transmitting the sensing failure indication to an upper layer is transmitted within the first node.

In one embodiment, the action of switching from the first subband to a second subband includes: stopping a random access process that is ongoing in the first serving cell.

In one embodiment, the action of switching from the first subband to a second subband includes: initiating a new random access process.

In one embodiment, the action of switching from the first subband to a second subband includes: transmitting a PRACH for the first serving cell in the second subband.

In one embodiment, the action of switching from the first subband to a second subband includes: performing LBT in the second subband.

In one embodiment, the action of switching from the first subband to a second subband includes: transmitting a radio signal on a physical layer data channel in the second subband.

In one embodiment, the first node is a UE, and the physical layer data channel is a PUSCH.

In one embodiment, the first node is a base station, and the physical layer data channel is a PDSCH.

In one embodiment, the action of switching from the first subband to a second subband includes: receiving Downlink Control Information (DCI) for uplink grant, the DCI for uplink grant indicating frequency domain resources occupied by a physical layer data channel from the second subband.

In one embodiment, the radio link failure message is carried by a higher layer signaling.

In one embodiment, the radio link failure message is carried by an RRC signaling.

In one embodiment, the radio link failure message is carried by an MAC CE signaling.

In one embodiment, the radio link failure message includes an RLF report.

In one embodiment, the radio link failure message includes an MCGfailureInformation.

In one embodiment, the radio link failure message includes an RRCReestablishmentRequest.

In one embodiment, the radio link failure message includes an RRCConnectionReestablishmentRequest.

In one embodiment, when a first condition is met, the first node resets the first counter to an initial value.

In one embodiment, the first condition includes: any one of Q timers expires.

In one embodiment, the first condition includes: the Q is reconfigured.

In one embodiment, the first condition includes: the Q indexes are reconfigured.

In one embodiment, the first condition includes: the Q multiantenna related parameters are reconfigured.

In one embodiment, the first condition includes: TCI states indicated by the Q indexes are reconfigured.

In one embodiment, the first condition includes: the Q reference signal resources are reconfigured.

In one embodiment, the first condition includes: the first mapping table is reconfigured.

In one embodiment, the first condition includes: the first field in the first type of signaling is reconfigured.

In one embodiment, the first condition includes: an expiration value of the first timer is reconfigured.

In one embodiment, the first condition includes: expiration values of the Q timers are reconfigured.

In one embodiment, the first condition includes: an expiration value of any one of the Q timers is reconfigured.

In one embodiment, the first condition includes: an expiration value of one of the Q timers is reconfigured.

In one embodiment, the first condition includes: an expiration value of at least one of the Q timers is reconfigured.

In one embodiment, the first condition includes: expiration values of all the Q timers are reconfigured.

In one embodiment, the first condition includes: an expiration value of the first counter is reconfigured.

In one embodiment, the first condition includes: the sensing failure indication of the first subband that is triggered is cancelled.

In one embodiment, the first condition includes: all triggered sensing failure indications in the first subband are cancelled.

In one embodiment, the first condition includes: in a serving cell to which the first subband belongs, all triggered sensing failure indications are cancelled.

In one embodiment, the first condition includes: lbt-FailureRecoveryConfig is reconfigured.

In one embodiment, as a response to the action that the first signal is transmitted, the first node cancels the sensing failure indication of the first subband that is triggered.

In one embodiment, as a response to the action that the first signal is transmitted, the first node cancels all triggered sensing failure indications in the first subband.

In one embodiment, as a response to the action that the first signal is transmitted, the first node cancels all triggered sensing failure indications in a serving cell to which the first subband belongs.

In one embodiment, as a response to the action that the first signal is transmitted, the first node cancels all triggered sensing failure indications in a target serving cell set, and the signal indicates the target serving cell set.

In one subembodiment, the target serving cell set includes a positive integer number of serving cells.

In one subembodiment, the target serving cell set includes a serving cell to which the first subband belongs.

In one subembodiment, the sensing failure indication has been triggered for any one serving cell in the target serving cell set.

### Embodiment 5B

Embodiment 5B illustrates a flowchart of transmission of a radio signal according to one embodiment of the disclosure, as shown in FIG. 5B. In FIG. 5B, a first node U01B and a second node N02B perform communication through an air interface. In FIG. 5B, dash line boxes F1B, F2B, F3B, F4B and F5B are optional. In FIG. 5B, each box represents one step, in particular, the order of each box in the figure does not represent the precedence relationship in time between the represented steps.

The first node U01B, in S10B, receives a first signaling; in S11B, monitors a first type of signaling in a first subband; in S12B, performs a first sensing in the first subband; in S13B, when the first sensing indicates that a channel is busy, determines to give up a radio transmission on a first channel, starts a first timer and updates a first counter by 1, and when the first timer expires, resets the first counter to an initial value; in S14B, when any one of Q counters reaches or exceeds a target threshold, triggers a sensing failure indication of the first subband; in S15B, when the sensing failure indication has been triggered for each subband configured with a PRACH in a first serving cell, transmits the sensing failure indication to an upper layer; in S16B, as a response to the action of transmitting the sensing failure indication to an upper layer, transmits a radio link failure message; in S17B, when the sensing failure indication has not been triggered for at least one subband configured with a PRACH in a first serving cell, switches from the first subband to a second subband; in S18B, when any one of Q counters reaches or exceeds a target threshold, transmits a first signal; and in S19B, transmits a second signal.

The second node N02B, in 520B, transmits a first signaling; in S21B, transmits a first type of signaling in a first subband; in S22B, receives a radio link failure message; in S23B, receives a first signal; and in S24B, receives a second signal.

In Embodiment 5B, the first channel belongs to the first subband in frequency domain, the first sensing is correlated to a first index, and the first index is any one of Q indexes; the Q indexes are one-to-one corresponding to the Q counters respectively, and the first counter is one of the Q counters that is corresponding to the first index; and Q is a positive integer greater than 1. The first type of signaling is used by the first node U01 to determine the first index; the first sensing is performed each time the first type of signaling is detected. As a response to the action that the sensing failure indication of the first subband is triggered, the first signal is generated. The second subband is one subband in the first serving cell that is configured with a PRACH and has not been triggered the sensing failure indication. The first signaling indicates at least one of an expiration value of the first timer or target thresholds of the Q counters. The second signal indicates a second index, and the second index is one of the Q indexes.

In one embodiment, the first type of signaling is used by the second node N02B to determine the first index.

In one embodiment, when the dash line box F2B does not exist, both the dash line boxes F3B and F4B do not exist.

In one embodiment, the first subband belongs to one serving cell.

In one embodiment, the Q counters are all specific to the first subband.

In one embodiment, the Q indexes correspond to Q Control resource sets (CORESET) sets respectively.

In one embodiment, the Q indexes correspond to Q search space sets respectively.

In one embodiment, the Q indexes correspond to Q CORESET pools respectively.

In one embodiment, the Q indexes correspond to Q CORESETPoolIndexes respectively.

In one embodiment, any one of the Q indexes is a CORESETPoolIndex.

In one embodiment, the Q indexes correspond to Q antenna panels respectively.

In one embodiment, the Q indexes correspond to Q TRPs respectively.

In one embodiment, when the first sensing indicates that a channel is busy, only the first counter among the Q counters is updated by 1.

In one embodiment, when the first sensing indicates that a channel is busy, any one of the Q counters other than the first counter keeps unchanged.

In one embodiment, when the first timer expires, only the first counter among the Q counters is reset to an initial value.

In one embodiment, when the first timer expires, any one of the Q counters other than the first counter keeps unchanged.

In one embodiment, the first timer and the Q counters are maintained by a transmitter of the first signal.

In one embodiment, the method in the first node includes:

when the first sensing indicates that a channel is idle, performing the radio transmission on the first channel.

In one embodiment, the method in the first node includes:

when the first sensing indicates that a channel is idle, transmitting a signaling to indicate that the radio transmission on the first channel is performed.

In one embodiment, the method in the first node includes:

when the first sensing indicates that a channel is idle, transmitting a signaling to indicate that a communication node other than the first node performs the radio transmission on the first channel.

In one embodiment, when the first sensing indicates that a channel is idle, the first transmitter performs the radio transmission on the first channel.

In one embodiment, when the first sensing indicates that a channel is idle, the first transmitter transmits a signaling to indicate that the radio transmission on the first channel is performed.

In one embodiment, when the first sensing indicates that a channel is idle, the first transmitter transmits a signaling to indicate that a communication node other than the first node performs the radio transmission on the first channel.

In one embodiment, when the first sensing indicates that a channel is idle, a communication node other than the first node performs the radio transmission on the first channel.

In one embodiment, the monitoring refers to a blind detection, that is, receiving a signal and performing a decoding operation; when the decoding is determined to be correct according to CRC bits, it is determined that a given signal is detected; otherwise, it is determined that a given signal is not detected.

In one embodiment, the monitoring refers to a coherent detection, that is, performing a coherent reception using an RS sequence of DMRS and measuring an energy of a signal obtained after the coherent reception; when the energy of the signal obtained after the coherent reception is less than a first given threshold, it is determined that a given signal is not detected; otherwise, it is determined that a given signal is detected.

In one embodiment, the monitoring refers to a coherent detection, that is, performing a coherent reception using a signature sequence and measuring an energy of a signal obtained after the coherent reception; when the energy of the signal obtained after the coherent reception is less than a second given threshold, it is determined that a given signal is not detected; otherwise, it is determined that a given signal is detected.

In one embodiment, the monitoring refers to an energy detection, that is, sensing energies of radio signals and averaging the energies over time to obtain a received energy; when the received energy is less than third given threshold, it is determined that a given signal is not detected; otherwise, it is determined that a given signal is detected.

In one embodiment, the monitoring refers to a power detection, that is, sensing a power of a radio signal to obtain a received power; when the received power is less than a fourth given threshold, it is determined that a given signal is not detected; otherwise, it is determined that a given signal is detected.

In one embodiment, the sensing failure indication is a consistent LBT failure.

In one embodiment, the first serving cell is a Special Cell (SpCell).

In one embodiment, the first serving cell is a Primary Cell (PCell).

In one embodiment, the first serving cell is a Primary Secondary Cell Group Cell (PSCell).

In one embodiment, the first subband is one subband in the first serving cell.

In one embodiment, the first subband is any one subband in the first serving cell.

In one embodiment, the first subband is any one subband in any one serving cell of the first node.

In one embodiment, the subband configured with a Physical random-access channel (PRACH) is preconfigured.

In one embodiment, the subband configured with a PRACH is configurable.

In one embodiment, the subband configured with a PRACH includes a positive integer number of subcarriers.

In one embodiment, the subband configured with a PRACH includes one carrier.

In one embodiment, the subband configured with a PRACH includes one BWP.

In one embodiment, the subband configured with a PRACH includes one UL BWP.

In one embodiment, the subband configured with a PRACH includes one subband.

In one embodiment, the subband configured with a PRACH belongs to an unlicensed spectrum.

In one embodiment, the second subband is different from the first subband.

In one embodiment, the second subband is predefined.

In one embodiment, the second subband is preconfigured.

In one embodiment, the second subband is configurable.

In one embodiment, the second subband includes a positive integer number of subcarriers.

In one embodiment, the second subband includes one carrier.

In one embodiment, the second subband includes one Bandwidth Part (BWP).

In one embodiment, the second subband includes one UpLink (UL) BWP.

In one embodiment, the second subband includes one subband.

In one embodiment, the second subband belongs to an unlicensed spectrum.

In one embodiment, the upper layer is above an MAC layer.

In one embodiment, the upper layer includes an RLC layer.

In one embodiment, the upper layer includes a PDCP layer.

In one embodiment, the upper layer includes an RLC layer and a PDCP layer.

In one embodiment, the upper layer includes an RLC layer and layers above the RLC layer.

In one embodiment, the upper layer includes an RRC layer.

In one embodiment, the upper layer includes Layer 3 (L3 layer).

In one embodiment, the upper layer includes Layer 3 (L3 layer) and layers above Layer 3.

In one embodiment, the upper layer includes a Non-Access-Stratum (NAS) layer.

In one embodiment, the action of transmitting the sensing failure indication to an upper layer includes: transmitting the sensing failure indication to an RLC layer.

In one embodiment, the action of transmitting the sensing failure indication to an upper layer includes: transmitting the sensing failure indication to an RRC layer.

In one embodiment, the action of transmitting the sensing failure indication to an upper layer includes: transmitting the sensing failure indication to an NAS layer.

In one embodiment, the action of transmitting the sensing failure indication to an upper layer triggers an RLC failure.

In one embodiment, the action of transmitting the sensing failure indication to an upper layer triggers a Radio Link Failure (RLF).

In one embodiment, the action of transmitting the sensing failure indication to an upper layer is transmitted within the first node.

In one embodiment, the action of switching from the first subband to a second subband includes: stopping a random access process that is ongoing in the first serving cell.

In one embodiment, the action of switching from the first subband to a second subband includes: initiating a new random access process.

In one embodiment, the action of switching from the first subband to a second subband includes: transmitting a PRACH for the first serving cell in the second subband.

In one embodiment, the action of switching from the first subband to a second subband includes: performing LBT in the second subband.

In one embodiment, the action of switching from the first subband to a second subband includes: transmitting a radio signal on a physical layer data channel in the second subband.

In one embodiment, the first node is a UE, and the physical layer data channel is a PUSCH.

In one embodiment, the first node is a base station, and the physical layer data channel is a PDSCH.

In one embodiment, the action of switching from the first subband to a second subband includes: receiving Downlink Control Information (DCI) for uplink grant, the DCI for uplink grant indicating frequency domain resources occupied by a physical layer data channel from the second subband.

In one embodiment, the radio link failure message is carried by a higher layer signaling.

In one embodiment, the radio link failure message is carried by an RRC signaling.

In one embodiment, the radio link failure message is carried by an MAC CE signaling.

In one embodiment, the radio link failure message includes an RLF report.

In one embodiment, the radio link failure message includes an MCGfailureInformation.

In one embodiment, the radio link failure message includes an RRCReestablishmentRequest.

In one embodiment, the radio link failure message includes an RRCConnectionReestablishmentRequest.

In one embodiment, when a first condition is met, the first node resets the first counter to an initial value.

In one embodiment, when a first condition is met, the first node resets all the Q counters to an initial value.

In one embodiment, the first condition includes: the first timer expires.

In one embodiment, the first condition includes: the Q is reconfigured.

In one embodiment, the first condition includes: the Q indexes are reconfigured.

In one embodiment, the first condition includes: the Q multiantenna related parameters are reconfigured.

In one embodiment, the first condition includes: TCI states indicated by the Q indexes are reconfigured.

In one embodiment, the first condition includes: the Q reference signal resources are reconfigured.

In one embodiment, the first condition includes: the first mapping table is reconfigured.

In one embodiment, the first condition includes: the first field in the first type of signaling is reconfigured.

In one embodiment, the first condition includes: an expiration value of the first timer is reconfigured.

In one embodiment, the first condition includes: expiration values of the Q timers are reconfigured.

In one embodiment, the first condition includes: an expiration value of any one of the Q timers is reconfigured.

In one embodiment, the first condition includes: an expiration value of one of the Q timers is reconfigured.

In one embodiment, the first condition includes: an expiration value of at least one of the Q timers is reconfigured.

In one embodiment, the first condition includes: expiration values of all the Q timers are reconfigured.

In one embodiment, the first condition includes: an expiration value of the first counter is reconfigured.

In one embodiment, the first condition includes: expiration values of the Q counters are reconfigured.

In one embodiment, the first condition includes: an expiration value of any one of the Q counters is reconfigured.

In one embodiment, the first condition includes: an expiration value of one of the Q counters is reconfigured.

In one embodiment, the first condition includes: an expiration value of at least one of the Q counters is reconfigured.

In one embodiment, the first condition includes: expiration values of all the Q counters are reconfigured.

In one embodiment, the first condition includes: the sensing failure indication of the first subband that is triggered is cancelled.

In one embodiment, the first condition includes: all triggered sensing failure indications in the first subband are cancelled.

In one embodiment, the first condition includes: in a serving cell to which the first subband belongs, all triggered sensing failure indications are cancelled.

In one embodiment, the first condition includes: lbt-FailureRecoveryConfig is reconfigured.

In one embodiment, as a response to the action that the first signal is transmitted, the first node cancels the sensing failure indication of the first subband that is triggered.

In one embodiment, as a response to the action that the first signal is transmitted, the first node cancels all triggered sensing failure indications in the first subband.

In one embodiment, as a response to the action that the first signal is transmitted, the first node cancels all triggered sensing failure indications in a serving cell to which the first subband belongs.

In one embodiment, as a response to the action that the first signal is transmitted, the first node cancels all triggered sensing failure indications in a target serving cell set, and the signal indicates the target serving cell set.

In one subembodiment, the target serving cell set includes a positive integer number of serving cells.

In one subembodiment, the target serving cell set includes a serving cell to which the first subband belongs.

In one subembodiment, the sensing failure indication has been triggered for any one serving cell in the target serving cell set.

### Embodiment 5C

Embodiment 5C illustrates a flowchart of transmission of a radio signal according to one embodiment of the disclosure, as shown in FIG. 5C. In FIG. 5C, a first node U01C and a second node N02C perform communication through an air interface. In FIG. 5C, dash line boxes F1C and F2C are optional. In FIG. 5C, each box represents one step, in particular, the order of each box in the figure does not represent the precedence relationship in time between the represented steps.

The first node U01C, in S10C, receives a first signaling; in S11C, as a response to the action that a first parameter is reconfigured, resets a first counter to an initial value; in S12C, as a response to the action that the first parameter is reconfigured, resets (Q−1) counters to an initial value; in S13C, monitors a first type of signaling in the first subband; in S14C, performs a first sensing in a first subband; in 515C, when the first sensing indicates that a channel is busy, determines to give up a radio transmission on a first channel, starts a first timer and updates the first counter by 1; in S16C, when the first timer expires, resets the first counter to the initial value; in S17C, when the first counter reaches or exceeds a target threshold, transmits a first signal.

The second node N02C, in 520C, transmits a first signaling; in S21C, transmits a first type of signaling in the first subband; and in 22C, receives a first signal.

In Embodiment 5C, the first signaling reconfigures a first parameter; the first channel belongs to the first subband in frequency domain, and the first parameter is used by the first node U01C to determine a first reference signal resource set; at least one of the radio transmission on the first channel and the first sensing is spatially correlated to a first reference signal resource, the first reference signal resource is one reference signal resource in the first reference signal resource set, and the first reference signal resource set includes at least one reference signal resource. The first sensing is performed by the first node U01C each time the first type of signaling is detected. The Q counters are composed of the first counter and the (Q−1) counters.

In one embodiment, the first parameter is used by the second node N02C to determine a first reference signal resource set.

In one embodiment, the first parameter is used for indicating a first reference signal resource set.

In one embodiment, the first parameter indicates explicitly a first reference signal resource set.

In one embodiment, the first parameter indicates implicitly a first reference signal resource set.

In one embodiment, the first parameter indicates an index of each reference signal resource in a first reference signal resource set.

In one embodiment, the first parameter includes M sub-parameters, the M sub-parameters are used for determining the first reference signal resource set, and the M is a positive integer greater than 1.

In one embodiment, the first parameter includes M sub-parameters, the first reference signal resource set includes M reference signal resources, the M sub-parameters are used for indicating the M reference signal resources respectively, and the M is a positive integer greater than 1.

In one subembodiment, the M sub-parameters indicate explicitly the M reference signal resources respectively.

In one subembodiment, the M sub-parameters indicate implicitly the M reference signal resources respectively.

In one subembodiment, the M sub-parameters indicate indexes of the M reference signal resources respectively.

In one embodiment, the first parameter includes M sub-parameters, any one of the M sub-parameters is used for indicating at least one reference signal resource in the first reference signal resource set, any one reference signal resource in the first reference signal resource set is indicated by one of the M sub-parameters, and the M is a positive integer greater than 1.

In one subembodiment, any one of the M sub-parameters indicates explicitly at least one reference signal resource in the first reference signal resource set.

In one subembodiment, any one of the M sub-parameters indicates implicitly at least one reference signal resource in the first reference signal resource set.

In one subembodiment, any one of the M sub-parameters indicates an index of at least one reference signal resource in the first reference signal resource set.

In one embodiment, any one of the M sub-parameters is a non-negative integer.

In one embodiment, any one of the M sub-parameters is a positive integer.

In one embodiment, any one of the M sub-parameters includes one TCI state.

In one embodiment, any one of the M sub-parameters includes an index of at least one TCI state.

In one embodiment, any one of the M sub-parameters includes an SRS-ResourceId.

In one embodiment, a name of the first parameter includes a tci.

In one embodiment, a name of the first parameter includes a TCI.

In one embodiment, a name of the first parameter includes an SRS.

In one embodiment, a name of the first parameter includes an srs.

In one embodiment, a name of the first parameter includes a CORESET.

In one embodiment, a name of the first parameter includes a coreset.

In one embodiment, the first parameter is a non-negative integer.

In one embodiment, the first parameter is a positive integer.

In one embodiment, the first parameter includes at least one non-negative integer.

In one embodiment, the first parameter includes at least one positive integer.

In one embodiment, the first parameter includes at least one TCI state.

In one embodiment, the first parameter includes an index of at least one TCI state.

In one embodiment, the first parameter includes a tci-StatesToAddModList.

In one embodiment, the first parameter includes a tci-StatesToReleaseList.

In one embodiment, the first parameter includes an SRS-ResourceSet.

In one embodiment, the first parameter includes an index of an antenna panel.

In one embodiment, the first parameter includes an index of a TRP.

In one embodiment, the first parameter includes a coresetPoolIndex-r16.

In one embodiment, the first parameter includes a tci-PresentInDCI.

In one embodiment, the first parameter includes a tci-StatesPDCCH-ToAddList.

In one embodiment, the first parameter includes a tci-StatesPDCCH-ToReleaseList.

In one embodiment, the first parameter includes a CORESETPoolIndex.

In one embodiment, the first parameter is used by the first node U01C to determine a first mapping table.

In one embodiment, the first parameter is used by the second node U02C to determine a first mapping table.

In one embodiment, the first parameter is used for indicating a first mapping table.

In one embodiment, the first parameter indicates explicitly a first mapping table.

In one embodiment, the first parameter indicates implicitly a first mapping table.

In one embodiment, any one mapping value in the first mapping table indicates at least one reference signal resource in the first reference signal resource set.

In one embodiment, the first reference signal resource set is used by the first node U01C to determine the first mapping table.

In one embodiment, the first reference signal resource set is used by the first second U02C to determine the first mapping table.

In one embodiment, at least one reference signal resource in the first reference signal resource set is used by the first node U01C to determine the first mapping table.

In one embodiment, at least one reference signal resource in the first reference signal resource set is used by the second node N02C to determine the first mapping table.

In one embodiment, the first mapping table is configured by a higher layer signaling.

In one embodiment, the first mapping table is configured by an RRC signaling.

In one embodiment, the first mapping table is configured by an MAC CE signaling.

In one embodiment, the first mapping table is preconfigured.

In one embodiment, the first mapping table is predefined.

In one embodiment, the first mapping table is fixed.

In one embodiment, the first mapping table is a TCI table.

In one embodiment, any one mapping value in the first mapping table corresponds to at least one TCI state.

In one embodiment, the first mapping table is an SRS resource table.

In one embodiment, any one mapping value in the first mapping table corresponds to at least one SRS resource.

In one embodiment, the first parameter is related to time-frequency resources occupied by the first type of signaling.

In one embodiment, the first parameter corresponds to a first time-frequency resource set, the first time-frequency resource set includes time-frequency resources occupied by the first type of signaling, and the first time-frequency resource set corresponds to the first reference signal resource set.

In one embodiment, the first time-frequency resource set includes a positive integer number of CORESETs.

In one embodiment, the first time-frequency resource set includes a positive integer number of search spaces.

In one embodiment, the first time-frequency resource set includes a positive integer number of REs.

In one embodiment, the first parameter is related to a TCI state of the first type of signaling.

In one embodiment, the first parameter corresponds to a first TCI state set, the first TCI state set includes a TCI state of the first type of signaling, and the first TCI state set corresponds to the first reference signal resource set.

In one embodiment, an expiration value of the first timer is a positive integer.

In one embodiment, an expiration value of the first timer is configurable.

In one embodiment, an expiration value of the first timer is predefined.

In one embodiment, the expiration value of the first timer is indicated by an lbt-FailureDetectionTimer.

In one embodiment, the first timer is a beamFailureDetectionTimer.

In one embodiment, the first counter is a BFI COUNTER.

In one embodiment, an initial value of the first counter is 0.

In one embodiment, an initial value of the first counter is a positive integer.

In one embodiment, a target threshold of the first counter is a positive integer.

In one embodiment, a target threshold of the first counter is 0.

In one embodiment, a target threshold of the first counter is configured.

In one embodiment, a target threshold of the first counter is predefined.

In one embodiment, the target threshold of the first counter is indicated by an lbt-FailureInstanceMaxCount.

In one embodiment, the first signaling indicates at least one of an expiration value of the first timer or a target threshold of the first counter.

In one embodiment, the first signaling indicates an expiration value of the first timer.

In one embodiment, the first signaling indicates a target threshold of the first counter.

In one embodiment, the first signaling indicates an expiration value of the first timer and a target threshold of the first counter.

In one embodiment, the first signaling reconfigures at least one of an expiration value of the first timer or a target threshold of the first counter.

In one embodiment, the first signaling reconfigures an expiration value of the first timer.

In one embodiment, the first signaling reconfigures a target threshold of the first counter.

In one embodiment, the first signaling reconfigures an expiration value of the first timer and a target threshold of the first counter.

In one embodiment, the first receiver receives a second signaling, wherein the second signaling indicates at least one of an expiration value of the first timer or a target threshold of the first counter.

In one embodiment, the second transmitter transmits a second signaling, wherein the second signaling indicates at least one of an expiration value of the first timer or a target threshold of the first counter.

In one embodiment, the first signaling and the second signaling belong to one same RRC signaling.

In one embodiment, the first signaling and the second signaling belong to different RRC signalings.

In one embodiment, the first signaling and the second signaling belong to one same RRC IE.

In one embodiment, the first signaling and the second signaling belong to different RRC IEs.

In one embodiment, the second signaling includes a higher layer signaling.

In one embodiment, the second signaling includes an RRC signaling.

In one embodiment, the second signaling includes an MAC CE signaling.

In one embodiment, the second signaling includes one IE in an RRC signaling.

In one embodiment, the second signaling includes multiple IEs in an RRC signaling.

In one embodiment, the second signaling includes an LBT-FailureRecoveryConfig IE in an RRC signaling.

In one embodiment, the second signaling includes an LBT-FailureRecoveryConfig-r16 IE in an RRC signaling.

In one embodiment, the second signaling indicates an expiration value of the first timer.

In one embodiment, the second signaling indicates a target threshold of the first counter.

In one embodiment, the second signaling indicates an expiration value of the first timer and a target threshold of the first counter.

In one embodiment, the second signaling indicates at least one of an expiration value of the first timer or a target threshold of the first counter.

In one embodiment, the second signaling indicates at least one of expiration values of the Q timers or target thresholds of the Q counters.

In one embodiment, the method in the first node includes:

when the first sensing indicates that a channel is idle, performing the radio transmission on the first channel.

In one embodiment, the method in the first node includes:

when the first sensing indicates that a channel is idle, transmitting a signaling to indicate that the radio transmission on the first channel is performed.

In one embodiment, the method in the first node includes:

when the first sensing indicates that a channel is idle, transmitting a signaling to indicate that a communication node other than the first node performs the radio transmission on the first channel.

In one embodiment, when the first sensing indicates that a channel is idle, the first transmitter performs the radio transmission on the first channel.

In one embodiment, when the first sensing indicates that a channel is idle, the first transmitter transmits a signaling to indicate that the radio transmission on the first channel is performed.

In one embodiment, when the first sensing indicates that a channel is idle, the first transmitter transmits a signaling to indicate that a communication node other than the first node performs the radio transmission on the first channel.

In one embodiment, when the first sensing indicates that a channel is idle, a communication node other than the first node performs the radio transmission on the first channel.

In one embodiment, the higher layer includes Layer 2 (L2 layer).

In one embodiment, the higher layer includes Layer 3 (L3 layer).

In one embodiment, the higher layer includes a Radio Resource Control (RRC) layer.

In one embodiment, the higher layer includes Layer 2 (L2 layer) and Layer 3 (L3 layer).

In one embodiment, the higher layer includes Layer 2 (L2 layer) and layers above Layer 2.

In one embodiment, the first signal is transmitted on a PUSCH.

In one embodiment, the first signal is transmitted on a PUCCH.

In one embodiment, the first signal includes a scheduling request.

In one embodiment, the first signal includes a Media Access Control Control Element (MAC CE).

In one embodiment, the first signal includes a physical layer signal.

In one embodiment, the first signal includes a PRACH.

In one embodiment, the first signal includes a higher layer signal.

In one embodiment, the first signal includes an LBT failure MAC CE.

In one embodiment, the first signal includes a scheduling request for an LBT failure MAC CE.

In one embodiment, when the sensing failure indication has not been triggered for at least one subband configured with a PRACH in a first serving cell, the first transmitter switches from the first subband to a second subband, and the first signal includes a PRACH.

In one embodiment, when the sensing failure indication has been triggered for each subband configured with a PRACH in a first serving cell, the first signal includes a sensing failure indication.

In one embodiment, when the sensing failure indication has been triggered for each subband configured with a PRACH in a first serving cell, the first signal includes a radio link failure message.

In one embodiment, before transmitting the first signal, the first receiver performs a channel sensing to determine that a channel occupied by the first signal is available for radio transmission.

In one embodiment, as a response to the action that the first signal is transmitted, the first node cancels the sensing failure indication of the first subband that is triggered.

In one embodiment, as a response to the action that the first signal is transmitted, the first node cancels all triggered sensing failure indications in the first subband.

In one embodiment, as a response to the action that the first signal is transmitted, the first node cancels all triggered sensing failure indications in a serving cell to which the first subband belongs.

In one embodiment, as a response to the action that the first signal is transmitted, the first node cancels all triggered sensing failure indications in a target serving cell set, and the signal indicates the target serving cell set.

In one subembodiment, the target serving cell set includes a positive integer number of serving cells.

In one subembodiment, the target serving cell set includes a serving cell to which the first subband belongs.

In one subembodiment, the sensing failure indication has been triggered for any one serving cell in the target serving cell set.

In one embodiment, the first subband belongs to one serving cell.

In one embodiment, when the first timer reaches an expiration value of the first timer, the first timer expires.

In one embodiment, when any one condition in a first condition set is met, the first counter is reset to an initial value; when the first condition set includes more than one condition, the first condition is one condition in the first condition set; the first condition includes: the first parameter is reconfigured.

In one embodiment, one condition in the first condition set includes: the first timer expires.

In one embodiment, one condition in the first condition set includes: an expiration value of the first timer is reconfigured.

In one embodiment, one condition in the first condition set includes: a target threshold of the first counter is reconfigured.

In one embodiment, one condition in the first condition set includes: the first mapping table is reconfigured.

In one embodiment, one condition in the first condition set includes: the first field in the first type of signaling is reconfigured.

In one embodiment, one condition in the first condition set includes: the sensing failure indication of the first subband that is triggered is cancelled.

In one embodiment, one condition in the first condition set includes: all triggered sensing failure indications in the first subband are cancelled.

In one embodiment, one condition in the first condition set includes: in a serving cell to which the first subband belongs, all triggered sensing failure indications are cancelled.

In one embodiment, one condition in the first condition set includes: an lbt-FailureRecoveryConfig is reconfigured.

### Embodiment 6A

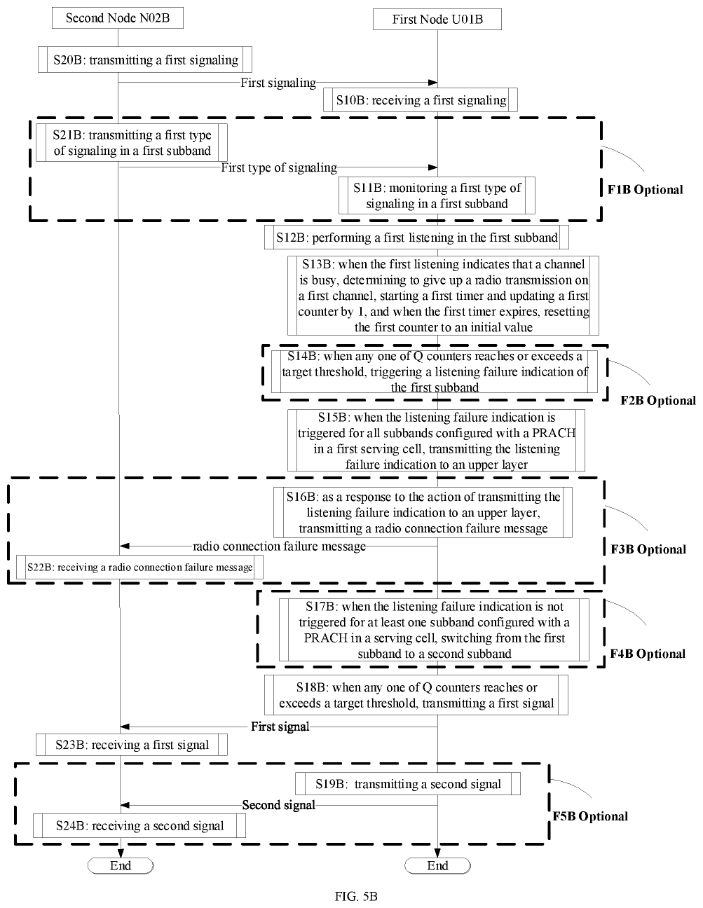

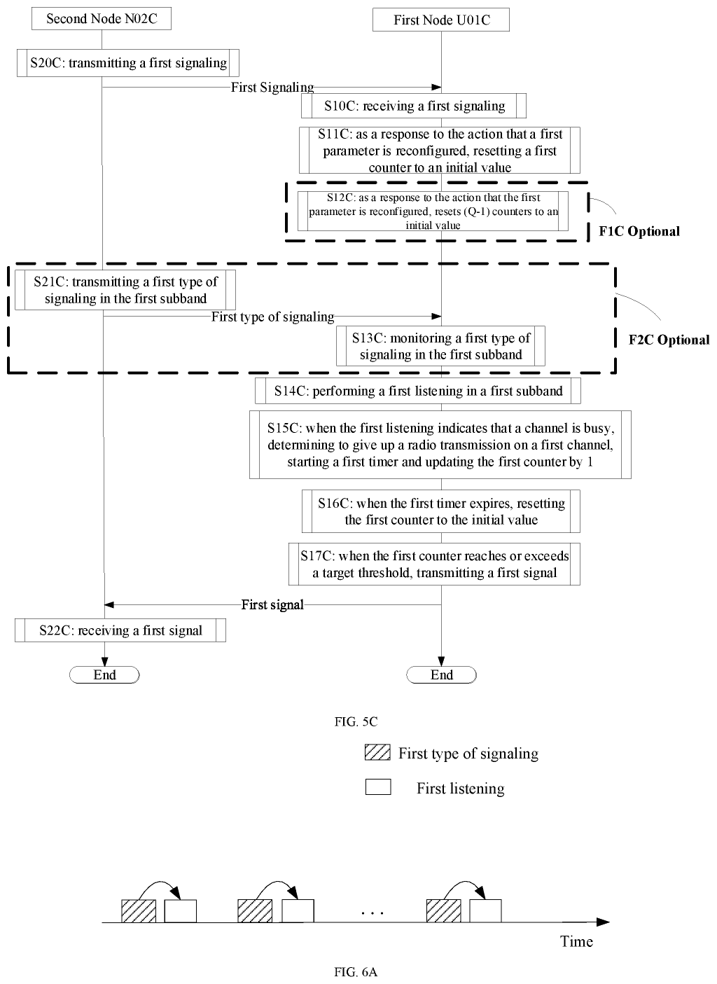

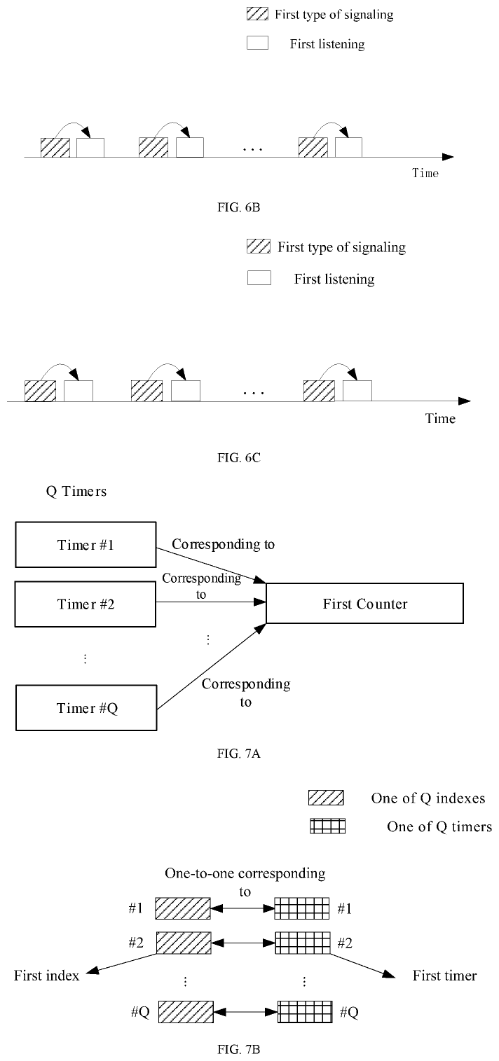

Embodiment 6A illustrates a diagram of a first type of signaling and a first sensing, as shown in FIG. 6A.

In Embodiment 6A, the first type of signaling is used for determining the first index in the disclosure; and the first sensing is performed each time the first type of signaling is detected.

In one embodiment, the first type of signaling is dynamically configured.

In one embodiment, the first type of signaling is a higher layer signaling.

In one embodiment, the first type of signaling is an RRC signaling.

In one embodiment, the first type of signaling is an MAC CE signaling.

In one embodiment, the first type of signaling is a physical layer signaling.

In one embodiment, the first type of signaling is transmitted on a downlink.

In one embodiment, the first type of signaling is transmitted on a sidelink.

In one embodiment, the first type of signaling is a DCI signaling.

In one embodiment, the first type of signaling is transmitted on a PDCCH.

In one embodiment, the first type of signaling is a Sidelink Control Information (SCI) signaling.

In one embodiment, a TCI state indicated by the first index is used for receiving the first type of signaling.

In one embodiment, a TCI state indicated by the first index is used for determining a multiantenna related parameter for receiving the first type of signaling.

In one embodiment, the first index is used for determining a first reference signal resource, and a multiantenna related parameter for receiving the first type of signaling is correlated to the first reference signal resource.

In one embodiment, the first index is used for determining a first reference signal resource, and a QCL parameter of the first reference signal resource is used for receiving the first type of signaling.

In one embodiment, the first index is used for determining a first reference signal resource, and a QCL parameter for receiving the first reference signal resource is used for determining a multiantenna related parameter for receiving the first type of signaling.

In one embodiment, the first index is used for determining a first reference signal resource, and a QCL parameter for receiving the first reference signal resource is used for receiving the first type of signaling.

In one subembodiment, the first reference signal resource is a downlink reference signal resource.

In one subembodiment, the first reference signal resource is a sidelink reference signal resource.

In one embodiment, the first index is used for determining a first reference signal resource, and a QCL parameter for transmitting the first reference signal resource is used for receiving the first type of signaling.

In one subembodiment, the first reference signal resource is an uplink reference signal resource.

In one subembodiment, the first reference signal resource is a sidelink reference signal resource.

In one embodiment, the multiantenna related parameter for receiving the first type of signaling includes an analog beamforming matrix.

In one embodiment, the multiantenna related parameter for receiving the first type of signaling includes a digital beamforming matrix.

In one embodiment, the multiantenna related parameter for receiving the first type of signaling includes a coefficient of a spatial filter.

In one embodiment, the multiantenna related parameter for receiving the first type of signaling includes a QCL parameter.

In one embodiment, a signaling format of the first type of signaling is used for determining the first index.

In one embodiment, the first type of signaling carries a first identifier and the first identifier is used for determining the first index.

In one embodiment, the first identifier is a non-negative integer.

In one embodiment, the first identifier is a Radio Network Temporary Identifier (RNTI).

In one embodiment, a signaling format of the first type of signaling belongs to a first format set, and the first format set corresponds to the first index; and the first format set includes a positive integer number of formats.

In one embodiment, Q format sets are one-to-one corresponding to the Q indexes respectively, a first format set is one of the Q format sets that includes a signaling format of the first type of signaling, and the first index is one of the Q indexes that is corresponding to the first format set; and any one of the Q format sets includes a positive integer number of formats.

In one embodiment, the first type of signaling is used for indicating the first index.

In one embodiment, the first type of signaling indicates explicitly the first index.

In one embodiment, the first type of signaling indicates implicitly the first index.

In one embodiment, the first type of signaling includes a first field, and the first filed in the first type of signaling is used for determining the first index.

In one embodiment, the first type of signaling includes a first field, and the first filed in the first type of signaling is used for indicating the first index.

In one subembodiment, the first filed in the first type of signaling indicates explicitly the first index.

In one subembodiment, the first filed in the first type of signaling indicates implicitly the first index.

In one embodiment, the first index is equal to a value of the first field in the first type of signaling.

In one embodiment, the first index is a mapping value in a first mapping table for the first field in the first type of signaling.

In one embodiment, a positive integer number of candidate values for the first field in the first type of signaling all correspond to the first index.

In one embodiment, only one candidate value for the first field in the first type of signaling corresponds to the first index.

In one embodiment, multiple candidate values for the first field in the first type of signaling correspond to the first index.

In one embodiment, the first field is a TCI field.

In one embodiment, the first field is an SRS resource indicator field.

In one embodiment, the first field in the first type of signaling indicates one RS resource.

In one embodiment, the first field in the first type of signaling indicates a first multiantenna related parameter, and the first sensing employs the first multiantenna related parameter.

In one embodiment, the first field in the first type of signaling is used for indicating a multiantenna related parameter of the radio transmission on the first channel.

In one embodiment, a multiantenna related parameter of the radio transmission on the first channel is the same as the first multiantenna related parameter employed by the first sensing.

In one embodiment, a multiantenna related parameter of the radio transmission on the first channel is different from the first multiantenna related parameter employed by the first sensing.

In one embodiment, a multiantenna related parameter of the radio transmission on the first channel includes an analog beamforming matrix.

In one embodiment, a multiantenna related parameter of the radio transmission on the first channel includes a digital beamforming matrix.

In one embodiment, a multiantenna related parameter of the radio transmission on the first channel includes a coefficient of a spatial filter.

In one embodiment, a multiantenna related parameter of the radio transmission on the first channel includes a QCL parameter.

In one embodiment, the first mapping table is configured by a higher layer signaling.

In one embodiment, the first mapping table is configured by an RRC signaling.

In one embodiment, the first mapping table is configured by an MAC CE signaling.

In one embodiment, the first mapping table is preconfigured.

In one embodiment, the first mapping table is predefined.

In one embodiment, the first mapping table is fixed.

In one embodiment, the first mapping table is a TCI table.

In one embodiment, the first mapping table is an SRS resource table.

In one embodiment, one candidate value for the first field in the first type of signaling has only one mapping value in the first mapping table.

In one embodiment, at least two candidate values for the first field in the first type of signaling are mapped to one same mapping value in the first mapping table.

In one embodiment, the first type of signaling includes a second field, the second field in the first type of signaling is used for indicating a multiantenna related parameter of the radio transmission on the first channel; the first field and the second field are two different fields.

In one embodiment, the second field is a TCI field.

In one embodiment, the second field is an SRS resource indicator field.

In one embodiment, the second field in the first type of signaling indicates a multiantenna related parameter of the radio transmission on the first channel.

In one embodiment, when K signalings of the first type are detected, K first sensings are performed, and the K is a positive integer.

In one embodiment, the first type of signaling is one of Q types of signalings, the Q types of signalings are used for determining the Q indexes respectively, and the first index is one of the Q indexes that is determined by the first type of signaling.

In one embodiment, the first receiver monitors (Q−1) types of signalings among the Q types of signalings other than the first type of signaling in the first subband.

### Embodiment 6B

Embodiment 6B illustrates a diagram of a first type of signaling and a first sensing, as shown in FIG. 6B.

In Embodiment 6B, the first type of signaling is used for determining the first index in the disclosure; and the first sensing is performed each time the first type of signaling is detected.

In one embodiment, the first type of signaling is dynamically configured.

In one embodiment, the first type of signaling is a higher layer signaling.

In one embodiment, the first type of signaling is an RRC signaling.

In one embodiment, the first type of signaling is an MAC CE signaling.

In one embodiment, the first type of signaling is a physical layer signaling.

In one embodiment, the first type of signaling is transmitted on a downlink.

In one embodiment, the first type of signaling is transmitted on a sidelink.

In one embodiment, the first type of signaling is a DCI signaling.

In one embodiment, the first type of signaling is transmitted on a PDCCH.

In one embodiment, the first type of signaling is a Sidelink Control Information (SCI) signaling.

In one embodiment, a TCI state indicated by the first index is used for receiving the first type of signaling.

In one embodiment, a TCI state indicated by the first index is used for determining a multiantenna related parameter for receiving the first type of signaling.

In one embodiment, the first index is used for determining a first reference signal resource, and a multiantenna related parameter for receiving the first type of signaling is correlated to the first reference signal resource.

In one embodiment, the first index is used for determining a first reference signal resource, and a QCL parameter of the first reference signal resource is used for receiving the first type of signaling.

In one embodiment, the first index is used for determining a first reference signal resource, and a QCL parameter for receiving the first reference signal resource is used for determining a multiantenna related parameter for receiving the first type of signaling.

In one embodiment, the first index is used for determining a first reference signal resource, and a QCL parameter for receiving the first reference signal resource is used for receiving the first type of signaling.

In one subembodiment, the first reference signal resource is a downlink reference signal resource.

In one subembodiment, the first reference signal resource is a sidelink reference signal resource.

In one embodiment, the first index is used for determining a first reference signal resource, and a QCL parameter for transmitting the first reference signal resource is used for receiving the first type of signaling.

In one subembodiment, the first reference signal resource is an uplink reference signal resource.

In one subembodiment, the first reference signal resource is a sidelink reference signal resource.

In one embodiment, the multiantenna related parameter for receiving the first type of signaling includes an analog beamforming matrix.

In one embodiment, the multiantenna related parameter for receiving the first type of signaling includes a digital beamforming matrix.

In one embodiment, the multiantenna related parameter for receiving the first type of signaling includes a coefficient of a spatial filter.

In one embodiment, the multiantenna related parameter for receiving the first type of signaling includes a QCL parameter.

In one embodiment, a signaling format of the first type of signaling is used for determining the first index.

In one embodiment, the first type of signaling carries a first identifier and the first identifier is used for determining the first index.

In one embodiment, the first identifier is a non-negative integer.

In one embodiment, the first identifier is a Radio Network Temporary Identifier (RNTI).

In one embodiment, a signaling format of the first type of signaling belongs to a first format set, and the first format set corresponds to the first index; and the first format set includes a positive integer number of formats.

In one embodiment, Q format sets are one-to-one corresponding to the Q indexes respectively, a first format set is one of the Q format sets that includes a signaling format of the first type of signaling, and the first index is one of the Q indexes that is corresponding to the first format set; and any one of the Q format sets includes a positive integer number of formats.

In one embodiment, the first type of signaling is used for indicating the first index.

In one embodiment, the first type of signaling indicates explicitly the first index.

In one embodiment, the first type of signaling indicates implicitly the first index.

In one embodiment, the first type of signaling includes a first field, and the first filed in the first type of signaling is used for determining the first index.

In one embodiment, the first type of signaling includes a first field, and the first filed in the first type of signaling is used for indicating the first index.

In one subembodiment, the first filed in the first type of signaling indicates explicitly the first index.

In one subembodiment, the first filed in the first type of signaling indicates implicitly the first index.

In one embodiment, the first index is equal to a value of the first field in the first type of signaling.

In one embodiment, the first index is a mapping value in a first mapping table for the first field in the first type of signaling.

In one embodiment, a positive integer number of candidate values for the first field in the first type of signaling all correspond to the first index.

In one embodiment, only one candidate value for the first field in the first type of signaling corresponds to the first index.

In one embodiment, multiple candidate values for the first field in the first type of signaling correspond to the first index.

In one embodiment, the first field is a TCI field.

In one embodiment, the first field is an SRS resource indicator field.

In one embodiment, the first field in the first type of signaling indicates one RS resource.

In one embodiment, the first field in the first type of signaling indicates a first multiantenna related parameter, and the first sensing employs the first multiantenna related parameter.

In one embodiment, the first field in the first type of signaling is used for indicating a multiantenna related parameter of the radio transmission on the first channel.

In one embodiment, a multiantenna related parameter of the radio transmission on the first channel is the same as the first multiantenna related parameter employed by the first sensing.

In one embodiment, a multiantenna related parameter of the radio transmission on the first channel is different from the first multiantenna related parameter employed by the first sensing.

In one embodiment, a multiantenna related parameter of the radio transmission on the first channel includes an analog beamforming matrix.

In one embodiment, a multiantenna related parameter of the radio transmission on the first channel includes a digital beamforming matrix.

In one embodiment, a multiantenna related parameter of the radio transmission on the first channel includes a coefficient of a spatial filter.

In one embodiment, a multiantenna related parameter of the radio transmission on the first channel includes a QCL parameter.

In one embodiment, the first mapping table is configured by a higher layer signaling.

In one embodiment, the first mapping table is configured by an RRC signaling.

In one embodiment, the first mapping table is configured by an MAC CE signaling.

In one embodiment, the first mapping table is preconfigured.

In one embodiment, the first mapping table is predefined.

In one embodiment, the first mapping table is fixed.

In one embodiment, the first mapping table is a TCI table.

In one embodiment, the first mapping table is an SRS resource table.

In one embodiment, one candidate value for the first field in the first type of signaling has only one mapping value in the first mapping table.

In one embodiment, at least two candidate values for the first field in the first type of signaling are mapped to one same mapping value in the first mapping table.

In one embodiment, the first type of signaling includes a second field, the second field in the first type of signaling is used for indicating a multiantenna related parameter of the radio transmission on the first channel; the first field and the second field are two different fields.

In one embodiment, the second field is a TCI field.

In one embodiment, the second field is an SRS resource indicator field.

In one embodiment, the second field in the first type of signaling indicates a multiantenna related parameter of the radio transmission on the first channel.

In one embodiment, when K signalings of the first type are detected, K first sensings are performed, and the K is a positive integer.

In one embodiment, the first type of signaling is one of Q types of signalings, the Q types of signalings are used for determining the Q indexes respectively, and the first index is one of the Q indexes that is determined by the first type of signaling.

In one embodiment, the first receiver monitors (Q−1) types of signalings among the Q types of signalings other than the first type of signaling in the first subband.

### Embodiment 6C

Embodiment 6C illustrates a diagram of a first type of signaling and a first sensing, as shown in FIG. 6C.

In Embodiment 6C, the first sensing is performed each time the first type of signaling is detected.

In one embodiment, when K signalings of the first type are detected, K first sensings are performed, and the K is a positive integer.

In one embodiment, the monitoring refers to a blind detection, that is, receiving a signal and performing a decoding operation; when the decoding is determined to be correct according to CRC bits, it is determined that a given signal is detected; otherwise, it is determined that a given signal is not detected.

In one embodiment, the monitoring refers to a coherent detection, that is, performing a coherent reception using an RS sequence of DMRS and measuring an energy of a signal obtained after the coherent reception; when the energy of the signal obtained after the coherent reception is less than a first given threshold, it is determined that a given signal is not detected; otherwise, it is determined that a given signal is detected.

In one embodiment, the monitoring refers to a coherent detection, that is, performing a coherent reception using a signature sequence and measuring an energy of a signal obtained after the coherent reception; when the energy of the signal obtained after the coherent reception is less than a second given threshold, it is determined that a given signal is not detected; otherwise, it is determined that a given signal is detected.

In one embodiment, the monitoring refers to an energy detection, that is, sensing energies of radio signals and averaging the energies over time to obtain a received energy; when the received energy is less than third given threshold, it is determined that a given signal is not detected; otherwise, it is determined that a given signal is detected.

In one embodiment, the monitoring refers to a power detection, that is, sensing a power of a radio signal to obtain a received power; when the received power is less than a fourth given threshold, it is determined that a given signal is not detected; otherwise, it is determined that a given signal is detected.

In one embodiment, the first type of signaling is dynamically configured.

In one embodiment, the first type of signaling is a higher layer signaling.

In one embodiment, the first type of signaling is an RRC signaling.

In one embodiment, the first type of signaling is an MAC CE signaling.

In one embodiment, the first type of signaling is a physical layer signaling.

In one embodiment, the first type of signaling is transmitted on a downlink.

In one embodiment, the first type of signaling is transmitted on a sidelink.

In one embodiment, the first type of signaling includes a DCI signaling.

In one embodiment, the first type of signaling is transmitted on a PDCCH.

In one embodiment, the first type of signaling is a Sidelink Control Information (SCI) signaling.

In one embodiment, the first type of signaling is any one of Q types of signalings, the Q types of signalings correspond to the Q counters respectively, the first counter is one of the Q counters that is corresponding to the first type of signaling, and the Q is a positive integer greater than 1.

In one embodiment, the first type of signaling is any one of Q types of signalings, the Q types of signalings correspond to the Q reference signal resources respectively, the first reference signal resource is one of the Q reference signal resources that is corresponding to the first type of signaling, and the Q is a positive integer greater than 1.

### Embodiment 7A

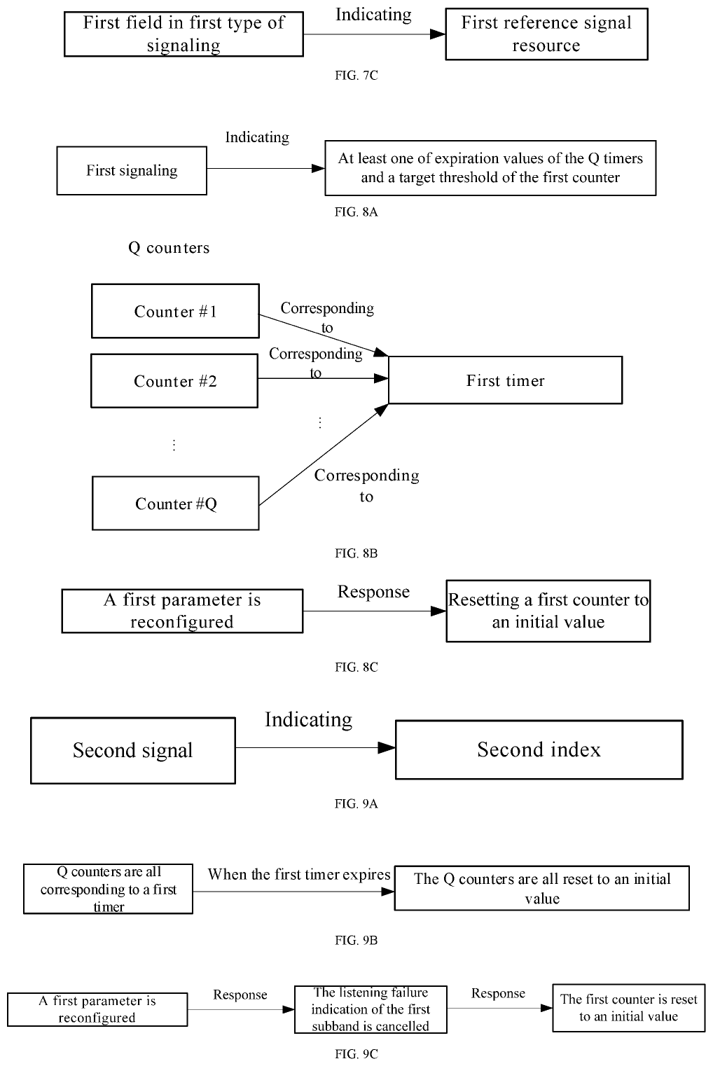

Embodiment 7A illustrates a diagram of Q timers and a first counter, as shown in FIG. 7A.

In Embodiment 7A, the Q timers in the disclosure are all corresponding to the first counter.

In one embodiment, expiration values of all the Q timers are positive integers.

In one embodiment, expiration values of all the Q timers are the same.

In one embodiment, expiration values of at least two of the Q timers are different.

In one embodiment, expiration values of the Q timers are configured respectively.

In one embodiment, expiration values of the Q timers are predefined respectively.

In one embodiment, the Q timers and the first counter are maintained by a transmitter of the first signal.

In one embodiment, the Q timers are all specific to the first subband.

In one embodiment, the phrase that the Q timers are all corresponding to the first counter includes: the Q indexes are all corresponding to the first counter.

In one embodiment, the phrase that the Q timers are all corresponding to the first counter includes: the first counter is independent of which one of the Q indexes is the first index.

In one embodiment, the phrase that the Q timers are all corresponding to the first counter includes: any one of the Q timers is used for determining the first counter.

In one embodiment, the phrase that the Q timers are all corresponding to the first counter includes: each one of the Q timers is used for determining the first counter.

In one embodiment, the phrase that the Q timers are all corresponding to the first counter includes: the first counter is related to all the Q timers.

### Embodiment 7B

Embodiment 7B illustrates a diagram of a first timer, as shown in FIG. 7B.

In Embodiment 7B, the Q indexes in the disclosure are one-to-one corresponding to Q timers, the first timer is one of the Q timers that corresponds to the first index in the disclosure.

In one embodiment, expiration values of all the Q timers are positive integers.

In one embodiment, expiration values of all the Q timers are the same.

In one embodiment, expiration values of at least two of the Q timers are different.

In one embodiment, expiration values of the Q timers are configured respectively.

In one embodiment, expiration values of the Q timers are predefined respectively.

In one embodiment, the Q timers and the Q counters are maintained by a transmitter of the first signal.

In one embodiment, the Q timers are all specific to the first subband.

In one embodiment, the phrase that the Q indexes are one-to-one corresponding to Q timers includes: the Q timers are one-to-one corresponding to the Q counters. In one embodiment, the phrase that the Q indexes are one-to-one corresponding to Q timers includes: the Q timers are related to the Q indexes respectively.

In one embodiment, the phrase that the Q indexes are one-to-one corresponding to Q timers includes: the Q timers are used for determining the Q counters respectively.

In one embodiment, the phrase that the Q indexes are one-to-one corresponding to Q timers includes: the Q counters are related to the Q timers respectively.

In one embodiment, the phrase that the Q indexes are one-to-one corresponding to Q timers includes: when the first timer expires, only the first counter among the Q counters is reset to an initial value.

In one embodiment, the phrase that the Q indexes are one-to-one corresponding to Q timers includes: when the first timer expires, any one of the Q counters other than the first counter keeps unchanged.

### Embodiment 7C

Embodiment 7C illustrates a diagram of a relationship between a first type of signaling and a first reference signal resource, as shown in FIG. 7C.

In Embodiment 7C, the first type of signaling includes a first field, and the first field in the first type of signaling is used for indicating the first reference signal resource.

In one embodiment, the first field in the first type of signaling includes a positive integer number of bits.

In one embodiment, the first field is a TCI field.

In one embodiment, the first field is an SRS resource indicator field.

In one embodiment, the first field in the first type of signaling is used for indicating the first reference signal resource from the first reference signal resource set.

In one embodiment, the first field in the first type of signaling is used for indicating the first multiantenna related parameter.

In one embodiment, the first field in the first type of signaling indicates explicitly the first multiantenna related parameter.

In one embodiment, the first field in the first type of signaling indicates implicitly the first multiantenna related parameter.

In one embodiment, the first field in the first type of signaling is used for indicating the second multiantenna related parameter.

In one embodiment, the first field in the first type of signaling indicates explicitly the second multiantenna related parameter.

In one embodiment, the first field in the first type of signaling indicates implicitly the second multiantenna related parameter.

In one embodiment, the first field in the first type of signaling indicates explicitly the first reference signal resource.

In one embodiment, the first field in the first type of signaling indicates implicitly the first reference signal resource.

In one embodiment, the first field in the first type of signaling corresponds to a first mapping table, and a value of the first field in the first type of signaling indicates one mapping value in the first mapping table.

In one embodiment, a value of the first field in the first type of signaling indicates a first mapping value, the first mapping value is one mapping value in the first mapping table, and the first mapping value indicates the first reference signal resource.

In one subembodiment, the first mapping value indicates a first reference signal resource group, and the first reference signal resource is one reference signal resource in the first reference signal resource group.

In one subembodiment, a value of the first field in the first type of signaling is equal to the first mapping value

In one subembodiment, a value of the first field in the first type of signaling is different from the first mapping value

### Embodiment 8A

Embodiment 8A illustrates a diagram of a first signaling, as shown in FIG. 8A.

In Embodiment 8A, the first signaling indicates at least one of expiration values of the Q timers or a target threshold of the first counter in the disclosure.

In one embodiment, the first signaling includes a higher layer signaling.

In one embodiment, the first signaling includes an RRC signaling.

In one embodiment, the first signaling includes an MAC CE signaling.

In one embodiment, the first signaling includes one IE in an RRC signaling.

In one embodiment, the first signaling includes multiple IEs in an RRC signaling.

In one embodiment, the first signaling includes an LBT-FailureRecoveryConfig IE in an RRC signaling.

In one embodiment, the first signaling indicates expiration values of the Q timers and a target threshold of the first counter.

In one embodiment, the first signaling indicates expiration values of the Q timers.

In one embodiment, the first signaling indicates a target threshold of the first counter.

In one embodiment, the first signaling indicates at least one of an expiration value of each one of the Q timers or a target threshold of the first counter.

In one embodiment, the first signaling indicates an expiration value of each one of the Q timers and a target threshold of the first counter.

In one embodiment, the first signaling indicates an expiration value of each one of the Q timers.

In one embodiment, the expiration values of all the Q timers are the same, and the first signaling indicates the expiration values of the Q timers.

In one embodiment, the first signaling includes an LBT-FailureRecoveryConfig IE.

In one embodiment, the expiration values of the Q timers are indicated by an lbt-FailureDetectionTimer.

In one embodiment, the first signaling includes an LBT-FailureRecoveryConfig IE.

In one embodiment, the expiration values of the Q timers are indicated by an lbt-FailureDetectionTimer.

In one embodiment, the target threshold of the first counter is indicated by an lbt-FailureInstanceMaxCount.

In one embodiment, the first signaling includes Q sub-signalings, the Q sub-signalings are one-to-one corresponding to the Q timers respectively, each one of the Q sub-signalings indicates at least one of the expiration value of a corresponding timer or the target threshold of the first counter.

In one subembodiment, each one of the Q sub-signalings indicates the expiration value of a corresponding timer.

In one subembodiment, each one of the Q sub-signalings indicates the target threshold of the first counter.

In one subembodiment, each one of the Q sub-signalings indicates the expiration value of a corresponding timer and the target threshold of the first counter.

In one subembodiment, each one of the Q sub-signalings includes an LBT-FailureRecoveryConfig IE.

### Embodiment 8B

Embodiment 8B illustrates another diagram of a first timer, as shown in FIG. 8B.

In Embodiment 8B, the Q counters in the disclosure are all corresponding to the first timer.

In one embodiment, the phrase that the Q counters are all corresponding to the first timer includes: the Q indexes are all corresponding to the first timer.

In one embodiment, the phrase that the Q counters are all corresponding to the first timer includes: the first timer is independent of which one of the Q indexes is the first index.

In one embodiment, the phrase that the Q counters are all corresponding to the first timer includes: the first timer is used for determining any one of the Q counters.

In one embodiment, the phrase that the Q counters are all corresponding to the first timer includes: the first timer is used for determining each one of the Q counters.

In one embodiment, the phrase that the Q counters are all corresponding to the first timer includes: the Q counters are all related to the first timer.

In one embodiment, the phrase that the Q counters are all corresponding to the first timer includes: when the first timer expires, the Q counters are all reset to an initial value.

In one embodiment, the phrase that the Q counters are all corresponding to the first timer includes: when the first timer expires, only the first counter among the Q counters is reset to an initial value.

In one embodiment, the phrase that the Q counters are all corresponding to the first timer includes: when the first timer expires, any one of the Q counters other than the first counter keeps unchanged.

### Embodiment 8C

Embodiment 8C illustrates a diagram of a relationship between a first parameter and a first counter, as shown in FIG. 8C.

In Embodiment 8C, as a response to the action that the first parameter is reconfigured, the first counter is reset to an initial value

In one embodiment, when the first parameter is reconfigured, the first counter is reset to the initial value.

### Embodiment 9A

Embodiment 9A illustrates a diagram of a second signal, as shown in FIG. 9A.

In Embodiment 9A, the second signal indicates a second index, and the second index is one of the Q indexes in the disclosure.

In one embodiment, the second signal includes one physical layer signal.

In one embodiment, the second signal includes one higher layer signal.

In one embodiment, the second signal includes one MAC CE.

In one embodiment, the first node is a UE, and the transmission of the second signal is grant free.

In one embodiment, the first node is a UE, and the transmission of the second signal is configured grant.

In one embodiment, the first node recommends a channel sensing correlated to the second index.

In one embodiment, as a response to the action that a first condition set is met, the second signal is triggered.

In one embodiment, the first condition set includes: the first sensing indicates that a channel is busy.

In one embodiment, the first condition set includes: the Q indexes are used for determining Q multiantenna related parameters respectively; the first multiantenna related parameter is employed by the first sensing, and at least one of the Q multiantenna related parameters other than the first multiantenna related parameter is more suitable for channel sensing than the first multiantenna related parameter.

In one embodiment, the first condition set includes: the Q multiantenna related parameters are correlated to the Q indexes respectively; a first multiantenna related parameter among the Q multiantenna related parameters that is correlated to the first index is employed by the first sensing, and at least one of the Q multiantenna related parameters other than the first multiantenna related parameter is more suitable for channel sensing than the first multiantenna related parameter.

In one embodiment, the second index is used for determining the second multiantenna related parameter, and the second multiantenna related parameter is more suitable for channel sensing than the first multiantenna related parameter.

In one embodiment, a multiantenna related parameter correlated to the second index is most suitable for channel sensing among the Q multiantenna related parameters, and the Q multiantenna related parameters are correlated to the Q indexes respectively.

In one embodiment, the second signal is transmitted on an uplink.

In one embodiment, the second signal is transmitted on a sidelink.

In one embodiment, a physical layer channel occupied by the second signal includes a PRACH.

In one embodiment, a physical layer channel occupied by the second signal includes a PUSCH.

In one embodiment, a physical layer channel occupied by the second signal includes a PUCCH.

In one embodiment, a transport channel occupied by the second signal includes an UpLink Shared Channel (UL-SCH).

In one embodiment, a physical layer channel occupied by the second signal includes a PSSCH.

In one embodiment, a transport channel occupied by the second signal includes a SideLink Shared CHannel (SL-SCH).

### Embodiment 9B

Embodiment 9B illustrates another diagram of a first timer, as shown in 9B.

In Embodiment 9B, the Q counters are all corresponding to the first timer; when the first timer expires, the Q counters in the disclosure are all reset to an initial value.

In one embodiment, when the first timer expires, the first transmitter resets all the Q counters to an initial value.

In one embodiment, when the first timer expires, the first transmitter also resets (Q−1) counters among the Q counters other than the first counter to an initial value.

### Embodiment 9C

Embodiment 9C illustrates another diagram of a relationship between a first parameter and a first counter, as shown in FIG. 9C.

In Embodiment 9C, as a response to the action that the first parameter is reconfigured, the sensing failure indication of the first subband is cancelled, wherein as a response to the action that the sensing failure indication of the first subband is cancelled, the first counter is reset to an initial value.

In one embodiment, the sensing failure indication of the first subband is cancelled by the first transmitter in the disclosure.

In one embodiment, when any one condition in a second condition set is met, the sensing failure indication of the first subband is cancelled; the second condition set includes more than one condition, a first condition is one condition in the second condition set; and the first condition includes: the first parameter is reconfigured.

In one embodiment, one condition in the second condition set includes: the first signal is transmitted.

In one embodiment, one condition in the second condition set includes: a random access process is considered to be successfully completed.

In one embodiment, one condition in the second condition set includes: an lbt-FailureRecoveryConfig is reconfigured.

### Embodiment 10A

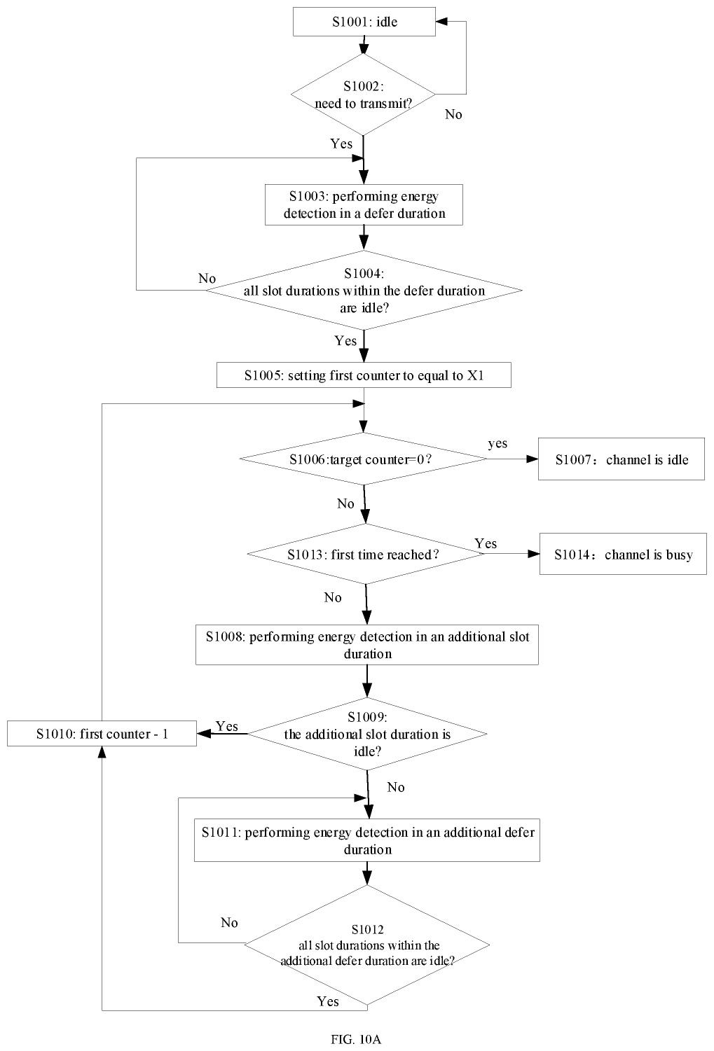

Embodiment 10A illustrates a diagram of a scenario in which a first sensing indicates whether a channel is busy, as shown in FIG. 10A.

In Embodiment 10A, the first sensing includes performing X times of energy detections in X time subpools in the first subband in the disclosure respectively to obtain X detection values; when X1 detection values among the X detection values are all less than a first reference threshold, the first sensing indicates that a channel is idle; otherwise, the first sensing indicates that a channel is busy; X is a positive integer, and X1 is a positive integer not greater than X. The process of the first sensing can be described through the flowchart shown in FIG. 10A.

In FIG. 10A, the first node in the disclosure is in an idle state in S1001; determines whether it is needed to transmit signals in S1002; performs an energy detections in a defer duration in S1003; determines whether all slot durations within the defer duration are idle in S1004, if yes, goes to S1005 to set a target counter to equal to X1, otherwise, returns to S1004; determines whether the target counter is 0 in S1006, if yes, goes to S1007 to indicate that a channel is idle, otherwise, goes to S1008 to perform an energy detections in an additional slot duration before a first time; determines whether the additional slot duration is idle in S1009, if yes, goes to step S1010 to subtract 1 from the target counter, and then returns to S1006, otherwise, goes to S1011 to perform an energy detections in an additional defer duration; determines whether all slot durations within the additional defer duration are idle in S1012, if yes, goes to S1010, otherwise, returns to S1011.

In Embodiment 10A, the target counter in FIG. 10A is reset before the first time, the first sensing indicates that a channel is idle, and a radio transmission may be performed in the first subband; otherwise, go to S1014 to indicate that a channel is busy, then give up performing the radio transmission in the first subband. The condition under which the target counter is reset is that the X1 detection values among the X detection values are all less than a first reference threshold, and start times of X1 time subpools among the X time subpools that are corresponding to the X1 detection values are behind S1005 in FIG. 10A.

In one embodiment, the X1 is equal to the X.

In one embodiment, the X1 is less than the X.

In one embodiment, end times of the X time subpools are not later than the first time.

In one embodiment, the first time is a start time of the radio transmission in the first subband.

In one embodiment, the first time is not later than a start time of the radio transmission in the first subband.

In one embodiment, the first time is a start time of the radio transmission in the first subband in the disclosure.

In one embodiment, the first time is not later than a start time of the radio transmission in the first subband in the disclosure.

In one embodiment, the X time subpools include all defer durations in FIG. 10A.

In one embodiment, the X time subpools include partial defer durations in FIG. 10A.

In one embodiment, the X time subpools include all defer durations and all additional defer durations in FIG. 10A.

In one embodiment, the X time subpools include all defer durations and partial additional defer durations in FIG. 10A.

In one embodiment, the X time subpools include all defer durations, all additional slot durations and all additional defer durations in FIG. 10A.

In one embodiment, the X time subpools include all defer durations, partial additional slot durations and all additional defer durations in FIG. 10A.

In one embodiment, the X time subpools include all defer durations, partial additional slot durations and partial additional defer durations in FIG. 10A.

In one embodiment, a duration of any one of the X time subpools is one of 16 microseconds or 9 microseconds.

In one embodiment, any one slot duration within a given duration is one of the X time subpools; the given duration is any one duration among all defer durations, all additional slot durations or all additional defer durations included in FIG. 10A.

In one embodiment, the phrase that performs an energy detection in a given duration refers to: performing an energy detection in all slot durations within the given duration, wherein the given duration is any one duration among all defer durations, all additional slot durations or all additional defer durations} included in FIG. 10A.

In one embodiment, the phrase that a given duration determined to be idle through an energy detection refers that: all slot durations included in the given duration are determined to be idle through an energy detection, wherein the given duration is any one duration among all defer durations, all additional slot durations or all additional defer duration included in FIG. 10A.

In one embodiment, the phrase that a given slot duration determined to be idle through an energy detection refers that: the first node senses powers of all radio signals in the first subband in a given time unit and averages the powers over time, and the obtained received power is lower than a first reference threshold, wherein the given time unit is a continuous period of time in the given slot duration.

In one subembodiment, a duration of the given time unit is not less than 4 microseconds.

In one embodiment, the phrase that a given slot duration determined to be idle through an energy detection refers that: the first node senses energies of all radio signals in the first subband in a given time unit and averages the energies over time, and the obtained received energy is lower than a first reference threshold, wherein the given time unit is a continuous period of time in the given slot duration.

In one subembodiment, a duration of the given time unit is not less than 4 microseconds.

In one embodiment, the phrase that performs an energy detection in a given duration refers to: performing an energy detection in all time subpools within the given duration, wherein the given duration is any one duration among all defer durations, all additional slot durations or all additional defer durations included in FIG. 10A, and the all time subpools belong to the X time subpools.

In one embodiment, the phrase that a given duration determined to be idle through an energy detection refers that: an energy detection is performed in all time subpools included in the given duration and all obtained detection values are less than a first reference threshold, wherein the given duration is any one duration among all defer durations, all additional slot durations or all additional defer durations included in FIG. 10A, the all time subpools belong to the X time subpools, and the detection values belong to the X detection values.

In one embodiment, one defer duration is 16 microseconds plus Y1*9 microseconds, wherein the Y1 is a positive integer.

In one subembodiment, one defer duration includes Y1+1 time subpools among the X time subpools.

In one reference embodiment of the above subembodiment, a first time subpool among the Y1+1 time subpools has a duration of 16 microseconds, and the other Y1 time subpools all have a duration of 9 microseconds.

In one subembodiment, a given priority level is used for determining the Y1.

In one reference embodiment of the above subembodiment, the priority level is a Channel Access Priority Class.

In one subembodiment, the Y1 belongs to {1, 2, 3, 7}.

In one embodiment, the definition of the Channel Access Priority Class can refer to Chapter 15 in 3GPP TS36.213.

In one embodiment, the definition of the Channel Access Priority Class can refer to Chapter 4 in 3GPP TS37.213.

In one embodiment, one defer duration includes a plurality of slot durations.

In one subembodiment, a first slot duration and a second slot duration among the plurality of slot durations are inconsecutive.

In one subembodiment, a first slot duration and a second slot duration among the plurality of slot durations have a time interval of 7 ms.

In one embodiment, one additional defer duration is 16 microseconds plus Y2*9 microseconds, wherein the Y2 is a positive integer.

In one subembodiment, one additional defer duration includes Y2+1 time subpools among the X time subpools.

In one reference embodiment of the above subembodiment, a first time subpool among the Y2+1 time subpools has a duration of 16 microseconds, and the other Y2 time subpools all have a duration of 9 microseconds.

In one subembodiment, a priority level is used for determining the Y2.

In one subembodiment, the Y2 belongs to {1, 2, 3, 7}.

In one embodiment, one defer duration is equal to one additional defer duration.

In one embodiment, the Y1 is equal to the Y2.

In one embodiment, one additional defer duration includes a plurality of slot durations.

In one subembodiment, a first slot duration and a second slot duration among the plurality of slot durations are inconsecutive.

In one subembodiment, a first slot duration and a second slot duration among the plurality of slot durations have a time interval of 7 ms.

In one embodiment, one slot duration is 9 microseconds.

In one embodiment, one slot duration is 1 time subpool among the X time subpools.

In one embodiment, one additional slot duration is 9 microseconds.

In one embodiment, one additional slot duration includes 1 time subpool among the X time subpools.

In one subembodiment, the X times of energy detections are used for determining whether the first frequency subband is idle.

In one subembodiment, the X times of energy detections are used for determining whether the first subband can be used by the first node to transmit a radio signal.

In one embodiment, the X detection values are in units of dBm.

In one embodiment, the X detection values are in units of mW.

In one embodiment, the X detection values are in units of J (Joule).

In one embodiment, the X1 is less than the X.

In one embodiment, the X is greater than 1.

In one embodiment, the first reference threshold is configurable.

In one embodiment, the first reference threshold is predefined.

In one subembodiment, the first reference threshold is configured by a high-layer signaling.

In one subembodiment, the first reference threshold is configured by an RRC signaling.

In one subembodiment, the first reference threshold is in unit of dBm.

In one subembodiment, the first reference threshold is in unit of mW.

In one subembodiment, the first reference threshold is in unit of J (Joule).

In one subembodiment, the first reference threshold is equal to or less than −72 dBm.

In one embodiment, the first reference threshold is any value equal to or less than a first given value.

In one subembodiment, the first given value is predefined.

In one subembodiment, the first given value is configured by a high-layer signaling.

In one embodiment, the first reference threshold is selected by the first node freely that is equal to or less than a first given value.

In one subembodiment, the first given value is predefined.

In one subembodiment, the first given value is configured by a high-layer signaling.

In one embodiment, the X times of energy detections are energy detections during a Cat 4 LBT process, and the X1 is a CWₚ during Cat 4 LBT, and the CWₚ represents a Contention Window size.

In one embodiment, the specific definition of the CWₚ can refer to Chapter 15 in 3GPP TS36.213.

In one embodiment, the specific definition of the CWp can refer to Chapter 4 in 3GPP TS37.213.

In one embodiment, at least one of the X detections values that does not belong to the X1 detection values is less than the first reference threshold.

In one embodiment, at least one of the X detections values that does not belong to the X1 detection values is not less than the first reference threshold.

In one embodiment, any two of the X1 time subpools have equal durations.

In one embodiment, at least two of the X1 time subpools have unequal durations.

In one embodiment, the X1 time subpools include a latest one of the X time subpools.

In one embodiment, the X1 time subpools include slot durations in an eCCA only.

In one embodiment, the X time subpools include the X1 time subpools and X2 time subpools; any one of the X2 time subpools does not belong to the X1 time subpools; and the X2 is a positive integer not greater than the X minus the X1.

In one subembodiment, the X2 time subpools include slot durations in an initial CCA.

In one subembodiment, the X2 time subpools have consecutive positions in the X time subpools.

In one subembodiment, at least one of the X2 time subpools has a corresponding detection value less than the first reference threshold.

In one subembodiment, at least one of the X2 time subpools has a corresponding detection value not less than the first reference threshold.

In one subembodiment, the X2 time subpools include all slot durations within all defer slot durations.

In one subembodiment, the X2 time subpools include all slot durations within at least one additional slot duration.

In one subembodiment, the X2 time subpools include at least one additional slot duration.

In one subembodiment, the X2 time subpools include all slot durations within all additional slot durations and all additional defer durations that are determined to be non-idle through an energy detection in FIG. 10A.

In one embodiment, the X1 time subpools belong to X1 subpool sets respectively, and any one of the X1 subpool sets includes a positive integer number of time subpool(s) among the X time subpools; any one of the X1 subpool sets has a corresponding detection value less than the first reference threshold.

In one subembodiment, at least one of the X1 subpool sets includes 1 time subpool.

In one subembodiment, at least one of the X1 subpool sets includes more than 1 time subpool.

In one subembodiment, at least two of the X1 subpool sets include different numbers of time subpools.

In one subembodiment, none of the X time subpools belongs to two of the X1 subpool sets simultaneously.

In one subembodiment, all time subpools in any one of the X1 subpool sets belong to one same additional defer duration or additional slot duration determined to be idle through an energy detection.

In one subembodiment, at least one of the X time subpools that does not belong to the X1 subpool sets has a corresponding detection value less than the first reference threshold.

In one subembodiment, at least one of the X time subpools that does not belong to the X1 subpool sets has a corresponding detection value not less than the first reference threshold.

### Embodiment 10B

Embodiment 10B illustrates a diagram of a first signaling, as shown in FIG. 10B.

In Embodiment 10B, the first signaling indicates at least one of an expiration value of the first timer in the disclosure or target thresholds of the Q counters in the disclosure.

In one embodiment, the first signaling includes a higher layer signaling.

In one embodiment, the first signaling includes an RRC signaling.

In one embodiment, the first signaling includes an MAC CE signaling.

In one embodiment, the first signaling includes one IE in an RRC signaling.

In one embodiment, the first signaling includes multiple IEs in an RRC signaling.

In one embodiment, the first signaling includes an LBT-FailureRecoveryConfig IE in an RRC signaling.

In one embodiment, the first signaling indicates at least one of expiration values of the Q timers or target thresholds of the Q counters.

In one embodiment, the first signaling indicates expiration values of the Q timers and target thresholds of the Q counters.

In one embodiment, the first signaling indicates expiration values of the Q timers.

In one embodiment, the first signaling indicates target thresholds of the Q counters.

In one embodiment, the first signaling indicates at least one of an expiration value of each one of the Q timers or a target threshold of each one of the Q counters.

In one embodiment, the first signaling indicates an expiration value of each one of the Q timers and a target threshold of each one of the Q counters.

In one embodiment, the first signaling indicates an expiration value of each one of the Q timers.

In one embodiment, the first signaling indicates a target threshold of each one of the Q counters.

In one embodiment, the expiration values of all the Q timers are the same, and the first signaling indicates the expiration values of the Q timers.

In one embodiment, the target thresholds of all the Q counters are the same, and the first signaling indicates the target thresholds of the Q counters.

In one embodiment, the first signaling includes an LBT-FailureRecoveryConfig IE.

In one embodiment, the expiration values of the Q timers are indicated by an lbt-FailureDetectionTimer.

In one embodiment, the first signaling indicates an expiration value of the first timer and target thresholds of the Q counters.

In one embodiment, the first signaling indicates an expiration value of the first timer.

In one embodiment, the first signaling indicates at least one of an expiration value of the first timer or a target threshold of each one of the Q counters.

In one embodiment, the first signaling indicates an expiration value of the first timer and a target threshold of each one of the Q counters.

In one embodiment, the first signaling includes an LBT-FailureRecoveryConfig IE.

In one embodiment, the expiration value of the first timer is indicated by an lbt-FailureDetectionTimer.

In one embodiment, the target thresholds of the Q counters are indicated by an lbt-FailureInstanceMaxCount.

In one embodiment, the first signaling includes Q sub-signalings, the Q sub-signalings are one-to-one corresponding to the Q timers respectively, the Q sub-signalings are one-to-one corresponding to the Q counters respectively, each one of the Q sub-signalings indicates at least one of the expiration value of a corresponding timer or the target threshold of a corresponding counter.

In one subembodiment, each one of the Q sub-signalings indicates the expiration value of a corresponding timer.

In one subembodiment, each one of the Q sub-signalings indicates the target threshold of a corresponding counter.

In one subembodiment, each one of the Q sub-signalings indicates the expiration value of a corresponding timer and the target threshold of a corresponding counter.

In one embodiment, the first signaling includes Q sub-signalings, the Q sub-signalings are one-to-one corresponding to the Q indexes respectively, each one of the Q sub-signalings indicates at least one of the expiration value of a timer correlated to a corresponding index or the target threshold of a counter correlated to a corresponding index.

In one subembodiment, each one of the Q sub-signalings indicates the expiration value of a timer correlated to a corresponding index and the target threshold of a counter correlated to a corresponding index.

In one subembodiment, each one of the Q sub-signalings indicates the expiration value of a timer correlated to a corresponding index.

In one subembodiment, each one of the Q sub-signalings indicates the target threshold of a counter correlated to a corresponding index.

In one subembodiment, each one of the Q sub-signalings includes an LBT-FailureRecoveryConfig 1E.

In one embodiment, the first signaling includes Q sub-signalings, the Q sub-signalings are one-to-one corresponding to the Q indexes, each one of the Q sub-signalings indicates at least one of the expiration value of the first timer or the target threshold of a counter correlated to a corresponding index.

In one subembodiment, each one of the Q sub-signalings indicates the expiration value of the first timer and the target threshold of a counter correlated to a corresponding index.

In one subembodiment, each one of the Q sub-signalings indicates the expiration value of the first timer.

In one subembodiment, each one of the Q sub-signalings indicates the target threshold of a counter correlated to a corresponding index.

### Embodiment 10C

Embodiment 10C illustrates a diagram of a triggering condition for a first signal, as shown in FIG. 10C.

In Embodiment 10C, when the first counter in the disclosure reaches or exceeds a target threshold, the first signal is transmitted.

### Embodiment 11A

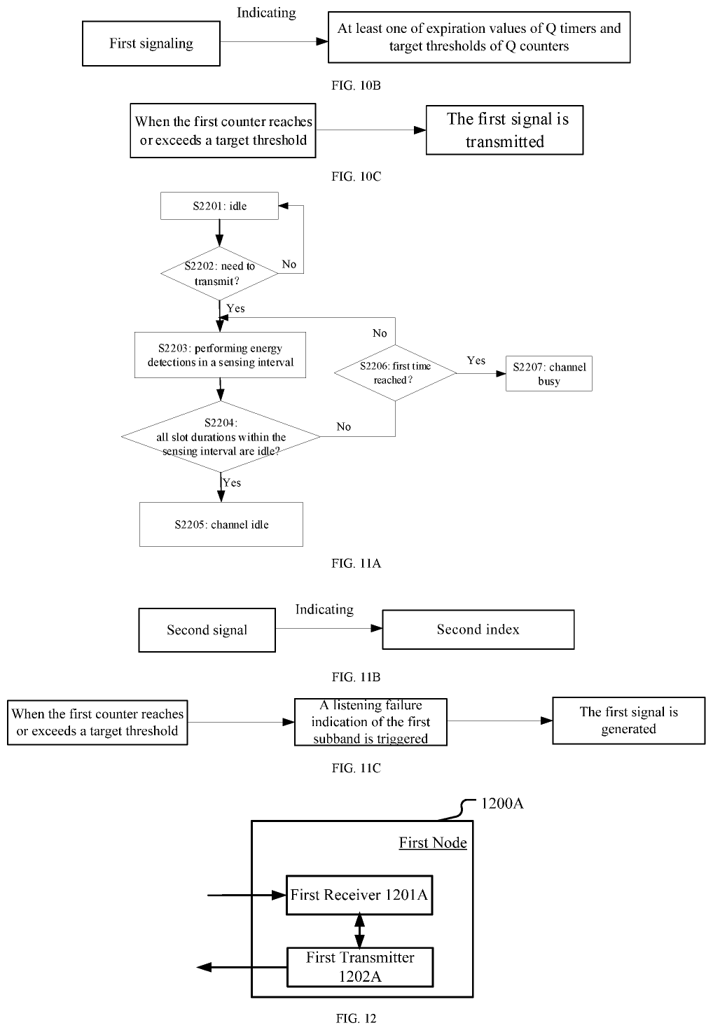

Embodiment 11A illustrates another diagram of a scenario in which a first sensing indicates whether a channel is busy, as shown in FIG. 11A.

In Embodiment 11A, the first sensing includes performing X times of energy detections in X time subpools in the first subband in the disclosure respectively to obtain X detection values; when X1 detection values among the X detection values are all less than a first reference threshold, the first sensing indicates that a channel is idle; otherwise, the first sensing indicates that a channel is busy; X is a positive integer, and X1 is a positive integer not greater than X. The process of the first sensing can be described through the flowchart shown in FIG. 11A.

In FIG. 11A, the first node in the disclosure is in an idle state in S2201; determines whether it is needed to transmit signals in S2202; performs an energy detections in a sensing interval in S2203; determines whether all slot durations within the sensing interval are idle in S2204, if yes, goes to S2205 to indicate that a channel is idle and a radio transmission may be performed in the first subband; otherwise, returns to S2203 before a first time; when determining that the first time is reached in S2206, goes to S2207 to indicate that a channel is busy, and gives up performing a radio transmission in the first subband.

In one embodiment, end times of the X time subpools are not later than the first time.

In one embodiment, the first time is a start time of the radio transmission in the first subband.

In one embodiment, the first time is not later than a start time of the radio transmission in the first subband.

In one embodiment, the first time is a start time of the radio transmission in the first subband in the disclosure.

In one embodiment, the first time is not later than a start time of the radio transmission in the first subband in the disclosure.

In one embodiment, the specific definition of the sensing interval can refer to Chapter 15.2 in 3GPP TS36.213.

In one embodiment, the specific definition of the sensing interval can refer to Chapter 4 in 3GPP TS37.213.

In one embodiment, the X1 is equal to 1.

In one embodiment, the X1 is equal to 2.

In one embodiment, the X1 is equal to the X.

In one embodiment, one sensing interval has a duration of 25 microseconds.

In one embodiment, one sensing interval has a duration of 16 microseconds.

In one embodiment, one sensing interval includes 2 slot durations, and the 2 slot durations are inconsecutive in time domain.

In one subembodiment, the 2 slot durations has a time interval of 7 microseconds.

In one embodiment, the X time subpools include the listening time in Category 2 LBT.

In one embodiment, the X time subpools include slots in a sensing interval in a Type 2 UL channel access procedure.

In one embodiment, the specific definition of the sensing interval can refer to Chapter 15.2 in 3GPP TS36.213.

In one embodiment, the specific definition of the sensing interval can refer to Chapter 4 in 3GPP TS37.213.

In one embodiment, the sensing interval has a duration of 25 microseconds.

In one embodiment, the sensing interval has a duration of 16 microseconds.

In one embodiment, the X time subpools include a Tf in a sensing interval in a Type 2 UL channel access procedure.

In one embodiment, the X time subpools include a Tf and a Tsl in a sensing interval in a Type 2 UL channel access procedure.

In one embodiment, the specific definition of the Tf and the Tsl can refer to Chapter 15.2 in 3GPP TS36.213.

In one embodiment, the specific definition of the Tf and the Tsl can refer to Chapter 4 in 3GPP TS37.213.

In one embodiment, the Tf has a duration of 16 microseconds.

In one embodiment, the Tsl has a duration of 9 microseconds.

In one embodiment, the X1 is equal to 1, and the X1 time subpool has a duration of 16 microseconds.

In one embodiment, the X1 is equal to 2, a first time subpool among the X1 time subpools has a duration of 16 microseconds, and a second time subpool among the X1 time subpools has a duration of 9 microseconds.

In one embodiment, the X1 time subpools all have a duration of 9 microseconds; a first time subpool and a second time subpool among the X1 time subpools have a time interval of 7 microseconds, and the X1 is equal to 2.

### Embodiment 11B

Embodiment 11B illustrates a diagram of a second signal, as shown in FIG. 11B.

In Embodiment 11B, the second signal indicates a second index, and the second index is one of the Q indexes in the disclosure.

In one embodiment, the second signal includes one physical layer signal.

In one embodiment, the second signal includes one higher layer signal.

In one embodiment, the second signal includes one MAC CE.

In one embodiment, the first node is a UE, and the transmission of the second signal is grant free.

In one embodiment, the first node is a UE, and the transmission of the second signal is configured grant.

In one embodiment, the first node recommends a channel sensing correlated to the second index.

In one embodiment, as a response to the action that a first condition set is met, the second signal is triggered.

In one embodiment, the first condition set includes: the first sensing indicates that a channel is busy.

In one embodiment, the first condition set includes: the Q indexes are used for determining Q multiantenna related parameters respectively; the first multiantenna related parameter is employed by the first sensing, and at least one of the Q multiantenna related parameters other than the first multiantenna related parameter is more suitable for channel sensing than the first multiantenna related parameter.

In one embodiment, the first condition set includes: the Q multiantenna related parameters are correlated to the Q indexes respectively; a first multiantenna related parameter among the Q multiantenna related parameters that is correlated to the first index is employed by the first sensing, and at least one of the Q multiantenna related parameters other than the first multiantenna related parameter is more suitable for channel sensing than the first multiantenna related parameter.

In one embodiment, the second index is used for determining the second multiantenna related parameter, and the second multiantenna related parameter is more suitable for channel sensing than the first multiantenna related parameter.

In one embodiment, a multiantenna related parameter correlated to the second index is most suitable for channel sensing among the Q multiantenna related parameters, and the Q multiantenna related parameters are correlated to the Q indexes respectively.

In one embodiment, the second signal is transmitted on an uplink.

In one embodiment, the second signal is transmitted on a sidelink.

In one embodiment, a physical layer channel occupied by the second signal includes a PRACH.

In one embodiment, a physical layer channel occupied by the second signal includes a PUSCH.

In one embodiment, a physical layer channel occupied by the second signal includes a PUCCH.

In one embodiment, a transport channel occupied by the second signal includes an UpLink Shared Channel (UL-SCH).

In one embodiment, a physical layer channel occupied by the second signal includes a PSSCH.

In one embodiment, a transport channel occupied by the second signal includes a SideLink Shared CHannel (SL-SCH).

### Embodiment 11C

Embodiment 11C illustrates another diagram of a triggering condition for a first signal, as shown in FIG. 11C.

In Embodiment 11C, when the first counter in the disclosure reaches or exceeds a target threshold, the first transmitter in the disclosure triggers a sensing failure indication of the first subband; wherein as a response of the action that the sensing failure indication of the first subband is triggered, the first signal is generated.

In one embodiment, the sensing failure indication is a consistent LBT failure.

In one embodiment, when the first counter reaches or exceeds a target threshold, the first receiver selects a new subband and performs LBT so as to determine whether a random access can be initiated in the new subband.

In one embodiment, when the first counter reaches or exceeds a target threshold, the first receiver selects a new serving cell and performs LBT so as to determine whether a random access can be initiated in the new serving cell.

### Embodiment 12

Embodiment 12 illustrates a structure block diagram of a processing device in a first node, as shown in FIG. 12. In FIG. 12, the processing device 1200 in the first node includes a first receiver 1201 and a first transmitter 1202.

In one embodiment, the first node 1200 is a UE.

In one embodiment, the first node 1200 is a relay node.

In one embodiment, the first node 1200 is a base station.

In one embodiment, the first node 1200 is a vehicle communication equipment.

In one embodiment, the first node 1200 is a UE supporting V2X communication.

In one embodiment, the first node 1200 is a relay node supporting V2X communication.

In one embodiment, the first receiver 1201 includes at least one of the antenna 452, the receiver 454, the multiantenna receiving processor 458, the receiving processor 456, the controller/processor 459, the memory 460 and the data source 467 illustrated in FIG. 4 in the disclosure.

In one embodiment, the first receiver 1201 includes at least the former two of the antenna 452, the receiver 454, the multiantenna receiving processor 458, the receiving processor 456, the controller/processor 459, the memory 460 and the data source 467 illustrated in FIG. 4 in the disclosure.

In one embodiment, the first receiver 1201 includes at least one of the antenna 420, the receiver 418, the multiantenna receiving processor 472, the receiving processor 470, the controller/processor 475 and the memory 476 illustrated in FIG. 4 in the disclosure.

In one embodiment, the first receiver 1201 includes at least the former two of the antenna 420, the receiver 418, the multiantenna receiving processor 472, the receiving processor 470, the controller/processor 475 and the memory 476 illustrated in FIG. 4 in the disclosure.

In one embodiment, the first transmitter 1202 includes at least one of the antenna 452, the transmitter 454, the multiantenna transmitting processor 457, the transmitting processor 468, the controller/processor 459, the memory 460 and the data source 467 illustrated in FIG. 4.

In one embodiment, the first transmitter 1202 includes at least the former two of the antenna 452, the transmitter 454, the multiantenna transmitting processor 457, the transmitting processor 468, the controller/processor 459, the memory 460 and the data source 467 illustrated in FIG. 4.

In one embodiment, the first transmitter 1202 includes at least one of the antenna 420, the transmitter 418, the multiantenna transmitting processor 471, the transmitting processor 416, the controller/processor 475 and the memory 476 illustrated in FIG. 4.

In one embodiment, the first transmitter 1202 includes at least the former two of the antenna 420, the transmitter 418, the multiantenna transmitting processor 471, the transmitting processor 416, the controller/processor 475 and the memory 476 illustrated in FIG. 4.

The first receiver 1201 performs a first sensing in a first subband, and, when the first sensing indicates that a channel is busy, determines to give up a radio transmission on a first channel, starts a first timer and updates a first counter by 1.

The first transmitter 1202, when any one of Q timers expires, resets the first counter to an initial value, and when the first counter reaches or exceeds a target threshold, transmits a first signal.

In Embodiment 12, the first channel belongs to the first subband in frequency domain, the first sensing is correlated to a first index, and the first index is any one of Q indexes; the Q indexes are one-to-one corresponding to the Q timers respectively, and the first timer is one of the Q timers that is corresponding to the first index; and Q is a positive integer greater than 1.

In one embodiment, the first receiver 1201 monitors a first type of signaling in the first subband, wherein the first type of signaling is used for determining the first index; and the first sensing is performed each time the first type of signaling is detected.

In one embodiment, when the first counter reaches or exceeds a target threshold, the first transmitter 1202 triggers a sensing failure indication of the first subband, wherein as a response to the action that the sensing failure indication of the first subband is triggered, the first signal is generated.

In one embodiment, when the sensing failure indication has been triggered for each subband configured with a PRACH in a first serving cell, the first transmitter 1202 transmits the sensing failure indication to an upper layer; when the sensing failure indication has not been triggered for at least one subband configured with a PRACH in a first serving cell, the first transmitter 1202 switches from the first subband to a second subband; wherein the second subband is one subband in the first serving cell that is configured with a PRACH and has not been triggered the sensing failure indication.

In one embodiment, as a response to the action of transmitting the sensing failure indication to an upper layer, the first transmitter 1202 transmits a radio link failure message.

In one embodiment, the first receiver 1201 receives a first signaling, wherein the first signaling indicates at least one of expiration values of the Q timers or a target threshold of the first counter.

In one embodiment, the first transmitter 1202 transmits a second signal, wherein the second signal indicates a second index, and the second index is one of the Q indexes.

### Embodiment 13

Embodiment 13 illustrates a structure block diagram of a processing device in a second node, as shown in FIG. 13. In FIG. 13, the processing device 1300 in the second node includes a second receiver 1302 and a second transmitter 1301, wherein the second transmitter 1301 is optional.

In one embodiment, the second node 1300 is a UE.

In one embodiment, the second node 1300 is a base station.

In one embodiment, the second node 1300 is a relay node.

In one embodiment, the second node 1300 is a vehicle communication equipment.

In one embodiment, the second node 1300 is a UE supporting V2X communication.

In one embodiment, the second node 1300 is a relay node supporting V2X communication.

In one embodiment, the second receiver 1302 includes at least one of the antenna 452, the receiver 454, the multiantenna receiving processor 458, the receiving processor 456, the controller/processor 459, the memory 460 and the data source 467 illustrated in FIG. 4 in the disclosure.

In one embodiment, the second receiver 1302 includes at least the former two of the antenna 452, the receiver 454, the multiantenna receiving processor 458, the receiving processor 456, the controller/processor 459, the memory 460 and the data source 467 illustrated in FIG. 4 in the disclosure.

In one embodiment, the second receiver 1302 includes at least one of the antenna 420, the receiver 418, the multiantenna receiving processor 472, the receiving processor 470, the controller/processor 475 and the memory 476 illustrated in FIG. 4 in the disclosure.

In one embodiment, the second receiver 1302 includes at least the former two of the antenna 420, the receiver 418, the multiantenna receiving processor 472, the receiving processor 470, the controller/processor 475 and the memory 476 illustrated in FIG. 4 in the disclosure.

In one embodiment, the second transmitter 1301 includes at least one of the antenna 452, the transmitter 454, the multiantenna transmitting processor 457, the transmitting processor 468, the controller/processor 459, the memory 460 and the data source 467 illustrated in FIG. 4.

In one embodiment, the second transmitter 1301 includes at least the former two of the antenna 452, the transmitter 454, the multiantenna transmitting processor 457, the transmitting processor 468, the controller/processor 459, the memory 460 and the data source 467 illustrated in FIG. 4.

In one embodiment, the second transmitter 1301 includes at least one of the antenna 420, the transmitter 418, the multiantenna transmitting processor 471, the transmitting processor 416, the controller/processor 475 and the memory 476 illustrated in FIG. 4.

In one embodiment, the second transmitter 1301 includes at least the former two of the antenna 420, the transmitter 418, the multiantenna transmitting processor 471, the transmitting processor 416, the controller/processor 475 and the memory 476 illustrated in FIG. 4.

The receiver 1302 receives a first signal.

In Embodiment 13, a transmitter of the first signal maintains a first counter, and the first counter reaches or exceeds a target threshold; the transmitter of the first signal performs a first sensing in a first subband; when the first sensing indicates that a channel is busy, the transmitter of the first signal determines to give up a radio transmission on a first channel, starts a first timer and updates the first counter by 1; the first channel belongs to the first subband in frequency domain, the first sensing is correlated to a first index, and the first index is any one of Q indexes; the Q indexes are one-to-one corresponding to Q timers respectively, and the first timer is one of the Q timers that is corresponding to the first index; and Q is a positive integer greater than 1.

In one embodiment, the second node includes:

a second transmitter 1301, to transmit a first type of signaling in the first subband.

Herein, the first type of signaling is used for determining the first index; and the first sensing is performed each time the first type of signaling is detected by the transmitter of the first signal.

In one embodiment, the second receiver 1302 receives a radio link failure message, wherein the transmitter of the first signal transmits a sensing failure indication to an upper layer.

In one embodiment, the second node includes:

a second transmitter 1301, to transmit a first signaling.

Herein, the first signaling indicates at least one of expiration values of the Q timers or a target threshold of the first counter.

In one embodiment, the second receiver 1302 receives a second signal, wherein the second signal indicates a second index, and the second index is one of the Q indexes.

### Embodiment 14A

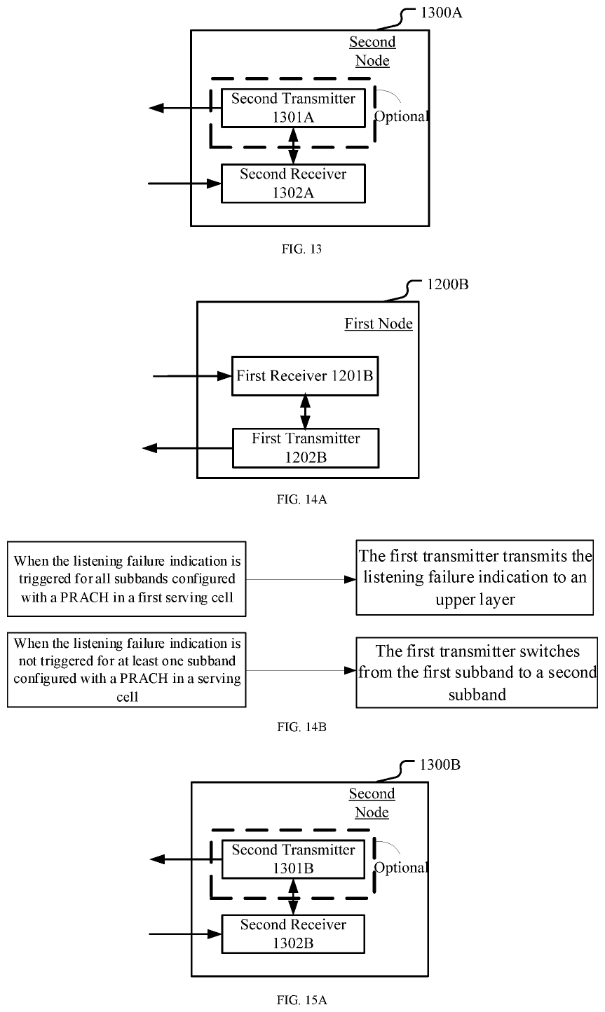

Embodiment 14A illustrates a structure block diagram of a processing device in a first node, as shown in FIG. 14A. In FIG. 14A, the processing device 1200B in the first node includes a first receiver 1201B and a first transmitter 1202B.

In one embodiment, the first node 1200B is a UE.

In one embodiment, the first node 1200B is a relay node.

In one embodiment, the first node 1200B is a base station.

In one embodiment, the first node 1200B is a vehicle communication equipment.

In one embodiment, the first node 1200B is a UE supporting V2X communication.

In one embodiment, the first node 1200B is a relay node supporting V2X communication.

In one embodiment, the first receiver 1201B includes at least one of the antenna 452, the receiver 454, the multiantenna receiving processor 458, the receiving processor 456, the controller/processor 459, the memory 460 and the data source 467 illustrated in FIG. 4 in the disclosure.

In one embodiment, the first receiver 1201B includes at least the former two of the antenna 452, the receiver 454, the multiantenna receiving processor 458, the receiving processor 456, the controller/processor 459, the memory 460 and the data source 467 illustrated in FIG. 4 in the disclosure.

In one embodiment, the first receiver 1201B includes at least one of the antenna 420, the receiver 418, the multiantenna receiving processor 472, the receiving processor 470, the controller/processor 475 and the memory 476 illustrated in FIG. 4 in the disclosure.

In one embodiment, the first receiver 1201B includes at least the former two of the antenna 420, the receiver 418, the multiantenna receiving processor 472, the receiving processor 470, the controller/processor 475 and the memory 476 illustrated in FIG. 4 in the disclosure.

In one embodiment, the first transmitter 1202B includes at least one of the antenna 452, the transmitter 454, the multiantenna transmitting processor 457, the transmitting processor 468, the controller/processor 459, the memory 460 and the data source 467 illustrated in FIG. 4.

In one embodiment, the first transmitter 1202B includes at least the former two of the antenna 452, the transmitter 454, the multiantenna transmitting processor 457, the transmitting processor 468, the controller/processor 459, the memory 460 and the data source 467 illustrated in FIG. 4.

In one embodiment, the first transmitter 1202B includes at least one of the antenna 420, the transmitter 418, the multiantenna transmitting processor 471, the transmitting processor 416, the controller/processor 475 and the memory 476 illustrated in FIG. 4.

In one embodiment, the first transmitter 1202B includes at least the former two of the antenna 420, the transmitter 418, the multiantenna transmitting processor 471, the transmitting processor 416, the controller/processor 475 and the memory 476 illustrated in FIG. 4.

The first receiver 1201B performs a first sensing in a first subband, and, when the first sensing indicates that a channel is busy, determines to give up a radio transmission on a first channel, starts a first timer and updates a first counter by 1.

The first transmitter 1202B, when the first timers expires, resets the first counter to an initial value, and when any one of Q counters reaches or exceeds a target threshold, transmits a first signal

In Embodiment 14B, the first channel belongs to the first subband in frequency domain, the first sensing is correlated to a first index, and the first index is any one of Q indexes; the Q indexes are one-to-one corresponding to the Q counters respectively, and the first counter is one of the Q counters that is corresponding to the first index; and Q is a positive integer greater than 1.

In one embodiment, the Q indexes are one-to-one corresponding to Q timers respectively, and the first timer is one of the Q timers that is corresponding to the first index.

In one embodiment, the Q counters are all corresponding to the first timer.

In one embodiment, when the first timer expires, the Q counters are all reset to an initial value by the first transmitter 1202B.

In one embodiment, the first receiver 1201B monitors a first type of signaling in the first subband, wherein the first type of signaling is used for determining the first index; and the first sensing is performed each time the first type of signaling is detected.

In one embodiment, when any one of the Q counters reaches or exceeds a target threshold, the first transmitter 1202B triggers a sensing failure indication of the first subband, wherein as a response to the action that the sensing failure indication of the first subband is triggered, the first signal is generated.

In one embodiment, when the sensing failure indication has been triggered for each subband configured with a PRACH in a first serving cell, the first transmitter 1202B transmits the sensing failure indication to an upper layer; when the sensing failure indication has not been triggered for at least one subband configured with a PRACH in a first serving cell, the first transmitter 1202B switches from the first subband to a second subband; wherein the second subband is one subband in the first serving cell that is configured with a PRACH and has not been triggered the sensing failure indication.

In one embodiment, as a response to the action of transmitting the sensing failure indication to an upper layer, the first transmitter 1202B transmits a radio link failure message.

In one embodiment, the first receiver 1201B receives a first signaling, wherein the first signaling indicates at least one of an expiration value of the first timer or target thresholds of the Q counters.

In one embodiment, the first transmitter 1202B transmits a second signal, wherein the second signal indicates a second index, and the second index is one of the Q indexes.

### Embodiment 14B

Embodiment 14B illustrates a diagram of a response to a sensing failure indication of a first subband, as shown in FIG. 14B.

In Embodiment 14B, when the sensing failure indication has been triggered for each subband configured with a PRACH in a first serving cell, the first transmitter in the disclosure transmits the sensing failure indication to an upper layer; when the sensing failure indication has not been triggered for at least one subband configured with a PRACH in a first serving cell, the first transmitter switches from the first subband to a second subband; wherein the second subband is one subband in the first serving cell that is configured with a PRACH and has not been triggered the sensing failure indication.

In one embodiment, when the sensing failure indication has not been triggered for at least one subband configured with a PRACH in first a serving cell, the first transmitter switches from the first subband to a second subband and starts a random access process.

In one embodiment, the first serving cell is a Special Cell (SpCell).

In one embodiment, the first serving cell is a Primary Cell (PCell).

In one embodiment, the first serving cell is a Primary Secondary Cell Group Cell (PSCell).

In one embodiment, the first subband is one subband in the first serving cell.

In one embodiment, the first subband is any one subband in the first serving cell.

In one embodiment, the first subband is any one subband in any one serving cell of the first node.

In one embodiment, the subband configured with a Physical random-access channel (PRACH) is preconfigured.

In one embodiment, the subband configured with a PRACH is configurable.

In one embodiment, the subband configured with a PRACH includes a positive integer number of subcarriers.

In one embodiment, the subband configured with a PRACH includes one carrier.

In one embodiment, the subband configured with a PRACH includes one BWP.

In one embodiment, the subband configured with a PRACH includes one UL BWP.

In one embodiment, the subband configured with a PRACH includes one subband.

In one embodiment, the subband configured with a PRACH belongs to an unlicensed spectrum.

In one embodiment, the second subband is different from the first subband.

In one embodiment, the second subband is predefined.

In one embodiment, the second subband is preconfigured.

In one embodiment, the second subband is configurable.

In one embodiment, the second subband includes a positive integer number of subcarriers.

In one embodiment, the second subband includes one carrier.

In one embodiment, the second subband includes one Bandwidth Part (BWP).

In one embodiment, the second subband includes one UpLink (UL) BWP.

In one embodiment, the second subband includes one subband.

In one embodiment, the second subband belongs to an unlicensed spectrum.

In one embodiment, the upper layer is above an MAC layer.

In one embodiment, the upper layer includes an RLC layer.

In one embodiment, the upper layer includes a PDCP layer.

In one embodiment, the upper layer includes an RLC layer and a PDCP layer.

In one embodiment, the upper layer includes an RLC layer and layers above the RLC layer.

In one embodiment, the upper layer includes an RRC layer.

In one embodiment, the upper layer includes Layer 3 (L3 layer).

In one embodiment, the upper layer includes Layer 3 (L3 layer) and layers above Layer 3.

In one embodiment, the upper layer includes a Non-Access-Stratum (NAS) layer.

In one embodiment, the action of transmitting the sensing failure indication to an upper layer includes: transmitting the sensing failure indication to an RLC layer.

In one embodiment, the action of transmitting the sensing failure indication to an upper layer includes: transmitting the sensing failure indication to an RRC layer.

In one embodiment, the action of transmitting the sensing failure indication to an upper layer includes: transmitting the sensing failure indication to an NAS layer.

In one embodiment, the action of transmitting the sensing failure indication to an upper layer triggers an RLC failure.

In one embodiment, the action of transmitting the sensing failure indication to an upper layer triggers a Radio Link Failure (RLF).

In one embodiment, as a response to the action of transmitting the sensing failure indication to an upper layer, the first transmitter transmits a radio link failure message.

In one embodiment, the action of switching from the first subband to a second subband includes: stopping a random access process that is ongoing in the first serving cell.

In one embodiment, the action of switching from the first subband to a second subband includes: initiating a new random access process.

In one embodiment, the action of switching from the first subband to a second subband includes: transmitting a PRACH for the first serving cell in the second subband.

In one embodiment, the action of switching from the first subband to a second subband includes: performing LBT in the second subband.

In one embodiment, the action of switching from the first subband to a second subband includes: transmitting a radio signal on a physical layer data channel in the second subband.

In one embodiment, the first node is a UE, and the physical layer data channel is a PUSCH.

In one embodiment, the first node is a base station, and the physical layer data channel is a PDSCH.

In one embodiment, the action of switching from the first subband to a second subband includes: receiving Downlink Control Information (DCI) for uplink grant, the DCI for uplink grant indicating frequency domain resources occupied by a physical layer data channel from the second subband.

In one embodiment, the radio link failure message is carried by a higher layer signaling.

In one embodiment, the radio link failure message is carried by an RRC signaling.

In one embodiment, the radio link failure message is carried by an MAC CE signaling.

In one embodiment, the radio link failure message includes an RLF report.

In one embodiment, the radio link failure message includes an MCGfailureInformation.

In one embodiment, the radio link failure message includes an RRCReestablishmentRequest.

In one embodiment, the radio link failure message includes an RRCConnectionReestablishmentRequest.

### Embodiment 15A

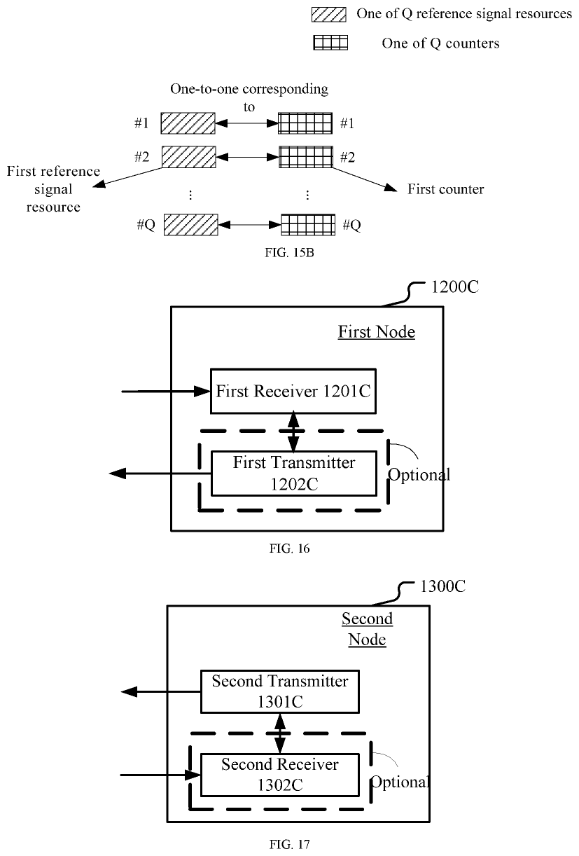

Embodiment 15A illustrates a structure block diagram of a processing device in a second node, as shown in FIG. 15A. In FIG. 15A, the processing device 1300B in the second node includes a second receiver 1302B and a second transmitter 1301B, wherein the second transmitter 1301B is optional.

In one embodiment, the second node 1300B is a UE.

In one embodiment, the second node 1300B is a base station.

In one embodiment, the second node 1300B is a relay node.

In one embodiment, the second node 1300B is a vehicle communication equipment.

In one embodiment, the second node 1300B is a UE supporting V2X communication.

In one embodiment, the second node 1300B is a relay node supporting V2X communication.

In one embodiment, the second receiver 1302B includes at least one of the antenna 452, the receiver 454, the multiantenna receiving processor 458, the receiving processor 456, the controller/processor 459, the memory 460 and the data source 467 illustrated in FIG. 4 in the disclosure.

In one embodiment, the second receiver 1302B includes at least the former two of the antenna 452, the receiver 454, the multiantenna receiving processor 458, the receiving processor 456, the controller/processor 459, the memory 460 and the data source 467 illustrated in FIG. 4 in the disclosure.

In one embodiment, the second receiver 1302B includes at least one of the antenna 420, the receiver 418, the multiantenna receiving processor 472, the receiving processor 470, the controller/processor 475 and the memory 476 illustrated in FIG. 4 in the disclosure.

In one embodiment, the second receiver 1302B includes at least the former two of the antenna 420, the receiver 418, the multiantenna receiving processor 472, the receiving processor 470, the controller/processor 475 and the memory 476 illustrated in FIG. 4 in the disclosure.

In one embodiment, the second transmitter 1301B includes at least one of the antenna 452, the transmitter 454, the multiantenna transmitting processor 457, the transmitting processor 468, the controller/processor 459, the memory 460 and the data source 467 illustrated in FIG. 4.

In one embodiment, the second transmitter 1301B includes at least the former two of the antenna 452, the transmitter 454, the multiantenna transmitting processor 457, the transmitting processor 468, the controller/processor 459, the memory 460 and the data source 467 illustrated in FIG. 4.

In one embodiment, the second transmitter 1301B includes at least one of the antenna 420, the transmitter 418, the multiantenna transmitting processor 471, the transmitting processor 416, the controller/processor 475 and the memory 476 illustrated in FIG. 4.

In one embodiment, the second transmitter 1301B includes at least the former two of the antenna 420, the transmitter 418, the multiantenna transmitting processor 471, the transmitting processor 416, the controller/processor 475 and the memory 476 illustrated in FIG. 4.

The receiver 1302B receives a first signal.

In Embodiment 15B, a transmitter of the first signal maintains Q counters, and any one of the Q counters reaches or exceeds a target threshold; the transmitter of the first signal performs a first sensing in a first subband; when the first sensing indicates that a channel is busy, the transmitter of the first signal determines to give up a radio transmission on a first channel, starts a first timer and updates a first counter by 1; the first channel belongs to the first subband in frequency domain, the first sensing is correlated to a first index, and the first index is any one of Q indexes; the Q indexes are one-to-one corresponding to Q counters respectively, and the first counter is one of the Q counters that is corresponding to the first index; and Q is a positive integer greater than 1.

In one embodiment, the Q indexes are one-to-one corresponding to Q timers respectively, and the first timer is one of the Q timers that is corresponding to the first index.

In one embodiment, the Q counters are all corresponding to the first timer.

In one embodiment, when the first timer expires, the Q counters are all reset to an initial value by the transmitter of the first signal.

In one embodiment, the second node includes:

a second transmitter 1301B, to transmit a first type of signaling in the first subband.

Herein, the first type of signaling is used for determining the first index; and the first sensing is performed each time the first type of signaling is detected by the transmitter of the first signal.

In one embodiment, the second receiver 1302B receives a radio link failure message, wherein the transmitter of the first signal transmits a sensing failure indication to an upper layer.

In one embodiment, the second node includes:

a second transmitter 1301B, to transmit a first signaling.

Herein, the first signaling indicates at least one of an expiration value of the first timer or target thresholds of the Q counters.

In one embodiment, the second receiver 1302B receives a second signal, wherein the second signal indicates a second index, and the second index is one of the Q indexes.

### Embodiment 15B

Embodiment 15B illustrates a diagram of Q counters, as shown in FIG. 15B.

In Embodiment 15B, Q counters are one-to-one corresponding to Q reference signal resources, the first reference signal resource in the disclosure is any one of the Q reference signal resources, the first counter in the disclosure is one of the Q counters that is corresponding to the first reference signal resource, and the Q is a positive integer greater than 1.

In one embodiment, the first parameter is used for determining the Q reference signal resources.

In one embodiment, Q parameters are used for determining Q reference signal resources respectively, the first parameter is any one of the Q parameters, and the first reference signal resource is one of the Q reference signal resources that is determined by the first parameter.

In one embodiment, Q parameters are used for determining Q reference signal resource sets respectively, the first parameter is any one of the Q parameters, and the first reference signal resource set is one of the Q reference signal resource sets that is determined by the first parameter.

In one embodiment, the first signaling reconfigures the Q parameters.

In one embodiment, Q signalings reconfigure the Q parameters respectively, and the first signaling is any one of the Q signalings.

In one embodiment, the first receiver receives (Q−1) signalings, wherein Q signalings are composed of the first signaling and the (Q−1) signalings, and the Q signalings reconfigure the Q parameters respectively.

In one embodiment, the Q reference signal resources belong to the first reference signal resource set.

In one embodiment, the Q reference signal resources correspond to Q CORESET sets respectively.

In one embodiment, the Q reference signal resources correspond to Q search spaces respectively.

In one embodiment, the Q reference signal resources correspond to Q CORESET pools respectively.

In one embodiment, the Q reference signal resources correspond to Q CORESETPoolIndexes respectively.

In one embodiment, any one index of the Q reference signal resources is an CORESETPoolIndex.

In one embodiment, the Q reference signal resources correspond to Q antenna panels respectively.

In one embodiment, the Q reference signal resources correspond to Q TRPs respectively.

In one embodiment, the Q counters are all specific to the first subband.

In one embodiment, initial values of all the Q counters are the same.

In one embodiment, target thresholds of all the Q counters are the same.

In one embodiment, target thresholds of at least two of the Q counters are different.

In one embodiment, target thresholds of the Q counters are configured respectively.

In one embodiment, target thresholds of the Q counters are defined respectively.

In one embodiment, when the first sensing indicates that a channel is busy, only the first counter among the Q counters is updated by 1.

In one embodiment, when the first timer expires, only the first counter among the Q counters is reset to an initial value.

In one embodiment, when the first timer expires, the Q counters are all reset to an initial value.

In one embodiment, when any one condition in the first condition set is met, only the first counter among the Q counters is reset to an initial value.

In one embodiment, when any one condition in the first condition set is met, the Q counters are all reset to an initial value.

In one embodiment, when any one of the Q counters reaches or exceeds a target threshold, the first signal is transmitted.

In one embodiment, the Q counters are all corresponding to the first timer.

In one embodiment, the phrase that the Q counters are all corresponding to the first timer includes: the first timer is independent of which one of the Q counters is the first counter.

In one embodiment, the phrase that the Q counters are all corresponding to the first timer includes: the first timer is used for determining any one of the Q counters.

In one embodiment, the phrase that the Q counters are all corresponding to the first timer includes: the Q counters are all related to the first timer.

In one embodiment, the phrase that the Q counters are all corresponding to the first timer includes: when the first timer expires, the Q counters are all reset to an initial value.

In one embodiment, the phrase that the Q counters are all corresponding to the first timer includes: when the first timer expires, only the first counter among the Q counters is reset to an initial value.

In one embodiment, the Q counters are corresponding to Q timers respectively, and the first timer is one of the Q timers that is corresponding to the first counter.

In one embodiment, expiration values of all the Q timers are positive integers.

In one embodiment, expiration values of all the Q timers are the same.

In one embodiment, expiration values of at least two of the Q timers are different.

In one embodiment, expiration values of the Q timers are configured respectively.

In one embodiment, expiration values of the Q timers are predefined respectively.

In one embodiment, the Q timers are all specific to the first subband.

In one embodiment, one condition in the first condition set includes: expiration values of all the Q timers are the same, the expiration values of the Q timers are reconfigured.

In one embodiment, one condition in the first condition set includes: an expiration value of any one of the Q timers is reconfigured.

In one embodiment, one condition in the first condition set includes: an expiration value of at least one of the Q timers is reconfigured.

In one embodiment, one condition in the first condition set includes: expiration values of all the Q timers are reconfigured.

### Embodiment 16

Embodiment 16 illustrates a structure block diagram of a processing device in a first node, as shown in FIG. 16. In FIG. 16, the processing device 1200C in the first node includes a first receiver 1201C and a first transmitter 1202C, wherein the first transmitter 1202C is optional.

In one embodiment, the first node 1200C is a UE.

In one embodiment, the first node 1200C is a relay node.

In one embodiment, the first node 1200C is a base station.

In one embodiment, the first node 1200C is a vehicle communication equipment.

In one embodiment, the first node 1200C is a UE supporting V2X communication.

In one embodiment, the first node 1200C is a relay node supporting V2X communication.

In one embodiment, the first receiver 1201C includes at least one of the antenna 452, the receiver 454, the multiantenna receiving processor 458, the receiving processor 456, the controller/processor 459, the memory 460 and the data source 467 illustrated in FIG. 4 in the disclosure.

In one embodiment, the first receiver 1201C includes at least the former two of the antenna 452, the receiver 454, the multiantenna receiving processor 458, the receiving processor 456, the controller/processor 459, the memory 460 and the data source 467 illustrated in FIG. 4 in the disclosure.

In one embodiment, the first receiver 1201C includes at least one of the antenna 420, the receiver 418, the multiantenna receiving processor 472, the receiving processor 470, the controller/processor 475 and the memory 476 illustrated in FIG. 4 in the disclosure.

In one embodiment, the first receiver 1201C includes at least the former two of the antenna 420, the receiver 418, the multiantenna receiving processor 472, the receiving processor 470, the controller/processor 475 and the memory 476 illustrated in FIG. 4 in the disclosure.

In one embodiment, the first transmitter 1202C includes at least one of the antenna 452, the transmitter 454, the multiantenna transmitting processor 457, the transmitting processor 468, the controller/processor 459, the memory 460 and the data source 467 illustrated in FIG. 4.

In one embodiment, the first transmitter 1202C includes at least the former two of the antenna 452, the transmitter 454, the multiantenna transmitting processor 457, the transmitting processor 468, the controller/processor 459, the memory 460 and the data source 467 illustrated in FIG. 4.

In one embodiment, the first transmitter 1202C includes at least one of the antenna 420, the transmitter 418, the multiantenna transmitting processor 471, the transmitting processor 416, the controller/processor 475 and the memory 476 illustrated in FIG. 4.

In one embodiment, the first transmitter 1202C includes at least the former two of the antenna 420, the transmitter 418, the multiantenna transmitting processor 471, the transmitting processor 416, the controller/processor 475 and the memory 476 illustrated in FIG. 4.

The first receiver 1201C receives a first signaling, the first signaling reconfiguring a first parameter; as a response to the action that the first parameter is reconfigured, resets a first counter to an initial value; performs a first sensing in a first subband; and when the first sensing indicates that a channel is busy, determines to give up a radio transmission on a first channel, starts a first timer and updates the first counter by 1.

In Embodiment 16, the first channel belongs to the first subband in frequency domain, and the first parameter is used for determining a first reference signal resource set; at least one of the radio transmission on the first channel and the first sensing is spatially correlated to a first reference signal resource, the first reference signal resource is one reference signal resource in the first reference signal resource set, and the first reference signal resource set includes at least one reference signal resource.

In one embodiment, the first node includes:

a first transmitter 1202C, when the first counter reaches or exceeds a target threshold, transmits a first signal.

In one embodiment, when the first timer expires, the first receiver resets the first counter to the initial value.

In one embodiment, the first receiver monitors a first type of signaling in the first subband, wherein the first sensing is performed each time the first type of signaling is detected.

In one embodiment, the first type of signaling includes a first field, and the first field in the first type of signaling is used for indicating the first reference signal resource.

In one embodiment, Q counters are one-to-one corresponding to Q reference signal resources, the first reference signal resource is any one of the Q reference signal resources, the first counter is one of the Q counters that is corresponding to the first reference signal resource.

In one embodiment, as a response to the action that the first parameter is reconfigured, the first receiver resets (Q−1) counters to the initial value, wherein the Q counters are composed of the first counter and the (Q−1) counters.

### Embodiment 17

Embodiment 17 illustrates a structure block diagram of a processing device in a second node, as shown in FIG. 17. In FIG. 17, the processing device 1300C in the second node includes a second receiver 1302C and a second transmitter 1301C, wherein the second receiver 1302C is optional.

In one embodiment, the second node 1300C is a UE.

In one embodiment, the second node 1300C is a base station.

In one embodiment, the second node 1300C is a relay node.

In one embodiment, the second node 1300C is a vehicle communication equipment.

In one embodiment, the second node 1300C is a UE supporting V2X communication.

In one embodiment, the second node 1300C is a relay node supporting V2X communication.

In one embodiment, the second receiver 1302C includes at least one of the antenna 452, the receiver 454, the multiantenna receiving processor 458, the receiving processor 456, the controller/processor 459, the memory 460 and the data source 467 illustrated in FIG. 4 in the disclosure.

In one embodiment, the second receiver 1302C includes at least the former two of the antenna 452, the receiver 454, the multiantenna receiving processor 458, the receiving processor 456, the controller/processor 459, the memory 460 and the data source 467 illustrated in FIG. 4 in the disclosure.

In one embodiment, the second receiver 1302C includes at least one of the antenna 420, the receiver 418, the multiantenna receiving processor 472, the receiving processor 470, the controller/processor 475 and the memory 476 illustrated in FIG. 4 in the disclosure.

In one embodiment, the second receiver 1302C includes at least the former two of the antenna 420, the receiver 418, the multiantenna receiving processor 472, the receiving processor 470, the controller/processor 475 and the memory 476 illustrated in FIG. 4 in the disclosure.

In one embodiment, the second transmitter 1301C includes at least one of the antenna 452, the transmitter 454, the multiantenna transmitting processor 457, the transmitting processor 468, the controller/processor 459, the memory 460 and the data source 467 illustrated in FIG. 4.

In one embodiment, the second transmitter 1301C includes at least the former two of the antenna 452, the transmitter 454, the multiantenna transmitting processor 457, the transmitting processor 468, the controller/processor 459, the memory 460 and the data source 467 illustrated in FIG. 4.

In one embodiment, the second transmitter 1301C includes at least one of the antenna 420, the transmitter 418, the multiantenna transmitting processor 471, the transmitting processor 416, the controller/processor 475 and the memory 476 illustrated in FIG. 4.

In one embodiment, the second transmitter 1301C includes at least the former two of the antenna 420, the transmitter 418, the multiantenna transmitting processor 471, the transmitting processor 416, the controller/processor 475 and the memory 476 illustrated in FIG. 4.

The second transmitter 1301C transmits a first signaling, the first signaling reconfiguring a first parameter.

In Embodiment 17, as a response to the action that the first parameter is reconfigured, a target receiver of the first signaling resets a first counter to an initial value; the target receiver of the first signaling performs a first sensing in a first subband; when the first sensing indicates that a channel is busy, the target receiver of the first signaling determines to give up a radio transmission on a first channel, starts a first timer and updates the first counter by 1; the first channel belongs to the first subband in frequency domain, and the first parameter is used for determining a first reference signal resource set; at least one of the radio transmission on the first channel and the first sensing is spatially correlated to a first reference signal resource, the first reference signal resource is one reference signal resource in the first reference signal resource set, and the first reference signal resource set includes at least one reference signal resource.

In one embodiment, the second node includes:

a second receiver 1302C, to receive a first signal.

Herein, the first counter reaches or exceeds a target threshold.

In one embodiment, when the first timer expires, the target receiver of the first signaling resets the first counter to the initial value.

In one embodiment, the second transmitter 1301C transmits a first type of signaling in the first subband. Herein, the first sensing is performed each time the first type of signaling is detected by the target receiver of the first signaling.

In on embodiment, the first type of signaling includes a first field, and the first field in the first type of signaling is used for indicating the first reference signal resource.

In one embodiment, Q counters are one-to-one corresponding to Q reference signal resources, the first reference signal resource is any one of the Q reference signal resources, and the first counter is one of the Q counters that is corresponding to the first reference signal resource.

In one embodiment, as a response to the action that the first parameter is reconfigured, the target receiver of the first signaling resets (Q−1) counters to the initial value, wherein the Q counters are composed of the first counter and the (Q−1) counters.

The ordinary skill in the art may understand that all or part steps in the above method may be implemented by instructing related hardware through a program. The program may be stored in a computer readable storage medium, for example Read-Only Memory (ROM), hard disk or compact disc, etc. Optionally, all or part steps in the above embodiments also may be implemented by one or more integrated circuits. Correspondingly, each module unit in the above embodiment may be realized in the form of hardware, or in the form of software function modules. The disclosure is not limited to any combination of hardware and software in specific forms. The first node in the disclosure includes but not limited to mobile phones, tablet computers, notebooks, network cards, low-power equipment, eMTC terminals, NB-IOT terminals, vehicle-mounted communication equipment, aircrafts, airplanes, unmanned aerial vehicles, telecontrolled aircrafts, and other radio communication equipment. The second node in the disclosure includes but not limited to mobile phones, tablet computers, notebooks, network cards, low-power equipment, eMTC terminals, NB-IOT terminals, vehicle-mounted communication equipment, aircrafts, airplanes, unmanned aerial vehicles, telecontrolled aircrafts, and other radio communication equipment. The UE or terminal in the disclosure includes but not limited to mobile phones, tablet computers, notebooks, network cards, low-power equipment, eMTC terminals, NB-IOT terminals, vehicle-mounted communication equipment, aircrafts, airplanes, unmanned aerial vehicles, telecontrolled aircrafts, and other radio communication equipment. The base station equipment or base station or network side equipment in the disclosure includes but not limited to macro-cellular base stations, micro-cellular base stations, home base stations, relay base stations, eNBs, gNBs, TRPs, GNSSs, relay satellites, satellite base stations, air base stations, and other radio communication equipment.

The above are merely the preferred embodiments of the disclosure and are not intended to limit the scope of protection of the disclosure. Any modification, equivalent substitute and improvement made within the spirit and principle of the disclosure are intended to be included within the scope of protection of the disclosure.

What is claimed is:

1. A first node for wireless communication, comprising:
a first receiver, to perform a first sensing in a first subband, and when the first sensing indicates that a channel is busy, to determine to give up a radio transmission on a first channel, to start a first timer and to update a first counter by 1; and
a first transmitter, when any one of Q timers expires, to reset the first counter to an initial value, and when the first counter reaches or exceeds a target threshold, to transmit a first signal;
wherein the first channel belongs to the first subband in frequency domain, the first sensing is correlated to a first index, and the first index is any one of Q indexes; the Q indexes are one-to-one corresponding to the Q timers respectively, and the first timer is one of the Q timers that is corresponding to the first index; and Q is a positive integer greater than 1.

2. The first node according to claim 1, wherein the first receiver monitors a first type of signaling in the first subband, wherein the first type of signaling is used for determining the first index; and the first sensing is performed each time the first type of signaling is detected;
or, the first receiver receives a first signaling, wherein the first signaling indicates at least one of expiration values of the Q timers or a target threshold of the first counter;
or, the first transmitter transmits a second signal, wherein the second signal indicates a second index, and the second index is one of the Q indexes.

3. The first node according to claim 1, wherein when the first counter reaches or exceeds a target threshold, the first transmitter triggers a sensing failure indication of the first subband, wherein as a response to the action that the sensing failure indication of the first subband is triggered, the first signal is generated.

4. The first node according to claim 3, wherein when the sensing failure indication has been triggered for each subband configured with a PRACH in a first serving cell, the first transmitter transmits the sensing failure indication to an upper layer; when the sensing failure indication has not been triggered for at least one subband configured with a PRACH in a first serving cell, the first transmitter switches from the first subband to a second subband; wherein the second subband is one subband in the first serving cell that is configured with a PRACH and has not been triggered the sensing failure indication.

5. The first node according to claim 4, wherein as a response to the action of transmitting the sensing failure indication to an upper layer, the first transmitter transmits a radio link failure message.

6. The first node according to any one of claim 1, wherein the Q timers are all corresponding to the first counter.

7. A second node for wireless communication, comprising:
a second receiver, to receive a first signal;
wherein a transmitter of the first signal maintains a first counter, and the first counter reaches or exceeds a target threshold; the transmitter of the first signal performs a first sensing in a first subband; when the first sensing indicates that a channel is busy, the transmitter of the first signal determines to give up a radio transmission on a first channel, starts a first timer and updates the first counter by 1; the first channel belongs to the first subband in frequency domain, the first sensing is correlated to a first index, and the first index is any one of Q indexes; the Q indexes are one-to-one corresponding to Q timers respectively, and the first timer is one of the Q timers that is corresponding to the first index; and Q is a positive integer greater than 1.

8. The second node according to claim 7, comprising:
a second transmitter, to transmit a first type of signaling in the first subband; wherein the first type of signaling is used for determining the first index; and the first sensing is performed each time the first type of signaling is detected by the transmitter of the first signal;
or, a second transmitter, to transmit a first signaling; wherein the first signaling indicates at least one of expiration values of the Q timers or a target threshold of the first counter;
or, the second receiver receives a second signal, wherein the second signal indicates a second index, and the second index is one of the Q indexes.

9. The second node according to claim 7, wherein the second receiver receives a radio link failure message, wherein the transmitter of the first signal transmits a sensing failure indication to an upper layer.

10. The second node according to claim 7, wherein the Q timers are all corresponding to the first counter.

11. A method in a first node for wireless communication, comprising:
performing a first sensing in a first subband; when the first sensing indicates that a channel is busy, determining to give up a radio transmission on a first channel, starting a first timer and updating a first counter by 1; and
when any one of Q timers expires, resetting the first counter to an initial value; and when the first counter reaches or exceeds a target threshold, transmitting a first signal;
wherein the first channel belongs to the first subband in frequency domain, the first sensing is correlated to a first index, and the first index is any one of Q indexes; the Q indexes are one-to-one corresponding to the Q timers respectively, and the first timer is one of the Q timers that is corresponding to the first index; and Q is a positive integer greater than 1.

12. The method according to claim 11, comprising:
monitoring a first type of signaling in the first subband; wherein the first type of signaling is used for determining the first index; and the first sensing is performed each time the first type of signaling is detected;
or, receiving a first signaling; wherein the first signaling indicates at least one of expiration values of the Q timers or a target threshold of the first counter;
or, transmitting a second signal; wherein the second signal indicates a second index, and the second index is one of the Q indexes.

13. The method according to claim 11, comprising:
when the first counter reaches or exceeds a target threshold, triggering a sensing failure indication of the first subband;
wherein as a response to the action that the sensing failure indication of the first subband is triggered, the first signal is generated.

14. The method according to claim 13, comprising:
when the sensing failure indication has been triggered for each subband configured with a PRACH in a first serving cell, transmitting the sensing failure indication to an upper layer; when the sensing failure indication has not been triggered for at least one subband configured with a PRACH in a first serving cell, switching from the first subband to a second subband;
wherein the second subband is one subband in the first serving cell that is configured with a PRACH and has not been triggered the sensing failure indication.

15. The method according to claim 14, comprising:
as a response to the action of transmitting the sensing failure indication to an upper layer, transmitting a radio link failure message.

16. The method according to claim 11, wherein the Q timers are all corresponding to the first counter.

17. A method in a second node for wireless communication, comprising:
receiving a first signal;
wherein a transmitter of the first signal maintains a first counter, and the first counter reaches or exceeds a target threshold; the transmitter of the first signal performs a first sensing in a first subband; when the first sensing indicates that a channel is busy, the transmitter of the first signal determines to give up a radio transmission on a first channel, starts a first timer and updates the first counter by 1; the first channel belongs to the first subband in frequency domain, the first sensing is correlated to a first index, and the first index is any one of Q indexes; the Q indexes are one-to-one corresponding to Q timers respectively, and the first timer is one of the Q timers that is corresponding to the first index; and Q is a positive integer greater than 1.

18. The method according to claim 17, comprising:
transmitting a first type of signaling in the first subband; wherein the first type of signaling is used for determining the first index; and the first sensing is performed each time the first type of signaling is detected by the transmitter of the first signal;
or, transmitting a first signaling; wherein the first signaling indicates at least one of expiration values of the Q timers or a target threshold of the first counter;
or, receiving a second signal; wherein the second signal indicates a second index, and the second index is one of the Q indexes.

19. The method according to claim 17, comprising:
receiving a radio link failure message;
wherein the transmitter of the first signal transmits a sensing failure indication to an upper layer.

20. The method according to claim 17, wherein the Q timers are all corresponding to the first counter.
